(19) United States
(12) Patent Application Publication
(10) Pub. No.: US 2026/0249315 A1
(43) Pub. Date: Aug. 27, 2026

(54) FLUID SPRAYER AND COMPONENTS OF A FLUID SPRAYER

(71) Applicant: Graco Minnesota Inc., Minneapolis, MN (US)

(72) Inventors: Christopher C. Wagner, Saint Anthony, MN (US); Mark C. Richter, River Falls, WI (US); Dawn P. Svenkeson-Koubal, Wayzata, MN (US)

(21) Appl. No.: 19/160,367

(22) PCT Filed: Feb. 27, 2024
(86) PCT No.: PCT/US2024/017517

§ 371 Date: Aug. 27, 2025

Related U.S. Application Data
(60) Provisional application No. 63/449,824, filed on Mar. 3, 2023.
(60) Provisional application No. 63/453,906, filed on Mar. 22, 2023.
(60) Provisional application No. 63/533,241, filed on Aug. 17, 2023.

(51) Int. Cl. B05B 7/12

(52) U.S. Cl. CPC B05B 7/12

(57) ABSTRACT

A spray gun is configured to emit spray fluid and compressed air that impinges on the spray fluid to atomize the spray fluid. A cap assembly mounts an air cap of to a gun body of the spray gun. The cap assembly includes an actuator that shifts axially along a cap axis to lock the cap assembly to the gun body and unlock the cap assembly from the gun body.

### CROSS-REFERENCE TO RELATED APPLICATION(S)

This application claims the benefit of U.S. Provisional Application No. 63/449,824 filed Mar. 3, 2023 and entitled “FLUID SPRAYER AND COMPONENTS OF A FLUID SPRAYER,” and claims the benefit of U.S. Provisional Application No. 63/453,906 filed Mar. 22, 2023 and entitled “FLUID SPRAYER AND COMPONENTS OF A FLUID SPRAYER,” and claims the benefit of U.S. Provisional Application No. 63/533,241 filed Aug. 17, 2023 and entitled “FLUID SPRAYER AND COMPONENTS OF A FLUID SPRAYER,” the disclosures of which are hereby incorporated by reference in their entireties.

### BACKGROUND

This disclosure relates to spray systems. More specifically, this disclosure relates to spray guns and components thereof for use in spray systems.

Spray guns can be used to spray fluids on surfaces. For example, spray guns can be used to spray a liquid such as paint, lacquer, finishes, and other coatings on furniture, cabinets, appliances, equipment, fabricated components, etc.

The spray guns utilize compressed gas, such as compressed air, to atomize the spray fluid into a desired spray pattern. Typically, the spray fluid is placed under pressure by a piston, diaphragm, or other positive displacement pump. The pump outputs the spray fluid under pressure through a flexible hose. A spray gun is used to dispense the spray fluid, the gun being attached to the end of the hose opposite the pump. In this way, the spray gun does not include a pump, but rather releases spray fluid pumped to the spray gun through the hose. The spray gun atomizes the spray fluid under pressure into a spray pattern, which is applied to a surface.

The compressed gas is emitted to assist in atomizing and, in some examples, shaping the fluid spray. The spray guns emit the compressed air through an air cap and the compressed air atomizes the spray fluid and can shape the spray fluid into a desired pattern.

### SUMMARY

According to an aspect of the present disclosure, a spray control assembly for a fluid spray gun includes a cartridge body elongate along a cartridge axis; a nozzle formed at a first end of the cartridge body; a spray valve disposed within the cartridge body; a needle partially disposed within the cartridge body and extending out of the cartridge body through a second end of the cartridge body opposite the first end of the cartridge body, the needle including a needle tip configured to engage with the seat to place a spray valve in a closed state and including a needle head at an opposite end of the needle from the needle tip; a cartridge mount disposed on an exterior of the cartridge body, the cartridge mount configured to interface with a gun body of the spray gun to mount the spray control assembly to the spray gun; and at least one fluid port extending through the cartridge body between the exterior of the cartridge body and a flow chamber formed within an interior of the cartridge body. The spray control assembly is formed as a single module configured to be mounted to and dismounted from the fluid spray gun as the single module.

According to an additional or alternative aspect of the present disclosure, a spray gun configured to emit a spray of spray fluid includes a gun body having a gun bore formed within the gun body, the gun bore extending along a spray axis; an air cap supported by the gun body, the air cap configured to output compressed air; and a spray control assembly mountable to the gun body. The spray control assembly including a cartridge body elongate along a cartridge axis, the cartridge body configured to mount to the gun body within the gun bore; a nozzle formed at a first end of the cartridge body; a spray valve disposed within the cartridge body; a needle partially disposed within the cartridge body and extending out of the cartridge body through a second end of the cartridge body opposite the first end of the cartridge body, the needle including a needle tip configured to engage with the seat to place a spray valve in a closed state and including a needle head at an opposite end of the needle from the needle tip; a cartridge mount disposed on an exterior of the cartridge body, the cartridge mount configured to mount the spray control assembly to the spray gun; and at least one fluid port extending through the cartridge body between the exterior of the cartridge body and a flow chamber formed within an interior of the cartridge body. The spray control assembly is formed as a single module configured to be mounted to and dismounted from the gun body.

According to another additional or alternative aspect of the present disclosure, a spray gun configured to emit a spray of spray fluid includes a gun body having a gun bore formed within the gun body, the gun bore extending along a spray axis; an air cap supported by the gun body, the air cap configured to output compressed air; and a spray control assembly mountable to the gun body. The spray control assembly including a cartridge body elongate along a cartridge axis, the cartridge body configured to mount to the gun body within the gun bore; a nozzle formed at a first end of the cartridge body; a spray valve disposed within the cartridge body; a needle partially disposed within the cartridge body and extending out of the cartridge body through a second end of the cartridge body opposite the first end of the cartridge body, the needle including a needle tip configured to engage with the seat to place a spray valve in a closed state and including a needle head at an opposite end of the needle from the needle tip; a cartridge mount disposed on an exterior of the cartridge body, the cartridge mount configured to mount the spray control assembly to the spray gun; and at least one fluid port extending through the cartridge body between the exterior of the cartridge body and a flow chamber formed within an interior of the cartridge body. The spray control assembly is formed as a single module configured to be mounted to and dismounted from the gun body.

According to yet another additional or alterative aspect of the present disclosure, a spray gun configured to emit spray fluid and compressed air includes a gun body and a spray control assembly. The spray control assembly includes a cartridge body mountable to the gun body; a needle configured to shift along an axis relative to a seat to open and close a spray valve; and a nozzle configured to emit the spray fluid. The spray control assembly is fixed to the gun body and drivingly disconnected from an actuator of the spray gun with the spray gun in a non-spray state such that the spray control assembly is fixed to the spray gun by a single interface between the cartridge body and the gun body with the spray gun in the non-spray state.

According to yet another additional or alterative aspect of the present disclosure, a spray gun configured to emit spray fluid and compressed air includes a gun body having a main body and a handle projecting from the main body; a trigger supported by the gun body; a spray control assembly mountable to and dismountable from the gun body as a single spray module; and a flow control assembly mountable to and dismountable from the gun body as a single flow module. The spray control assembly includes a cartridge body mountable to the gun body; a needle configured to shift along an axis relative to a seat to open and close a spray valve; and a nozzle configured to emit the spray fluid. The flow control assembly includes a limiter housing mountable to the gun body; a valve seal extending from the limiter housing and movable relative to the limiter housing, the valve seal configured to shift along the axis to open and close an air valve; a valve spring interfacing with the valve seal and biasing the valve seal to place the air valve in a closed state; and a needle return disposed radially inward of the valve seal, the needle return configured to bias the needle into engagement with the seat to place the spray valve in a closed state.

According to yet another additional or alterative aspect of the present disclosure, a spray gun includes a gun body having a main body and a handle projecting from the main body; an air cap mounted to the gun body, the air cap configured to emit compressed air; a trigger supported by the gun body; a spray control assembly mountable to and dismountable from the gun body as a single spray module, the spray control assembly including a nozzle and a spray valve actuatable between an open spray state, in which spray fluid can flow through the nozzle, and a closed spray state, in which the spray fluid is prevented from flowing through the nozzle; and a flow control assembly mountable to and dismountable from the gun body as a single flow module, the flow control assembly biasing the spray valve towards the closed spray state and the flow control assembly biasing an air valve configured to control flow of compressed air to the air cap towards a closed air state, the air valve actuatable between an open air state, in which the compressed air can flow through the air valve, and the closed air state, in which the compressed air is prevented from flowing through the air valve.

According to yet another additional or alterative aspect of the present disclosure, a flow control assembly for use in a spray gun configured to emit spray fluid and compressed air includes a limiter housing extending along an assembly axis; a valve seal extending from the limiter housing and movable relative to the limiter housing, the valve seal configured to shift along the axis to open and close an air valve; a valve spring interfacing with the valve seal and biasing the valve seal to in a first direction along the assembly axis; and a needle return disposed radially inward of the valve seal. The needle return includes a return block disposed at least partially within the valve seal; and a return spring biasing the return block in the first direction along the assembly axis. The flow control assembly is formed as a single module configured to be mounted to and dismounted from the spray gun as the single module.

According to yet another additional or alterative aspect of the present disclosure, a spray gun includes an air cap supported by the gun body, the air cap configured to output compressed air; a spray valve formed between a needle at least partially disposed within the gun body and a seat, the needle movable along an axis to place the spray valve in an open state, in which the needle is spaced from the seat, and in a closed state, in which the needle is engaged with the seat; and a valve lock selectively engageable with the spray valve, wherein the valve lock drivingly engages with the needle with the spray gun in a spray state and is drivingly disengaged from the needle with the spray gun in a non-spray state.

According to yet another additional or alterative aspect of the present disclosure, a spray gun includes a gun body having a gun bore formed therein; an air cap supported by the gun body, the air cap configured to output compressed air; a spray control assembly mountable to the gun body; and a valve lock. The spray control assembly includes a cartridge body elongate along a cartridge axis, the cartridge body mountable to the gun body; a nozzle formed at a first end of the cartridge body; a spray valve disposed within the cartridge body; and a needle partially disposed within the cartridge body and extending out of the cartridge body through a second end of the cartridge body opposite the first end of the cartridge body, the needle including a needle tip configured to engage with the seat to place a spray valve in a closed state and including a needle head at an opposite end of the needle from the needle tip. The valve lock is selectively engageable with the needle, wherein the valve lock is drivingly engaged with the needle with the spray gun in a spray state and is drivingly disengaged from the needle with the spray gun in a non-spray state.

According to yet another additional or alterative aspect of the present disclosure, a method of mounting a spray control assembly configured to control emission of spray fluid from a nozzle to a spray gun includes aligning the spray control assembly with a gun bore formed in a gun body of the spray gun; shifting the spray control assembly in a first axial direction along an axis through the gun bore such that the spray control assembly enters into the gun bore through a front end of the spray gun; and fixing a cartridge body of the spray control assembly to the gun body. A needle of the spray control assembly extends out of the cartridge body in the first axial direction, the needle aligned with a valve lock disposed within the gun body by shifting the spray control assembly and fixing the cartridge body, wherein the valve lock is selectively engageable with the needle such that the valve lock is drivingly engaged with the needle with the spray gun in a spray state and the valve lock is drivingly disengaged from the needle with the spray gun in a non-spray state.

According to yet another additional or alterative aspect of the present disclosure, a method of spraying with a spray gun includes shifting a valve lock along an axis and into a lock bore, the lock bore biasing a needle detent of the valve lock radially inwards to axially overlap with a needle head of a needle, the needle configured to engage with a seat to place a spray valve of the spray gun in a closed state in which spray fluid is prevented from flowing through the nozzle and the needle disengaged from the seat to place the spray valve in an open state in which the spray valve can flow through the nozzle for spraying; engaging the needle head with the needle detent; and exerting a driving force on the needle head in a first axial direction and displacing the needle in the first axial direction by the needle detent engaging with the needle head to displace the needle relative to the seat and place the spray valve in the open state.

According to yet another additional or alterative aspect of the present disclosure, a displacement limiter for a spray gun includes a limiter housing extending between a first end and a second end, the limiter housing having a limiter bore extending fully therethrough along an axis; a positioner disposed at least partially within the limiter bore and extending out of the limiter housing through the second end, the positioner including a positioner body disposed within the limiter bore, a positioner shaft extending from the positioner body and towards the first end, and a positioner head disposed outside of the limiter bore; a stop mounted to the positioner shaft by interfaced threading between the stop and the positioner shaft; a knob mounted on the positioner head; and at least one knob detent supported by one of the limiter housing and the knob, the at least one knob detent seated in a catch of an array of catches formed on the other one of the limiter housing and the knob. Rotation of the knob rotates the positioner and axially displaces the stop along the axis by the threaded interface. Rotation of the knob causes the at least one knob detent to transition between individual catches of the array of catches and provide feedback regarding a rotational position of the knob.

According to yet another additional or alterative aspect of the present disclosure, a displacement limiter for a spray gun includes a limiter housing extending between a first end and a second end, the limiter housing having a limiter bore extending fully therethrough along an axis; a positioner disposed at least partially within the limiter bore and extending out of the limiter housing through the second end, the positioner including positioner shaft; a stop mounted to the positioner shaft by interfaced threading between the stop and the positioner shaft; a knob mounted on the positioner at a location outside of the limiter housing; a first indicator formed on an exterior of the limiter housing; and a second indicator formed on an exterior of the knob. Rotation of the knob rotates the positioner and axially displaces the stop along the axis by the threaded interface. Alignment and misalignment of the first indicator and the second indicator provides visual feedback regarding an axial position of the stop.

According to yet another additional or alterative aspect of the present disclosure, a spray gun includes a gun body having a gun bore extending fully therethrough along a spray axis; a spray valve supported by the gun body, the spray valve formed at an interface between a needle and a seat, the needle configured to shift along the spray axis relative to the seat to actuate the spray valve between an open state and a closed state; and a displacement limiter mounted to the gun body. The displacement limiter includes a limiter housing extending between a first end and a second end, the limiter housing having a limiter bore extending fully therethrough along the spray axis; a positioner disposed at least partially within the limiter bore and extending out of the limiter housing through the second end, the positioner including a positioner shaft extending towards the first end; a stop mounted to the positioner shaft by interfaced threading between the stop and the positioner shaft; a knob mounted on the positioner head; and at least one knob detent supported by one of the limiter housing and the knob, the at least one knob detent seated in a catch of an array of catches formed on the other one of the limiter housing and the knob. Rotation of the knob rotates the positioner and axially displaces the stop along the axis by the threaded interface. Rotation of the knob causes the at least one knob detent to transition between individual catches of the array of catches and provide feedback regarding a rotational position of the knob. The stop is disposed on the spray axis and is positioned to limit displacement of the needle axially away from the seat.

According to yet another additional or alterative aspect of the present disclosure, a method of setting an opening distance of a spray valve of a spray gun includes rotating a knob of a displacement limiter mounted to a gun body of the spray gun in a first rotational direction to displace a stop of the displacement limiter to a blocking position in which an opening size of a spray valve of the spray gun is at a minimum, wherein rotation of the knob rotates a positioner of the displacement limiter within a limiter housing of the displacement limiter, the positioner displacing the stop along a spray axis of the spray gun by a threaded interface between the positioner and the stop; disconnecting the knob from the positioner; repositioning the knob about the spray axis to align a first indicator on the knob with a second indicator on the limiter housing; and fixing the knob to the positioner such that the first indicator is aligned with the second indicator with the stop in the blocking position.

According to yet another additional or alterative aspect of the present disclosure, a metering valve for controlling flow of compressed air into a spray gun includes a meter mount extending along a valve axis; a meter sleeve connected to the meter mount; a meter piston disposed at least partially within the meter mount, the meter piston including a seal head engaged with a meter seat to prevent flow through the metering valve and the seal head disengaged from the meter seat to allow flow through the metering valve; and a bearing supporting the metering piston on the meter sleeve. Displacing the meter sleeve in a first direction along the valve axis exerts a first axial force on the bearing such that the bearing displaces the meter piston in the first direction. Displacing the meter sleeve in a second direction along the valve axis exerts a second axial force on the bearing such that the bearing displaces the meter piston in the second direction.

According to yet another additional or alterative aspect of the present disclosure, a metering valve for controlling flow of compressed air into a spray gun includes a meter mount extending along a valve axis between a gun connector configured to mount to the spray gun and a retaining flange; a meter sleeve connected to the meter mount; and a meter piston disposed at least partially within the meter mount and supported by the meter sleeve, the meter piston including a seal head configured to engage with a meter seat to prevent flow of the compressed gas and configured to be disengaged from the meter seat to allow flow of the compressed gas. Displacing the meter sleeve in a first direction along the valve axis displaces the meter piston in the first direction to shift the seal head axially towards the meter seat. Displacing the meter sleeve in a second direction along the valve axis displaces the meter piston in the second direction to shift the seal head axially away from the meter seat.

According to yet another additional or alterative aspect of the present disclosure, a method of controlling compressed air flow to a spray gun configured to emit spray fluid and the compressed air includes rotating a meter sleeve in a first rotational direction about a valve axis to displace the meter sleeve in a first direction along a meter mount that is mounted to the spray gun; and displacing a meter piston in the first direction by a bearing extending between and mounting the meter piston to the meter sleeve, wherein the meter piston moving in the first direction moves a seal head of the meter piston away from a meter seat to open a flowpath therebetween.

According to yet another additional or alterative aspect of the present disclosure, a needle for a spray valve of a spray gun, the needle configured to engage with a seat to place the spray valve in a closed state to prevent emission of spray fluid by the spray gun, and the needle configured to be disengaged from the seat to place the spray valve in an open state to allow for emission of the spray fluid. The needle includes a needle body elongate along a needle axis; a needle tip formed at a first axial end of the needle body, the needle tip including a seal region configured to engage with the seat; and a wear head projecting radially outward from an exterior of the needle.

According to yet another additional or alterative aspect of the present disclosure, a needle tip of a needle for a spray valve of a spray gun, the needle tip configured to engage with a seat to place the spray valve in a closed state to prevent emission of spray fluid by the spray gun, and the needle tip configured to be disengaged from the seat to place the spray valve in an open state to allow for emission of the spray fluid. The needle tip includes a seal region configured to engage with the seat; and a wear head projecting radially outward from an exterior of the needle tip.

According to yet another additional or alterative aspect of the present disclosure, a spray valve for controlling flow of spray fluid through a nozzle of a spray gun includes a seat; and a needle configured to shift along a needle axis relative to the seat. The needle includes a needle body elongate along a needle axis; a needle tip formed at a first axial end of the needle body, the needle tip including a seal region configured to engage with the seat with the spray valve in a closed state; and a wear head projecting radially outward from an exterior of the needle.

According to yet another additional or alterative aspect of the present disclosure, a spray control assembly mountable to a spray gun as a single module includes a cartridge body defining a flow chamber within an interior of the cartridge body; a nozzle formed at a first end of the cartridge body, the nozzle configured to output spray fluid from the flow chamber; a seat disposed within the cartridge body; and a needle elongate along a needle axis. The needle includes a needle body elongate along a needle axis, the needle body extending from within the flow chamber and out of the cartridge body through a second end of the cartridge body; a needle tip formed at a first axial end of the needle body, the needle tip including a seal region configured to engage with the seat to place the spray valve in a closed state; and a wear head projecting radially outward from an exterior of the needle. A flow restriction is formed between the wear head and the cartridge body at a location spaced axially from the seal region.

According to yet another additional or alterative aspect of the present disclosure, a spray control assembly mountable to a spray gun as a single module, the spray control assembly including a cartridge body defining a flow chamber within an interior of the cartridge body; a nozzle formed at a first end of the cartridge body, the nozzle configured to output spray fluid from the flow chamber; a seat disposed within the cartridge body; and a needle elongate along a needle axis. The needle includes a needle body elongate along a needle axis, the needle body extending from within the flow chamber and out of the cartridge body through a second end of the cartridge body; a needle tip formed at a first axial end of the needle body, the needle tip including a seal region configured to engage with the seat to place the spray valve in a closed state; and a wear head projecting radially outward from an exterior of the needle. The needle is configured to shift axially away from the seat to open a flowpath through the nozzle. The seal region defines a flow constriction for a first needle displacement distance of the needle axially away from the seat. A portion of the needle tip downstream of the seal region defines the flow constriction for a second needle displacement distance of the needle axially away from the seat. The second needle displacement distance is at least three times larger than the first needle displacement distance.

According to yet another additional or alterative aspect of the present disclosure, a spray gun configured to emit spray fluid and compressed air includes a gun body; a seat supported by the gun body; and a needle configured to shift along a needle axis relative to the seat. The needle includes a needle body elongate along a needle axis; a needle tip formed at a first axial end of the needle body, the needle tip including a seal region configured to engage with the seat to place a spray valve in a closed state; and a wear head projecting radially outward from an exterior of the needle.

According to yet another additional or alternative aspect of the disclosure, a cap assembly for a spray gun configured to output an atomized fluid spray includes an air cap having a spray opening oriented on an axis; and a cap retainer configured to interface with the air cap and with a gun body of the spray gun to connect the air cap to the spray gun. The cap retainer includes a retainer body extending about the axis and having a first axial end and a second axial end; an array of detents disposed about the axis and supported by the retainer body; and a cap lock supported by the retainer body, the cap lock movable relative to the retainer body and along the axis to place the cap retainer in a locked state, in which a blocker of the cap lock is disposed over the array of detents to inhibit radial movement of the array of detents away from the axis, and an unlocked state, in which the blocker is spaced axially from the array of detents.

According to yet another additional or alternative aspect of the disclosure, a cap assembly for a spray gun configured to output an atomized fluid spray includes an air cap having a spray opening oriented on an axis; and a cap retainer configured to interface with the air cap and with a gun body of the spray gun to connect the air cap to the spray gun. The cap retainer includes a retainer body extending about the axis and having a first axial end with a cap opening formed therethrough and a second axial end with a body opening formed therethrough, the retainer body defining a receiving chamber; an array of detents disposed about the axis and supported by the retainer body; a cap lock supported by the retainer body, the cap lock movable relative to the retainer body and along the axis between a locked state, in which a blocker of the cap lock is disposed over the detents to inhibit radial movement of the detents away from the axis to maintain the detents in respective engaged states in which the detents project through the retainer body and into the receiving chamber, and an unlocked state, in which the blocker is spaced axially from the detents such that the detents can shift radially outward to a disengaged state; a stop block disposed between the blocker and the second axial end, the stop block configured to limit displacement of the cap lock towards the second axial end; and a position lock configured to interface with the cap lock to maintain the cap lock in a position associated with the locked state. The array of detents is disposed axially between the stop block and the position lock.

According to yet another additional or alternative aspect of the disclosure, a method of assembling a cap assembly to a gun body of a spray gun includes displacing the cap assembly in a first direction along an assembly axis of the cap assembly and such that the gun body enters into a receiving chamber within a retainer body of the cap assembly, the retainer body extending about the axis and having a first axial end and a second axial end; and displacing a cap lock supported by the retainer body in the first axial direction and relative to the retainer body such that a blocker of the cap lock is disposed over an array of detents disposed about the axis and supported by the retainer body to inhibit radial movement of the array of detents away from the axis, thereby placing the cap assembly in a locked state.

### BRIEF DESCRIPTION OF THE DRAWINGS

FIG. 1 is a schematic block diagram of a spray system.

FIG. 2A is a first isometric view of a spray gun.

FIG. 2B is a second isometric view of a spray gun.

FIG. 3A is a cross-sectional view taken along line 3-3 in FIG. 2A showing the spray valve in a closed state.

FIG. 3B is a cross-sectional view taken along line 3-3 in FIG. 2A showing the spray valve in an open state.

FIG. 4A is an isometric view of a spray control assembly.

FIG. 4B is a side elevational view of the spray control assembly.

FIG. 4C is an isometric cross-sectional view of the spray control assembly taken along line 4-4 in FIG. 4A.

FIG. 4D is an elevational cross-sectional view of the spray control assembly taken along line 4-4 in FIG. 4D.

FIG. 5A is an enlarged view of detail 5 in FIG. 3A.

FIG. 5B is an enlarged view of detail 5 in FIG. 3B.

FIG. 6A is an enlarged view of detail 6 in FIG. 2B.

FIG. 6B is a cross-sectional view showing a displacement limiter mounted to a gun body.

FIG. 6C is another cross-sectional view of displacement limiter.

FIG. 6D is a cross-sectional view taken along line D-D in FIG. 6C.

FIG. 7 is an isometric view of a spray gun.

FIG. 8A is a cross-sectional view taken along line 8-8 in FIG. 7 showing the spray valve in a closed state.

FIG. 8B is a cross-sectional view taken along line 8-8 in FIG. 7 showing the spray valve in an open state.

FIG. 9A is an isometric view of a spray control assembly.

FIG. 9B is an isometric cross-sectional view of the spray control assembly taken along line 9-9 in FIG. 9A.

FIG. 9C is an elevational cross-sectional view of the spray control assembly taken along line 9-9 in FIG. 9A.

FIG. 10A is an isometric view of a flow control assembly.

FIG. 10B is an isometric cross-sectional view of the flow control assembly taken along line 10-10 in FIG. 10A.

FIG. 10C is an elevational cross-sectional view of the flow control assembly taken along line 10-10 in FIG. 10A.

FIG. 11A is an isometric view showing a metering valve mounted to a spray gun.

FIG. 11B is a cross-sectional view taken along line 11-11 in FIG. 11A showing the metering valve in an open state.

FIG. 11C is a cross-sectional view taken along line 11-11 in FIG. 11A showing the metering valve in a closed state.

FIG. 12 is an isometric view of a needle for a spray valve.

FIG. 13A is a cross-sectional view showing a spray valve in a closed state.

FIG. 13B is a cross-sectional view showing the spray valve in an open state.

FIG. 14 is an elevational view of a needle tip.

FIG. 15 is a graph illustrating the flow area through a spray valve for a needle including a wear head versus a prior art needle that does not include a wear head.

FIG. 16 is an enlarged cross-sectional view showing a spray valve in a closed state.

FIG. 17 is an elevational cross-sectional view of a portion of a manual spray gun with a valve lock for selectively engaging with a needle to actuate a spray valve to an open state.

FIG. 18A is an isometric view of a spray control assembly.

FIG. 18B is an isometric cross-sectional view of the spray control assembly taken along line 18-18 in FIG. 18A.

FIG. 18C is an enlarged cross-sectional view showing a portion of the spray control assembly mounted to a spray gun.

FIG. 19A is an isometric view of a spray control assembly.

FIG. 19B is an isometric cross-sectional view of the spray control assembly taken along line 19-19 in FIG. 19A.

FIG. 19C is an enlarged cross-sectional view showing a portion of the spray control assembly mounted to a spray gun.

FIG. 20A is an isometric view of a cap assembly.

FIG. 20B is an exploded view of the cap assembly.

FIG. 20C is a cross-sectional view of the cap assembly taken along line 20-20 in FIG. 20A showing the cap assembly in a locked state.

FIG. 20D is a cross-sectional view of the cap assembly taken along line 20-20 in FIG. 20A showing the cap assembly in an unlocked state.

FIG. 21 is an enlarged isometric cross-sectional view showing the cap assembly mounted to a gun body of a spray gun.

### DETAILED DESCRIPTION

This disclosure relates to fluid spraying. More specifically, this disclosure relates to air spraying. Spray guns according to this disclosure are configured to emit a spray of spray fluid, such as liquid paints, varnishes, lacquers, fine finishes, high-gloss finishes, waterborne coatings, solvent-borne coatings, etc. The spray gun can be used to apply coatings to surfaces, furniture, cabinets, appliances, equipment, fabricated components, etc., among other options. The spray gun also emits compressed air. An atomization portion of the compressed air is configured to atomize spray fluid and complete the atomization of the fan tails, preventing undesired tailing. A shaping portion of the compressed air is configured to shape the spray pattern. The spray fluid is emitted through a nozzle and the air is emitted through an air cap surrounding the nozzle. The atomization air is emitted with each actuation of the spray gun to a spray state while the fan air can be set by the user between no fan air and a maximum flow. Spray guns according to the present disclosure can be automatic spray guns that are manipulated and caused to spray by a control system or can be manual spray guns that are manipulated and caused to spray by a user.

Spray guns according to the present disclosure can include a spray fluid cartridge that is mountable to and dismountable from the spray gun as a single unit. The spray fluid cartridge includes the movable valving component, such as a needle, that shifts relative to a seat to open and close the path of the spray fluid through the spray gun. The spray fluid cartridge is configured to receive the spray fluid and route the spray fluid to the nozzle for output. The spray fluid cartridge can further include baffles and/or passages for routing one or more portions of the compressed airflow for emission from the air cap. The spray fluid cartridge facilitates mounting and dismounting of the spray fluid control components of the spray gun as a single unit. The spray fluid cartridge can be configured to mount and dismount without the user having to access the air valving side of the spray gun.

Additionally or alternatively, spray guns according to the present disclosure can include a valve lock. The valve lock engages with the needle to exert a driving force on the needle of the spray valve to drive the needle away from the seat of the spray valve to actuate the spray valve from a closed state, in which the needle is engaged with a seat, to an open state, in which the needle is disengaged from the seat. The valve lock is configured to selectively engage with and disengage from the needle. The valve lock can lock with the needle during actuation of the spray gun from a non-spray state to a spray state such that the valve lock can exert the driving force. The valve lock can be unlocked from the needle with the spray gun in the non-spray state, allowing the needle to be dismounted from the valve lock without the user manipulating components of the valve lock. The needle can thus be mounted to or dismounted from the valve lock without requiring the user to access or manipulate the components to connect or disconnect the needle from the valve lock that actuates the needle to place spray valve in the open state.

Additionally or alternatively, spray guns according to the present disclosure can include an air cartridge that is mountable to and dismountable from the spray gun as a single unit. The air cartridge forms at least a portion of an air valve configured to control flows of the compressed airflow to the air cap. The air cartridge can interface with components of the spray valve to control the maximum opening distance of the spray valve. Components of the air cartridge can interface with the needle to displace the needle towards and into engagement with the seat to place the spray valve in the closed state. In this way, the air cartridge can be utilized control flow of the spray fluid from the spray gun.

Additionally or alternatively, spray guns according to the present disclosure can include a displacement limiter. The displacement limiter is configured to set a distance that the needle of the spray valve can travel between the closed and open states. The displacement limiter thereby sets the distance that the spray valve can open, controlling a flow rate and emission of the spray fluid. The displacement limiter can include indexes configured to provide feedback to the user as to the position of a stop configured to set the maximum opening distance of the spray valve, thereby providing information regarding the opening distance of the spray valve to the user. The indexes can be configured to provide audio feedback, haptic feedback, visual feedback, etc.

Additionally or alternatively, a metering valve can be associated with the spray gun to control airflow into the spray gun. The metering valve can be actuated between a closed state, in which the compressed air is prevented from flowing downstream through the metering valve, and an open state, in which the compressed air can flow through the metering valve. The metering valve can be mounted to the spray gun to be supported by the spray gun. The metering valve is configured to connect with an air hose that supplies compressed air to the air gun from a compressed air source. The metering valve can be configured such that the air hose can freely pivot relative to the spray gun while connected to the metering valve.

Additionally or alternatively, the spray valve needle can include a wear head formed at a downstream end of the needle. The wear head is a radial enlargement on the exterior of the needle. The wear head is disposed downstream of the portion of the needle that engages with and seals against the seat with the spray valve in a closed state. The wear head is configured to reduce a velocity of the spray fluid as the spray fluid flows over the sealing portion of the needle and downstream towards the nozzle orifice. The wear head shifts the location of the smallest flow area between the needle and nozzle from between the sealing portion and nozzle to between the wear head and nozzle. The smallest flow area experiences the greatest velocity of spray fluid and experiences the greatest wear. Shifting the smallest flow area away from the shoulder reduces wear on the sealing surfaces, providing for a longer operating life, reducing downtime due to worn needles, and reducing user costs.

Components can be considered to radially overlap when those components are disposed at common axial locations along an axis. A radial line extending orthogonally from axis will extend through each of the radially overlapping components. Components can be considered to axially overlap when those components are disposed at common radial and circumferential locations relative to the axis. An axial line parallel to the axis will extend through the axially overlapping components. Components can be considered to circumferentially overlap when those components are disposed at common radial distance and axial locations along the axis, such that a circle centered on the axis passes through each of the circumferentially overlapping components.

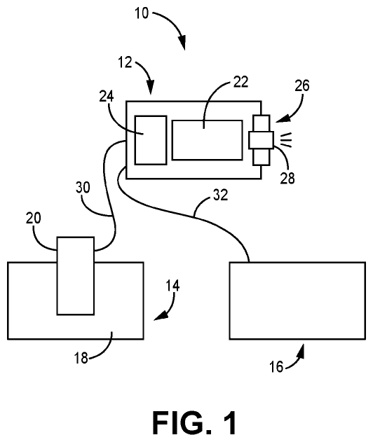

FIG. 1 is a schematic block diagram of a spray system 10. Spray system 10 includes spray gun 12, fluid supply 14, and air supply 16. Fluid supply 14 includes reservoir 18 and pump 20. Spray gun 12 includes spray valve 22, actuator 24, air cap assembly 26, and nozzle 28.

Spray gun 12 is configured to emit a spray of spray fluid for application on a target surface. The spray fluid can be liquid, such as a coating liquid. For example, spray gun 12 can be used to spray paint, lacquer, finishes, and other coatings on furniture, cabinets, appliances, equipment, fabricated components, etc. Spray gun 12 can be configured to emit airflows to assist in atomizing and/or shaping the spray fluid emitted by spray gun 12. As such, spray gun 12 can be configured to emit one or more airflows along with the spray fluid. The air that atomizes the fluid spray can be referred to as “atomization air.” The air that shapes the spray pattern can be referred to as “shaping air” or “fan air.” Spray gun 12 emits the spray fluid through nozzle 28 and emits the airflows proximate the nozzle 28 through air cap assembly 26.

Fluid supply 14 is configured to supply spray fluid to spray gun 12 for spraying. Reservoir 18 is configured to store a supply of spray fluid. For example, reservoir 18 can be a tank, bucket, barrel, or other container suitable for storing a volume of the spray fluid. Pump 20 is configured to drive the spray fluid downstream from reservoir 18 to the spray gun 12 under pressure. Fluid hose 30 extends between and fluidly connects pump 20 and spray gun 12. The pump 20 can be of any type suitable for driving pressurized spray fluid to spray gun 12. For example, the pump 20 can be a piston pump, a diaphragm pump, a rotor-stator pump, a peristaltic pump, a plunger pump, among other options.

Air supply 16 is configured to store and/or generate a supply of compressed air. Air supply 16 is fluidly connected to the spray gun 12 by air hose 32 extending between air supply 16 and spray gun 12. Air supply 16 can be of any configuration suitable for storing and/or generating and supplying compressed air to the spray gun 12. For example, air supply 16 can be an air compressor, one or more pressurized tanks, etc. Air supply 16 can provide a single flow of compressed air to spray gun 12 and spray gun 12 can divide the compressed air to the atomization air and shaping air. While spray gun 12 is described as utilizing compressed air, such as compressed atmospheric air, it is understood that any desired compressed gas suitable for spray operations can be used, such as nitrogen gas among other options.

Spray valve 22 is configured to control flow of the spray fluid to nozzle 28. Spray valve 22 is disposed within the body of spray gun 12. Spray valve 22 is disposed upstream of nozzle 28. Spray valve 22 is actuatable between an open state, in which the spray fluid can flow through the spray valve 22 and to and though nozzle 28 for atomization, and a closed state, in which the spray fluid is prevented from flowing through the spray valve 22 and to the nozzle 28. The spray valve 22 can be of any type suitable for controlling flow of the spray fluid. For example, the spray valve 22 can be a needle valve, among other options.

Spray valve 22 is operatively connected to actuator 24. Actuator 24 is configured to actuate the spray valve 22 between the open and closed states. Actuator 24 can be mechanically connected to a movable component of spray valve 22 to displace that movable component and actuate the spray valve 22 between the open and closed states. In some examples, the actuator 24 can include a first displacer configured to actuate the spray valve 22 from the closed state to the open state and the actuator 24 can include a second displacer configured to actuate the spray valve 22 from the open state to the closed state.

Spray gun 12 can be configured as an automatic spray gun or a manual spray gun. In automatic spray gun examples, the spray gun 12 can be oriented and caused to spray by a controller (e.g., having a computer readable memory and control circuitry). The actuator 24 in such automatic spray gun examples can be pneumatically powered to actuate the spray valve 22. In some examples, the actuator 24 can be pneumatically displaced (e.g., by the compressed air from air supply 16) to shift the spray valve 22 to the open state and the actuator 24 can be mechanically displaced (e.g., by a spring) to shift the spray valve 22 to the closed state. In some examples, the compressed air from air supply 16 can cause the actuator 24 to displace the spray valve 22 both from the closed state to the open state and from the open state to the closed state. In manual spray gun examples, the actuator 24 can include a trigger that is depressed by the user. Depressing the trigger can cause the spray valve 22 to shift from the closed state to the open state. Releasing the trigger can cause the spray valve 22 to shift from the open state to the closed state. In some examples, actuating the trigger can direct compressed air to cause displacement of a piston, which piston is operatively connected to the spray valve 22 to displace the moving member of the spray valve 22. In some examples, the trigger mechanically actuates the spray valve 22 to an open state and spray gun 12 includes a spring that actuates the spray valve 22 from the open state to the closed state. In some manual gun examples, the actuator 24 can be pneumatically displaced to actuate the spray valve 22 to the open state and to actuate the spray valve 22 to the closed state.

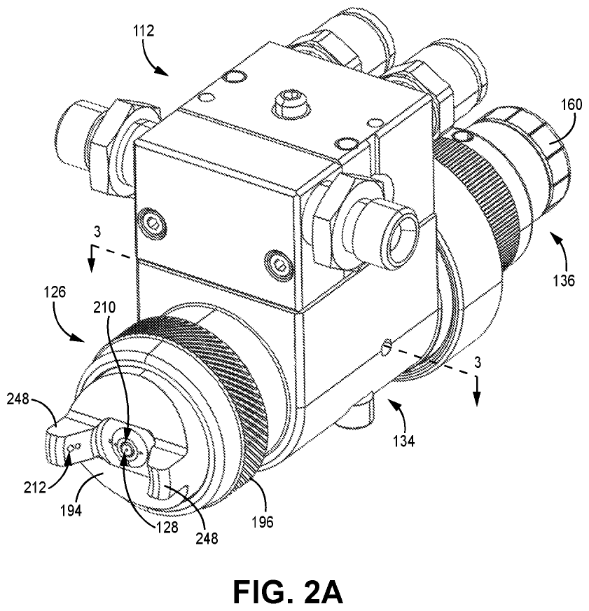

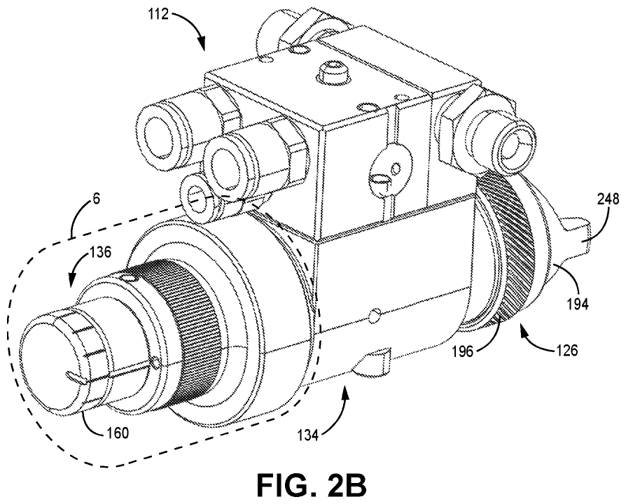

FIG. 2A is a first isometric view of spray gun 112. FIG. 2B is a second isometric view of spray gun 112. FIGS. 2A and 2B will be discussed together. Gun body 134, air cap assembly 126, and displacement limiter 136 of spray gun 112 are shown. Spray gun 112 is an automatic spray version of spray gun 12.

Spray gun 112 is configured to receive pressurized spray fluid and to output that spray fluid as an atomized fluid spray. Spray gun 112 is configured to emit the spray fluid along spray axis SA. In the example shown, spray gun 112 is an automatic spray gun. Gun body 134 supports other components of spray gun 112. Air cap assembly 126 is disposed at a first axial end of gun body 134. Air cap assembly 126 is supported by gun body 134. Air cap assembly 126 can be mounted directly to gun body 134, such as by a threaded interface among other options. Air cap assembly 126 is configured to direct compressed air flows for atomizing and, in some examples, shaping of the spray fluid output by spray gun 112.

Displacement limiter 136 is supported by gun body 134. Displacement limiter 136 is disposed at a second axial end of gun body 134. Displacement limiter 136 is disposed at an opposite end of gun body 134 from air cap assembly 126. Displacement limiter 136 is operatively associated with the spray valve 122 of spray gun 112 and is configured to set a distance that the movable component of spray valve 122 can displace to the fully open state, as discussed in more detail below.

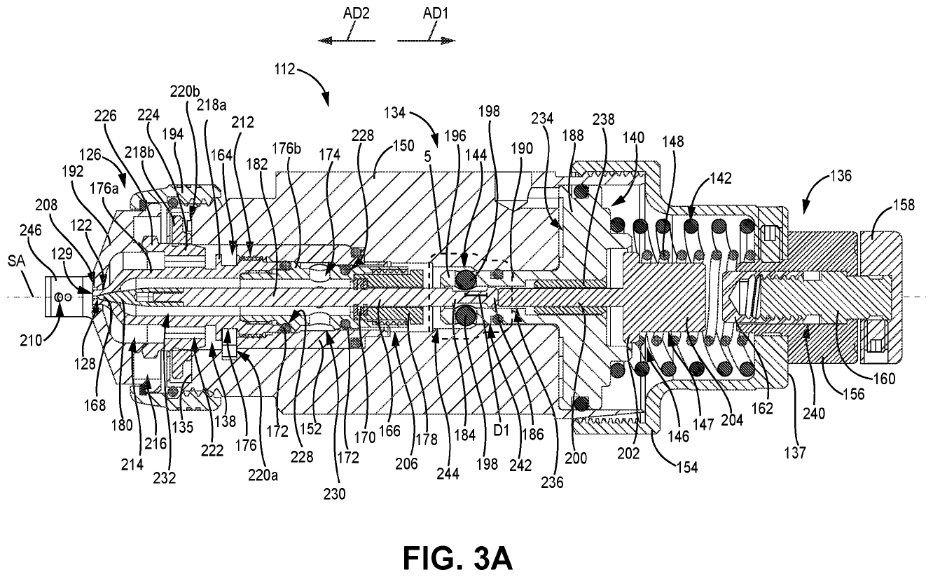

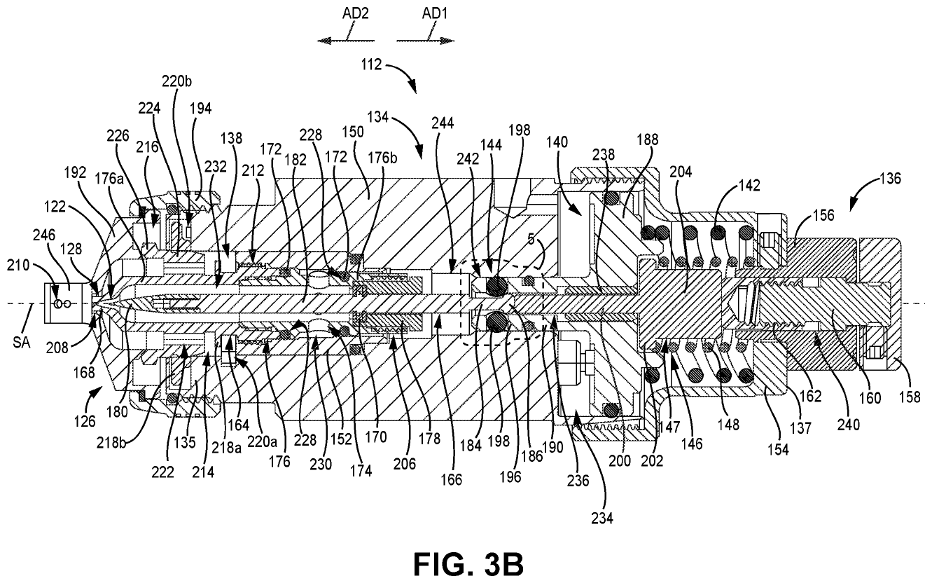

FIG. 3A is a cross-sectional view taken along line 3-3 in FIG. 2A showing the spray valve 122 in a closed state. FIG. 3B is a cross-sectional view taken along line 3-3 in FIG. 2A showing the spray valve 122 in an open state. FIGS. 3A and 3B will be discussed together. Spray gun 112 includes gun body 134, displacement limiter 136, spray control assembly 138, spray valve 122, piston 140, air cap assembly 126, nozzle 128, piston spring 142, valve lock 144, and needle return 146.

Gun body 134 includes main body 150, gun mount 152, and piston cap 154. Displacement limiter 136 includes limiter housing 156, knob 158, positioner 160, and stop 162. Spray control assembly 138 includes cartridge body 164, needle 166, seat 168, needle seal 170, cartridge seals 172, and fluid ports 174. Cartridge body 164 includes housing 176 and seal holder 178. Housing 176 includes outlet housing 176a and inlet housing 176b. Needle 166 includes needle tip 180, needle body 182, needle neck 184, and needle head 186. Piston 140 includes piston head 188 and piston shaft 190. Air cap assembly 126 includes air cap 192 and cap retainer 194. Valve lock 144 includes carrier 196 and needle detents 198. Needle return 146 includes return block 147 and return spring 148. Return block 147 includes return rod 200, return flange 202, and return body 204.

Spray gun 112 is configured to receive flows of spray fluid and compressed air and to emit an atomized spray of the spray fluid for application on a target surface. Spray gun 112 is configured as an automatic spray gun, though it is understood that not all examples are so limited. The spray gun 112 sprays along a spray axis SA. The axis also represents an upstream side or direction and a downstream side or direction, wherein spray fluid generally flow from the upstream direction towards the downstream direction. In the example shown, the downstream direction is the second axial direction AD2 and the upstream direction is the first axial direction AD1.

Gun body 134 supports other components of spray gun 112. Gun body 134 at least partially houses and at least partially contains other components of spray gun 112. Main body 150 supports other components of spray gun 112. Gun bore 206 extends axially through main body 150. Gun bore 206 extends fully axially through main body 150 in the example shown. Gun bore 206 is formed from a series of bores having varying diameters.

Gun mount 152 is disposed within main body 150. For example, gun mount 152 can be press-fit or otherwise secured within main body 150. In the example shown, gun mount 152 is mounted within gun bore 206. Gun mount 152 at least partially defines the spray fluid pathway through spray gun 112. Gun mount 152 can be considered to form a wet component of spray gun 112 as gun mount 152 is exposed to the spray fluid during operation. Piston cap 154 is mounted to main body 150. Piston cap 154 is disposed at an opposite axial end of spray gun 112 from air cap assembly 126. Piston cap 154 at least partially defines the chamber that piston 140 reciprocates within.

Air cap assembly 126 is disposed at a first axial end of gun body 134. Central orifice 208 is formed through air cap 192. Central orifice 208 is disposed on spray axis SA. Central orifice 208 is configured to emit atomization air from air cap 192. Shaping orifices 210 are formed in horns 246 of air cap 192. Shaping orifices 210 are configured to emit shaping air from air cap 192.

Air cap 192 is mounted to gun body 134 by cap retainer 194. Cap retainer 194 extends over air cap 192 and interfaces with gun body 134 to secure air cap 192 to gun body 134. Cap retainer 194 is connected to gun body 134 by a threaded interface in the example shown, though it is understood that other connection types are possible. Air cap 192 is configured to emit both atomizing air and shaping air.

Spray control assembly 138 is configured to control emission of the spray fluid from spray gun 112. Spray control assembly 138 is mounted to gun body 134. Spray control assembly 138 can be at least partially disposed within gun body 134. Spray control assembly 138 forms a spray control cartridge that is mountable to and dismountable from gun body 134 as a unitary assembly. The spray control assembly 138 can be mounted and dismounted without manipulating or disconnecting components of gun body 134. Instead, the spray control assembly 138 can be accessed simply by removing air cap assembly 126.

Spray control assembly 138 is mounted at least partially within gun bore 206. Spray control assembly 138 is insertable into gun bore 206 and removable from gun bore 206 through a first axial end of gun body 134. Spray control assembly 138 is insertable into and removable from gun body 134 through a front end 135 of gun body 134.

Cartridge body 164 is at least partially disposed within gun body 134. Cartridge body 164 is secured within gun body 134 to secure spray control assembly 138 relative to gun body 134. In the example shown, cartridge body 164 is mounted to gun mount 152. Cartridge body 164 extends into gun mount 152 to interface with gun mount 152. In the example shown, cartridge body 164 extends fully axially through gun mount 152 such that cartridge body 164 projects out of gun mount 152 in both first axial direction AD1 and second axial direction AD2.

Cartridge body 164 includes housing 176 that is configured to interface with a portion of gun body 134 to mount spray control assembly 138 to gun body 134. Cartridge body 164 includes seal holder 178 that mounts to housing 176. Housing 176 and seal holder 178 form the exterior of cartridge body 164. In the example shown, nozzle 128 is formed by housing 176. Nozzle 128 is formed at a first axial end of housing 176 and seal holder 178 is mounted to a second axial end of housing 176 opposite the first axial end of housing 176.

Cartridge mount 212 is formed on an exterior of cartridge body 164. In the example shown, cartridge mount 212 is formed on housing 176. Cartridge mount 212 is configured to interface with a portion of gun body 134 to secure spray control assembly 138 to gun body 134. In the example shown, cartridge mount 212 is formed by threads on the exterior of outlet housing 176a. Cartridge mount 212 is configured to engage with threading on gun mount 152 to secure spray control assembly 138 within gun body 134.

In the example shown, housing 176 is formed from outlet housing 176a and inlet housing 176b mounted together. Outlet housing 176a is configured to emit spray fluid from spray control assembly 138. Inlet housing 176b is configured to receive spray fluid into spray control assembly 138. Inlet housing 176b and outlet housing 176a are connected together to form housing 176. In the example shown, inlet housing 176b and outlet housing 176a are connected together by a threaded interface. In the example shown, outlet housing 176a includes female threading configured to interface with male threading formed on inlet housing 176b.

Baffle 218a is formed on the exterior of cartridge body 164. Baffle 218a extends radially from housing 176. In the example shown, baffle 218a extends radially from outlet housing 176a. In the example shown, baffle 218a is formed as a flange extending radially outwards from cartridge body 164. Baffle 218a extends annularly about cartridge body 164 in the example shown. Baffle 218a can be integrally formed with other portions of cartridge body 164. In some examples, baffle 218a can be formed monolithically with other portions of cartridge body 164. In the example shown, baffle 218a is monolithic with housing 176. In the example shown, baffle 218a is monolithic with outlet housing 176a.

Baffle 218a is configured to distribute a first portion of the compressed air annularly about the spray axis SA as the first portion of the compressed air flows in second axial direction AD2. The first portion of the compressed air forms the atomization air in the example shown.

An inner air chamber 214 is configured to route the first portion of the compressed air to the central orifice 208. The inner air chamber 214 is formed about the spray axis SA. The inner air chamber 214 is a dry portion of the spray gun 112 that routes compressed air and does not route or handle spray fluid. The spray fluid flows at locations radially within inner air chamber 214, within flow chamber 232 through cartridge body 164, but the spray fluid does not flow in the inner air chamber 214. The spray fluid is isolated from the compressed air while within gun body 134 but the flowpaths of the spray fluid and compressed air can radially overlap while flowing within pathways defined by the spray control assembly 138.

The inner air chamber 214 is disposed about an exterior of the cartridge body 164. In the example shown, a portion of the inner air chamber 214 is radially bracketed by the cartridge body 164 such that a radially outer side of that portion of the inner air chamber 214 is defined by the cartridge body 164 and a radially inner side of that portion of the inner air chamber 214 is defined by the cartridge body 164. The inner air chamber 214 is disposed axially between gun mount 152 and central orifice 208.

The first portion of the compressed air enters into the inner air chamber 214 through aperture 220a on one axial side of the baffle 218a. The first portion of the compressed air flows in second axial direction AD2 over baffle 218a, through air passages 222 in cartridge body 164 and downstream to central orifice 208. The first portion of the compressed air exits spray gun 112 through central orifice 208 in air cap 192. The first portion of the compressed air exits spray gun 112 through an annular ring formed about the portion of the cartridge body 164 defining nozzle 128. The compressed air exiting central orifice 208 impinges on the spray fluid exiting from nozzle 128 to atomize the spray fluid.

Baffle 218b is disposed on the exterior of cartridge body 164. Baffle 218b extends radially from housing 176. In the example shown, baffle 218b extends radially from outlet housing 176a. More specifically, the baffle 218b extends radially outward from an outer radial surface of collar 224, in the example shown. In the example shown, baffle 218b is formed as a flange extending radially outwards from cartridge body 164. Baffle 218b extends annularly about cartridge body 164 in the example shown. Baffle 218b can be integrally formed with other portions of cartridge body 164 or can be formed separately from cartridge body 164 and assembled to cartridge body 164. In some examples, baffle 218b can be formed monolithically with other portions of cartridge body 164. In the example shown, baffle 218b is formed separately from outer housing 176 and connected to outlet housing 176a. While baffle 218b is formed as a component of spray control assembly 138 in the example shown, it is understood that not all examples are so limited. In some examples, baffle 218b can be mounted to or integrated with gun body 134 such that baffle 218b does not mount to and dismount from gun body 134 with spray control assembly 138.

Baffle 218b is configured to distribute a second portion of the compressed air annularly about the spray axis SA as the second portion of the compressed air flows in second axial direction AD2. The second portion of the compressed air forms the shaping air in the example shown. An outer air chamber 216 is configured to route the second portion of the compressed air to the shaping orifices 210. Shaping orifices 210 are formed in horns 246 of air cap 192. Shaping orifices 210 are configured to emit shaping air from air cap 192. The outer air chamber 216 is formed about the spray axis SA. The outer air chamber 216 is disposed about an exterior of the cartridge body 164. Outer air chamber 216 is disposed radially outward of inner air chamber 214. In the example shown, a portion of the outer air chamber 216 radially overlaps with a portion of the inner air chamber 214. Outer air chamber 216 radially overlaps with inner air chamber 214 and with flow chamber 232 within spray control assembly 138. Outer air chamber 216 is a dry path through spray gun 112 that is exposed to and conveys compressed air but is not exposed to and does not convey spray fluid. Outer air chamber 216 extends from air aperture 220b and into air cap 192.

The second portion of the compressed air enters into the outer air chamber 216 through air aperture 220b on one axial side of the baffle 218b. The second portion of the compressed air flows in second axial direction AD2 over baffle 218b and downstream to shaping orifices 210. The second portion of the compressed air exits spray gun 112 through shaping orifices 210 in air cap 192. In the example shown, the second portion of the compressed air flows around a radially outer edge of baffle 218b. A passage is formed radially between baffle 218b and gun housing 176 to allow the compressed air to flow downstream in second axial direction AD2.

Collar 224 is formed on outlet housing 176a. Collar 224 extends radially outward relative to other portions of outlet housing 176a. Collar 224 can extend fully about the spray axis SA. Air passages 222 extend through collar 224. Air passages 222 are configured to route the first portion of the compressed air from an upstream portion of the inner air chamber 214 to a downstream portion of the inner air chamber 214. In the example shown, a plurality of air passages 222 are formed through collar 224. An array of the air passages 222 can be disposed annularly about the spray axis SA.

Ring 226 projects in second axial direction AD2 from a main body portion of collar 224 through which air passages 222 are formed. Ring 226 is disposed radially between inner air chamber 214 and outer air chamber 216. Ring 226 projects to engage with an axially inner side of air cap 192, sealing with air cap 192 to fluidly separate inner air chamber 214 and outer air chamber 216. Ring 226 defines portions of inner air chamber 214 and outer air chamber 216 in the example shown.

Cartridge seals 172 are disposed on the exterior of cartridge body 164. Cartridge seals 172 are disposed between and sealingly engage with cartridge body 164 and gun body 134. In the example shown, cartridge seals 172 are disposed between and engage with cartridge body 164 and gun mount 152. Cartridge seals 172 axially bracket the portion of the spray fluid flowpath outside of cartridge body 164 and inside of gun mount 152. Cartridge seals 172 fluidly separate wet and dry portions within spray gun 112.

Cartridge seals 172 are disposed in seal grooves 228. In the example shown, seal grooves 228 are formed on cartridge body 164 such that cartridge seals 172 are mounted on cartridge body 164. A first one of seal grooves 228 is disposed axially between nozzle 128 and fluid ports 174. A second one of seal grooves 228 is disposed on an opposite axial side of fluid ports 174 from nozzle 128. The first seal groove 228 is disposed axially between the nozzle 128 and the second seal groove 228. The second seal groove 228 is disposed axially between fluid ports 174 and the actuator of spray gun 112 (similar to actuator 24 (FIG. 1)), which actuator is formed by piston 140, valve lock 144, and piston spring 142.

A portion of the spray fluid flowpath through spray gun 112 extends annularly around cartridge body 164 within gun mount 152. Fluid passage 230 is disposed axially between the cartridge seals 172. The fluid passage 230 extends fully annularly about cartridge body 164. The fluid passage 230 defines an annular flowpath for the spray fluid to flow fully about cartridge body 164 to enter into fluid ports 174 to enter into flow chamber 232. The fluid passage 230 facilitates spray fluid entering into flow chamber 232 from locations disposed circumferentially about cartridge body 164 and spray axis SA. The flowpath from fluid passage 230 through fluid ports 174 and into flow chamber 232 does not restrict flow relative to outflow through nozzle 128, facilitating efficient and effective output of spray fluid for atomization during spray operations.

Fluid ports 174 extend through cartridge body 164. Fluid ports 174 form flowpaths for the spray fluid to enter into flow chamber 232 within cartridge body 164. In the example shown, multiple fluid ports 174 are arrayed about the cartridge body 164. Each fluid port 174 includes an outer opening on the exterior of cartridge body 164 that allows spray fluid to enter into the fluid port 174 from fluid passage 230 and includes an inner opening that opens into flow chamber 232 and allows the spray fluid to enter into flow chamber 232. The fluid ports 174 are disposed axially between the cartridge seals 172. The fluid ports 174 are spaced in first axial direction AD1 from cartridge mount 212. The fluid ports 174 are disposed on an opposite axial side of the mating interface between cartridge body 164 and gun body 134 from nozzle 128. Such positioning facilitates the interface between cartridge body 164 and gun body 134 forming a back up seal (e.g., by the threading in the example shown) that inhibits spray fluid from migrating to the compressed air passages, such as inner air chamber 214 and outer air chamber 216.

Seal holder 178 is connected to housing 176. Seal holder 178 is disposed at an opposite axial end of housing 176 from nozzle 128. Seal holder 178 extends into housing 176 to radially overlap with housing 176. Seal holder 178 is configured to interface with needle seal 170 to retain needle seal 170 within cartridge body 164.

Needle seal 170 is configured to interface with an exterior of needle 166. Needle seal 170 can be considered to form a dynamic seal as needle 166 shifts axially relative to needle seal 170 during operation. Needle seal 170 is disposed in the interior of cartridge body 164. The flow chamber 232 of spray control assembly 138 extends axially between nozzle 128 and needle seal 170. Needle seal 170 forms a sliding seal with the exterior of needle 166 as needle 166 shifts axially to actuate spray valve 122 between the open and closed states. Needle seal 170 engages with the exterior of needle 166 to inhibit spray fluid from leaking in first axial direction AD1 and out of cartridge body 164.

Spray valve 122 is formed between needle 166 and seat 168. Seat 168 is formed by cartridge body 164, in the example shown. Seat 168 is formed by a portion of housing 176 narrowing to form nozzle 128. Needle 166 is engaged with seat 168 with spray valve 122 in the closed state and needle 166 is disengaged from seat 168 with spray valve 122 in the open state. Needle 166 is configured as the movable component of spray valve 122.

Needle 166 is at least partially disposed within cartridge body 164. Needle 166 is configured to shift axially along spray axis SA. Needle 166 is movable along spray axis SA and relative to seat 168 to place spray valve 122 in the open and closed states. Needle 166 is disposed coaxially with nozzle 128, valve lock 144, and piston 140 in the example shown. Needle 166 is disposed coaxially with nozzle 128, piston 140, and piston spring 142 in the example shown. Needle 166 is disposed coaxially with return block 147 and return spring 148 in the example shown.

Needle tip 180 is configured to engage with seat 168 to place spray valve 122 in the closed state. Needle body 182 extends axially from needle tip 180. In the example shown, needle tip 180 is formed separate from needle body 182 and connected to needle body 182. It is understood, however, that not all examples are so limited. For example, needle tip 180 and needle body 182 can be formed monolithically. Needle body 182 extends in first axial direction AD1 from needle tip 180. Needle body 182 extends from within flow chamber 232 to outside of cartridge body 164. Needle body 182 extends through needle seal 170 and engages with needle seal 170. Needle seal 170 engaging with the exterior of needle body 182 seals an axial end of flow chamber 232.

Needle neck 184 is disposed at an opposite axial end of needle body 182 from needle tip 180. Needle neck 184 extends axially between needle body 182 and needle head 186. Needle head 186 is disposed at an opposite axial end of needle neck 184 from needle body 182. Needle head 186 has a larger diameter than needle neck 184. In the example shown, needle neck 184 has a smaller diameter than both needle body 182 and needle head 186. Needle head 186 is disposed at an opposite axial end of needle 166 from needle tip 180. The needle head 186 includes an outer face 187 oriented in a first axial direction along the axis and an inner face 189 oriented in a second axial direction along the axis.

Piston 140 is disposed within gun body 134. Piston 140 is configured to shift axially along spray axis SA to displace needle 166. Piston head 188 is disposed in piston chamber 234. Needle 166 does not extend to radially overlap with piston head 188 in the example shown. Piston shaft 190 extends in second axial direction AD2 from piston head 188. Piston shaft 190 extends into gun bore 206. Piston bore 236 extends within piston 140. Piston bore 236 is disposed on spray axis SA in the example shown. Piston bore 236 extends fully axially though piston 140 in the example shown. Piston bore 236 extends through both piston shaft 190 and piston head 188. Piston bore 236 is disposed coaxially with the spray axis SA in the example shown.

Piston spring 142 interfaces with piston 140. In the example shown, piston spring 142 interfaces with piston head 188. Piston spring 142 is configured to bias piston 140 in second axial direction AD2.

Needle return 146 is disposed within gun body 134. Needle return 146 is configured to interface with needle 166 and bias needle 166 in second axial direction AD2 and into engagement with seat 168. Needle return 146 is movable along the spray axis SA. Return block 147 is independent of and not connected to piston 140 such that piston 140 and return block 147 can move relative to each other along spray axis SA. Needle 166 does not radially overlap with return block 147, though it is understood that not all examples are so limited.

Return rod 200 extends in second axial direction AD2 and is at least partially disposed in piston bore 236. Return rod 200 is configured to abut and engage with needle 166. In the example shown, return rod 200 engages with an axially oriented face of needle head 186. In the example shown, bearing 238 is disposed within piston bore 236 and engages with return rod 200. Bearing 238 facilitates sliding of return block 147 and piston 140 relative to each other. Bearing 238 engages with return rod 200 to assist in maintaining return block 147 in coaxial alignment with needle 166 on spray axis SA.

Return flange 202 extends radially outward. Return flange 202 projects from the exterior surface of return block 147. Return flange 202 provides a bearing surface for return spring 148 to engage with. Return body 204 forms a main body portion of return block 147. Return body 204 extends in first axial direction AD1 from return flange 202. Return body 204 is disposed radially within return spring 148 and can assist in aligning return spring 148 relative to return block 147. As such, return body 204 can be considered to form a spring guide. Return body 204 maintains return spring 148 in coaxial alignment on spray axis SA.

Return spring 148 is disposed within gun body 134 and engages with return block 147. In the example shown, return spring 148 engages with return flange 202 of return block 147. Return spring 148 is configured to bias return block 147, and thus needle 166 due to the engagement of return rod 200 and needle head 186, in second axial direction AD2. Return spring 148 is configured to bias needle 166 into engagement with seat 168 to place spray valve 122 in the closed state.

Return spring 148 is disposed outside of the flowpath of the spray fluid through spray gun 112. Return spring 148 is a dry component that is not exposed to the spray fluid during operation. Spray control assembly 138 does not include any springs in the flow chamber 232. In the example shown, the spray control assembly 138 does not include any springs that are part of the spray control assembly 138. Spray control assembly 138 is mountable and dismountable as a single module that does not include any springs. The only spring that exerts a biasing force on needle 166 is return spring 148, which does not directly interface with needle 166. Instead, the return spring 148 is indirectly connected to the needle 166 via the intermediate return block 147. The return spring 148 exerts a biasing force on needle return 146 and return block 147 exerts a biasing force on needle 166.

Displacement limiter 136 is supported by gun body 134. Displacement limiter 136 is disposed at an opposite axial end of spray gun 112 from nozzle 128. Displacement limiter 136 is mounted at rear end 137 of gun body 134. Limiter housing 156 is mounted to gun body 134. In the example shown, limiter housing 156 is mounted to piston cap 154 of gun body 134. Limiter housing 156 is disposed partially within gun body 134 and partially outside of gun body 134. Limiter bore 240 extends axially within limiter housing 156. In the example shown, limiter bore 240 extends fully axially through limiter housing 156.

Positioner 160 is at least partially disposed within limiter housing 156. Stop 162 is mounted to positioner 160. In the example shown, positioner 160 includes exterior threads that engage with interior threads formed on stop 162. Stop 162 is at least partially disposed within limiter bore 240. Stop 162 is keyed to limiter housing 156 to prevent rotation of stop 162 on spray axis SA. For example, at least a portion of the limiter bore 240 can include a non-circular cross-section taken in a plane normal to the spray axis SA. An exterior surface of the stop 162 can be of the same cross-sectional shape as the surface of the limiter bore 240. The mating non-circular surfaces form the keyed interface that prevents stop 162 from rotating on spray axis SA. For example, stop 162 and limiter bore 240 can include hexed exteriors. The keyed interface causes axial displacement of stop 162 as positioner 160 is rotated. The threaded interface between positioner 160 and stop 162 and the keyed interface between stop 162 and limiter housing 156 causes stop 162 to shift axially along spray axis SA.

Stop 162 is configured to define a maximum opening size of spray valve 122. Stop 162 defines the maximum distance that needle 166 can shift relative to seat 168 to open spray valve 122. Increasing the opening size of spray valve 122 allows for greater volumetric flow of the spray fluid while decreasing the size of spray valve 122 allows for lesser volumetric flow. Adjusting the size of the spray valve opening distance changes the flow of the spray fluid, resulting in different coverage and finish of the fluid spray applied to the target substrate.

Knob 158 is mounted on positioner 160. Knob 158 is fixed to positioner 160 such that rotating knob 158 causes rotation of positioner 160. Knob 158 is disposed outside of gun body 134. Knob 158 is accessible by a user such that the user can manipulate knob 158 to adjust the axial position of stop 162 and thus adjust the maximum displacement distance of needle 166.

Valve lock 144 forms a portion of the actuator of spray gun 112. Valve lock 144 is selectively engageable with needle 166. Valve lock 144 is configured to engage with needle 166 with the spray gun 112 transitioning to and in the spray state. Valve lock 144 is configured to disengage from the needle 166 with spray gun 112 in the non-spray state. Valve lock 144 selectively engaging with needle 166 allows for spray control assembly 138 to be mounted and dismounted as the single unit without having to access or manipulate any connection between the needle 166 and the actuator.

Valve lock 144 is configured to exert an axial driving force on needle 166 to displace needle 166 in first axial direction AD1 away from seat 168 to place spray valve 122 in the open state. Valve lock 144 includes needle detents 198 that are configured to engage with needle 166 and exert the axial driving force. An array of needle detents 198 can extend annularly about the spray axis SA. It is understood that valve lock 144 preferably includes at least two needle detents 198 that are disposed evenly about the spray axis SA to evenly distribute any radial forces about the spray axis SA, preventing deformation to or damage to needle 166. For example, two needle detents 198 can be disposed 180-degrees apart about spray axis SA, three needle detents 198 can be disposed 120-degrees apart about spray axis SA, four needle detents 198 can be disposed 90-degrees apart about spray axis SA, etc.

Needle detents 198 are supported by carrier 196. Carrier 196 is formed by piston shaft 190 in the example shown, though it is understood that not all examples are so limited. Needle detents 198 are not normally biased but instead float relative to carrier 196. In the example shown, needle detents 198 are formed as balls, though it is understood that not all examples are so limited.

Needle detents 198 are sized such that lock bore 242 can drive the needle detents 198 radially inward into engagement with needle 166 as piston 140 is displaced in first axial direction AD1. Lock bore 242 is configured to displace needle detents 198 radially inwards into engagement with needle 166 to position needle detents 198 to exert axial force on needle 166. Release bore 244 is disposed immediately adjacent to lock bore 242. Release bore 244 has a larger diameter then lock bore 242. Release bore 244 is sized such that needle detents 198 can shift radially outward and over needle head 186. In the example shown, lock bore 242 and release bore 244 are formed by gun bore 206. Lock bore 242 and release bore 244 are static such that lock bore 242 and release bore 244 do not move axially in the example shown. It is understood, however, that not all examples are so limited. For example, the lock bore 242 and release bore 244 can be formed by piston bore 236 and carrier 196 can be formed by return block 147. For example, return rod 200 can have an axial bore formed therein and needle 166 can extend into the bore in return block 147 to radially overlap with the needle detents 198 that are supported by return block 147. In such an example, the lock bore 242 can be spaced in second axial direction AD2 from the lock bore 242, in an opposite configuration from that currently shown.

Spray control assembly 138 is inserted into gun bore 206 through the front end of gun body 134. Spray control assembly 138 is mountable and dismountable as a single cartridge. The spray control assembly 138 can be removed for servicing and/or replacement as a single unit. During assembly of spray gun 112, spray control assembly 138 is inserted into gun bore 206 in first axial direction AD1. Spray control assembly 138 is connected to gun body 134 by cartridge mount 212 engaging with gun mount 152. In the example shown, spray control assembly 138 is rotated on spray axis SA to threadedly engage cartridge body 164 with gun body 134.

As spray control assembly 138 shifts in first axial direction AD1, the needle head 186 encounters needle detents 198. With needle detents 198 disposed within the release bore 244 and outside of the lock bore 242, the needle detents 198 are able to displace radially away from spray axis SA. The needle head 186 pushes the needle detents 198 radially outward and passes through needle detents 198 such that needle neck 184 is radially aligned with and radially overlaps with the needle detents 198.

With spray control assembly 138 installed on spray gun 112, the air cap 192 is mounted over cartridge body 164. Cap retainer 194 is engaged with gun body 134 to retain air cap on gun body 134.

To dismount spray control assembly 138, the air cap 192 is removed. The spray control assembly 138 is accessible from front end of spray gun 112. The user can grasp the exterior of collar 224, by hand or with a tool, such as a wrench, to disconnect the interface between cartridge body 164 and gun body 134. The user can then pull spray control assembly 138 in second axial direction AD2 and out of gun bore 206.

During dismounting, the needle 166 is pulled out of piston bore 236. Needle head 186 encounters needle detents 198 and pushes needle detents 198 radially outward away from spray axis SA. The needle head 186 passes under the needle detents 198 and out of piston bore 236.

During operation, the user initially sets the maximum opening distance for spray valve 122. A larger opening distance allows for a greater volume of spray fluid to flow through the open spray valve 122 while a smaller opening distance allows for a reduced volume of spray fluid to flow through the open spray valve 122. To set the maximum opening distance, the user rotates knob 158. Knob 158 is connected to positioner 160 and rotates positioner 160. Positioner 160 axially displaces stop 162 due to the threaded interface formed between positioner 160 and stop 162 and the keyed interface with stop 162. Stop 162 is either threaded further onto positioner 160 or further off of positioner 160, depending on the rotational direction of knob 158. Rotating knob 158 in a first rotational direction displaces stop 162 further onto positioner 160, displacing stop 162 in first axial direction AD1 and increasing the opening distance. Rotating knob 158 in a second rotational direction opposite the first rotational direction displaces stop 162 further off of positioner 160, displacing stop 162 in second axial direction AD2 and decreasing the opening distance.

Spray fluid and compressed air are provided to spray gun 112. Spray gun 112 is initially in the non-spray state shown in FIG. 3A. The pressurized spray fluid flows through flowpaths in gun body 134 and enters into fluid passage 230. The spray fluid flows through fluid ports 174 and into flow chamber 232. Needle 166 is engaged with seat 168 such that spray valve 122 is in the closed state and the spray fluid is prevented from flowing through nozzle 128.

To initiate spraying, compressed air is introduced to piston chamber 234 to displace piston 140 in first axial direction AD1. The compressed air acts on the face of piston head 188 oriented in second axial direction AD2 and overcomes the force exerted on piston 140 by piston spring 142 to displace piston 140 in first axial direction AD1. Piston shaft 190 shifts in first axial direction AD1 such that needle detents 198 enter into lock bore 242. The lock bore 242 drives needle detents 198 radially inward and into the groove that extends about needle neck 184 and axially between needle head 186 and needle body 182.

Piston 140 continues to shift in first axial direction AD1 and needle detents 198 shift into engagement with needle head 186. The needle detents 198 cannot pass over needle head 186 due to lock bore 242 biasing needle detents 198 radially inward. The needle detents 198 engage with inner face 189 of needle head 186 and exert an axial force in first axial direction AD1 on needle head 186. The force exerted on needle 166 by needle detents 198 drives needle 166 in first axial direction AD1. Needle 166 is driven in first axial direction AD1 by the valve lock 144. Needle 166 disengages from seat 168 to open spray valve 122. With spray valve 122 in the open state, the spray fluid is able to flow through nozzle 128 to be emitted from spray gun 112.

As needle 166 shifts in first axial direction AD1, the needle 166 exerts an axial force on needle return 146 to displace return block 147 in first axial direction AD1. The return spring 148 is compressed between return block 147 and gun body 134. Return block 147 can displace in first axial direction AD1 until return block 147 engages with stop 162. Stop 162 prevents further displacement in first axial direction AD1. The stop 162 engaging with return block 147 prevents needle 166 from shifting further in first axial direction AD1. The spray gun 112 is thus in the spray state shown in FIG. 3B.

The piston 140 shifting in first axial direction AD1 opens flowpaths for compressed air to flow to aperture 220a and aperture 220b. The portion of the compressed air forming the atomizing air flows to aperture 220a and into inner air chamber 214. The atomizing air encounters baffle 218a, which distributes the atomizing air about the spray axis SA. The atomizing air continues in second axial direction AD2 through air passages 222 and exits spray gun 112 through central orifice 208. The atomizing air impinges on the spray fluid exiting from nozzle 128 to atomize that spray fluid.

The portion of the compressed air forming the shaping air flows to aperture 220b and into outer air chamber 216. The shaping air encounters baffle 218b, which distributes the shaping air about the spray axis SA. The shaping air continues in second axial direction AD2 and exits from spray gun 112 through shaping orifices 210. The shaping air encounters the atomized spray fluid and is configured to shape the atomized spray fluid into a desired pattern, such as a fan.

Spray gun 112 is configured such that there is a delay between spray gun 112 beginning to emit the compressed air from air cap and the spray gun 112 beginning to emit the spray fluid from spray control assembly 138. The emission of the compressed air from air cap occurs before the emission of spray fluid from spray control assembly 138. As such, the emission of spray fluid can be considered to lag behind the emission of compressed air. The compressed air being emitted from air cap 192 before the spray fluid is emitted from spray control assembly 138 ensures that the spray fluid encounters emitted compressed air at the initiation of spraying, preventing spitting or sputtering that can lead to undesirable spray quality.

With spray gun 112 in the non-spray state, needle detents 198 are spaced from needle head 186 by axial distance D1. Distance D1 can also be referred to as a lead distance. The needle detents 198 travel the distance D1 prior to encountering needle head 186. The distance that piston 140 shifts to uncover the air passages leading to aperture 220a and aperture 220b is less than the distance D1. The air pathways providing compressed air to air cap 192 are opened prior to the fluid pathway emitting spray fluid from spray gun 112. Spray gun 112 can thereby emit the compressed air from air cap 192 prior to needle 166 being engaged by needle detents 198 to open spray valve 122.

To stop spraying by spray gun 112 the spray valve 122 is actuated from the open state to the closed state. The flow of compressed air into gun body 134 is shut off or reduced such that the piston spring 142 can overcome the force exerted on the piston head 188 in first axial direction AD1. Piston spring 142 displaces piston 140 in second axial direction AD2. Return spring 148 displaces return block 147 in second axial direction AD2. The return spring 148 exerts an axial force on needle 166 via return block 147. The return block 147 engages with outer face 187 of needle head 186 and is configured to push needle 166 in second axial direction AD2. Needle 166 is pushed in second axial direction AD2 until needle tip 180 engages with seat 168, thereby closing spray valve 122. With spray valve 122 in the closed state the flow of spray fluid through nozzle 128 is shut off.

Needle detents 198 prevent needle head 186 from passing by needle detents 198 in second axial direction AD2 while needle detents 198 are disposed within lock bore 242. Piston 140 continues to shift in second axial direction AD2 and needle detents 198 pass out of lock bore 242. With needle detents 198 returned to within release bore 244 the valve lock 144 is disengaged from needle 166 and spray control assembly 138 can be dismounted without the user having to access the interface between valve lock 144 and needle 166.

Spray gun 112 provides significant advantages. Spray control assembly 138 is mountable as a single, unitary component. Spray control assembly 138 can be mounted and dismounted through the front end of spray gun 112. The user does not have to access the piston 140 or other components spaced in first axial direction from spray control assembly 138 to make or break the driving connection that actuates needle 166 during operation. Instead, the user can simply and easily access spray control assembly 138 at front end. With the air cap 192 dismounted, only the cartridge housing 176 needs to be manipulated to install or remove the spray control assembly 138. The needle 166 is not fixed to a displacer but is instead aligned with valve lock 144 during assembly for selective engagement and disengagement depending on the operational state of the spray gun 112.

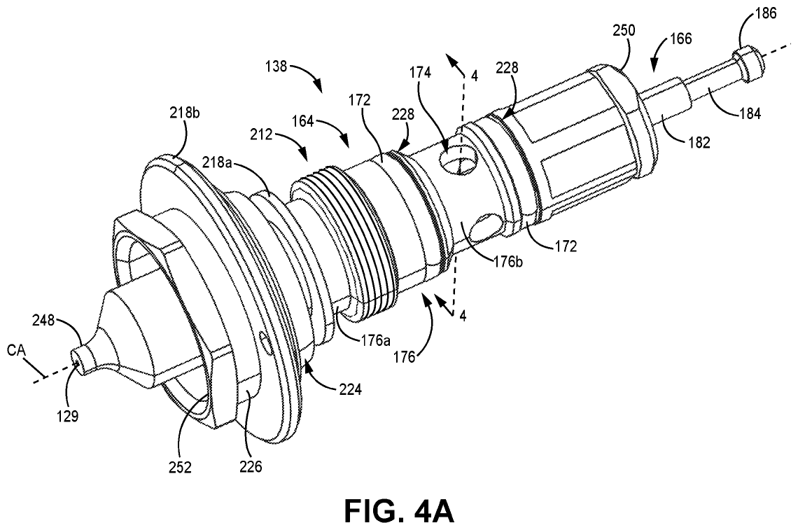

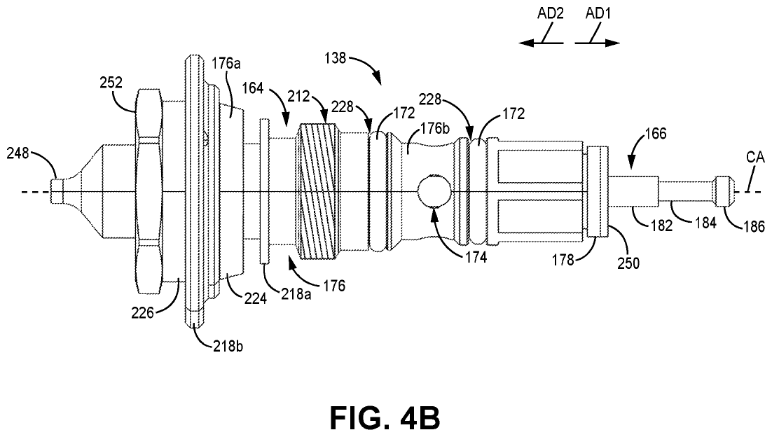

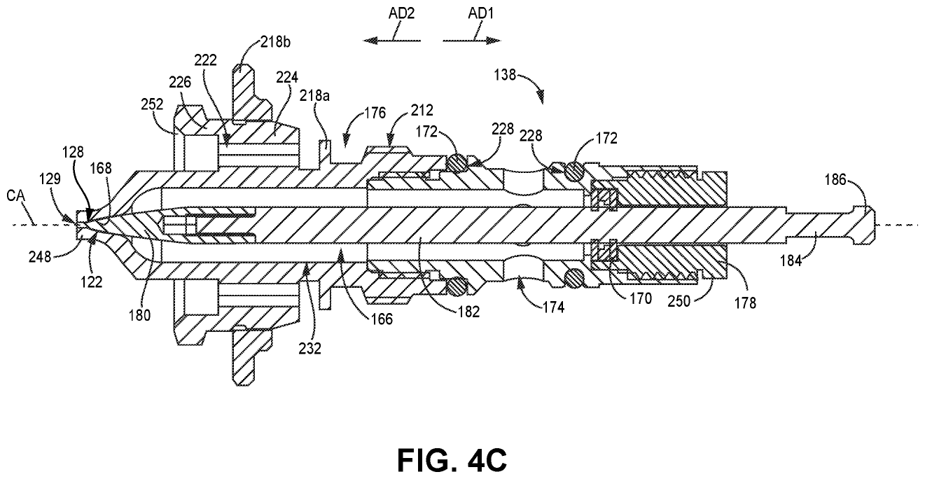

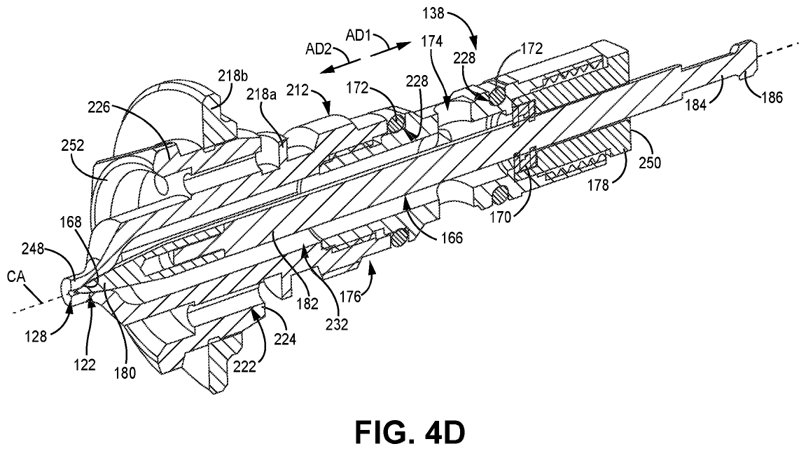

FIG. 4A is an isometric view of spray control assembly 138. FIG. 4B is a side elevational view of spray control assembly 138. FIG. 4C is an isometric cross-sectional view of spray control assembly 138 taken along line 4-4 in FIG. 4A. FIG. 4D is an elevational cross-sectional view of spray control assembly 138 taken along line 4-4 in FIG. 4A. FIGS. 4A-4D will be discussed together. Spray control assembly 138 includes spray valve 122, nozzle 128, cartridge body 164, needle 166, seat 168, needle seal 170, cartridge seals 172, baffle 218a, baffle 218b, and fluid ports 174. Cartridge body 164 includes housing 176 and seal holder 178. Housing 176 includes outlet housing 176a and inlet housing 176b. Needle 166 includes needle tip 180, needle body 182, needle neck 184, and needle head 186.

Spray control assembly 138 is configured to control emission of spray fluid from a spray gun, such as spray gun 112 (FIGS. 2A-3B). Spray control assembly 138 forms a single module that is mountable to and dismountable from the spray gun 112 as the single module. The spray control assembly 138 is mountable to the spray gun 112 such that only a single locking interface is formed between spray control assembly 138 and spray gun 112.

Cartridge body 164 forms an exterior of spray control assembly 138. Cartridge body 164 is elongate along cartridge axis CA. Cartridge axis CA can be disposed coaxially with spray axis SA with spray control assembly 138 mounted to gun body 134. Cartridge body 164 defines flow chamber 232. Flow chamber 232 is formed within cartridge body 164 and is a chamber that routes pressurized spray fluid to nozzle 128 for spraying. Flow chamber 232 is a wet chamber through which spray fluid flows during operation. The interior surfaces of cartridge body 164 that define flow chamber 232 are wet surfaces that are exposed to the spray fluid. The exterior surfaces of cartridge body 164 spaced in second axial direction AD2 from the first cartridge seal 172 that is disposed axially between fluid ports 174 and cartridge mount 212 and exterior surfaces of cartridge body 164 spaced in first axial direction AD1 from the second cartridge seal 172 that is disposed axially between fluid ports 174 and needle head 186 are dry surfaces that do not define spray fluid flowpaths. A majority of the exterior surface of cartridge body 164 is dry. At least some of the exterior surfaces of cartridge body define flowpaths for compressed air.

Cartridge body 164 includes housing 176 and seal holder 178 mounted together. Seal holder 178 extends into housing 176 such that a portion of housing 176 is disposed around a portion of seal holder 178. In the example shown, housing 176 and seal holder 178 are connected together at a threaded interface.

Housing 176 is formed from inlet housing 176b and outlet housing 176a in the example shown. Inlet housing 176b extends into outlet housing 176a to connect to outlet housing 176a. A portion of outlet housing 176a is disposed outside of and around a portion of inlet housing 176b. In the example shown, inlet housing 176b and outlet housing 176a are connected together by a threaded interface. While housing 176 is formed from inlet housing 176b and outlet housing 176a, it is understood that in some examples inlet housing 176b and outlet housing 176a can be formed as a single component. In some examples, inlet housing 176b and outlet housing 176a can be formed as a monolithic component.

Fluid ports 174 extend through cartridge body 164 and provide flowpaths for spray fluid to enter into flow chamber 232. In the example shown, fluid ports 174 are formed through inlet housing 176b. Fluid ports 174 are disposed radially through cartridge body 164. During operation, pressurized spray fluid flows radially through fluid ports 174 to enter into flow chamber 232 and the pressurized spray fluid flows axially through nozzle 128 to exit from flow chamber 232. Spray control assembly 138 redirects the spray fluid from a radial inlet flow to an axial outlet flow.

Outlet housing 176a extends in second axial direction AD2 from inlet housing 176b. Nozzle 128 is formed through outlet housing 176a. Nozzle 128 is formed by outlet housing 176a in the example shown. Nozzle 128 is disposed at first end 248 of cartridge body 164.

Cartridge mount 212 is formed on an exterior of cartridge body 164. Cartridge mount 212 is configured to interface with the gun body 134 of the spray gun 112 to secure spray control assembly 138 to the gun body 134. In the example shown, cartridge mount 212 is formed as threading formed on an exterior of cartridge body 164. In the example shown, cartridge mount 212 is formed as threads configured to interface with threads in the gun body 134.

Cartridge mount 212 is disposed axially between fluid ports 174 and nozzle 128. As such, the spray control assembly 138 is fixed to the gun body 134 at a location axially between the locations where the spray fluid enters into spray control assembly 138 and where the spray fluid exits from the spray control assembly 138. Cartridge mount 212 is disposed axially between dry portions of the exterior of cartridge body 164, which dry portions do not contact the spray fluid during operation, and wet portions of the exterior of the cartridge body 164, which wet portions do contact the spray fluid during operation. Cartridge mount 212 is disposed axially between ports in cartridge body 164 that route the spray fluid (e.g., fluid ports 174) and ports in the cartridge body 164 that route compressed air (e.g., air passages 222). While cartridge mount 212 is shown as exterior threads, it is understood that not all examples are so limited. For example, cartridge mount 212 can be configured to facilitate a bayonet style connection with spray gun 112. In such an example, cartridge mount 212 can be formed as one or more projections or slots configured to interface with mating slots or projections of gun body 134.

Collar 224 is formed as a radial enlargement of cartridge body 164. Air passages 222 extend through collar 224 and define pathways for compressed air to flow from a first axial side of collar 224 to a second axial side of collar 224.

Ring 226 projects in second axial direction AD2 relative to a portion of collar 224 defining air passages 222. Ring 226 does not radially overlap with air passages 222 in the example shown. Ring 226 extends around and defines an annular chamber that the atomization air enters into after exiting from the air passages 222. In the example shown, ring 226 includes a faceted exterior surface. The faceted exterior forms a tool interface on which a tool, such as a wrench, can interface with cartridge body 164 to torque cartridge body 164 during installation and removal. Ring 226 projects to ring lip 252. Ring lip 252 is configured to interface with air cap 192 to form a seal that separates the atomization and shaping portions of the compressed air.

Baffle 218a extends radially from cartridge body 164. Baffle 218a extends radially outward to axially overlap with air passages 222. During operation, compressed air (e.g., the atomization air) flows over and around baffle 218a to reach air passages 222 and flow downstream to central orifice 208 in air cap 192. The baffle 218a facilitates distribution of the compressed air about the cartridge axis CA. Distributing the atomization air about the cartridge axis CA provides an evenly distributed flow to impinge on and atomize the spray fluid. Distributing the atomization air about the cartridge axis CA provides for effective atomization, preventing spitting or incomplete atomization.

Baffle 218b extends radially from cartridge body 164. In the example shown, baffle 218b extends radially outward from collar 224. Baffle 218b is disposed radially outward from baffle 218a. In the example shown, baffle 218b does not axially overlap with baffle 218a. During operation, compressed air (e.g., the shaping air) flows over and around baffle 218b to reach air cap 192 and flow to the shaping orifices 210 in air cap 192. Baffle 218b is configured such that the compressed air flows over the outer radial edge of baffle 218b. The baffle 218b facilitates distribution of the compressed air about the cartridge axis CA. Distributing the shaping air about the cartridge axis CA provides an evenly distributed flow to shape the atomized spray fluid. Distributing the shaping air about the cartridge axis CA provides for effective flow to all sets of shaping orifices to effectively shape the spray pattern. While baffle 218b is formed as a component of spray control assembly 138 in the example shown, it is understood that not all examples are so limited. In some examples, baffle 218b can be mounted to or integrated with gun body 134 such that baffle 218b does not mount to and dismount from gun body 134 with spray control assembly 138.

Seal grooves 228 are formed on the exterior of cartridge body 164. Seal grooves 228 extend radially into cartridge body 164. A first seal groove 228 is spaced in second axial direction AD2 from fluid ports 174. A second seal groove 228 is spaced in first axial direction AD1 from fluid ports 174. In the example shown, the first seal groove 228 is formed between inlet housing 176b and outlet housing 176a. The first seal groove 228 is partially defined by inlet housing 176b and partially defined by outlet housing 176a. In the example shown, the second seal groove 228 is formed by inlet housing 176b.

Cartridge seals 172 are disposed in seal grooves 228. The cartridge seals 172 are configured to engage with gun body 134 to inhibit leakage of spray fluid about the exterior of cartridge body 164 in either first axial direction AD1 or second axial direction AD2. Cartridge seals 172 are disposed on opposite axial sides of the fluid ports 174. A first cartridge seal 172 is disposed axially between the fluid ports 174 and cartridge mount 212. The first cartridge seal 172 is disposed axially between the fluid ports 174 and nozzle 128. The first cartridge seal 172 is disposed axially between the fluid ports 174 and baffle 218a. The first cartridge seal 172 is disposed axially between the fluid ports 174 and baffle 218b. A second cartridge seal 172 is disposed axially between fluid ports 174 and needle head 186. The cartridge seals 172 can be of any configuration suitable for creating a fluid-tight seal to inhibit leakage of spray fluid. For example, cartridge seals 172 can be configured as elastomer seals, such as O-rings, among other options. In the example shown, the first cartridge seal 172 has a larger diameter than the second cartridge seal 172.

Needle seal 170 is disposed within cartridge body 164. In some examples, needle seal 170 can be mounted to seal holder 178. In some examples, needle seal 170 can be clamped between seal holder 178 and housing 176. Needle seal 170 is configured to engage an exterior of needle 166. Needle seal 170 prevents spray fluid from leaking out of cartridge body 164 between needle 166 and cartridge body 164. The interface between needle seal 170 and needle 166 is a sliding interface as needle 166 slides axially relative to needle seal 170 during operation.

Needle 166 is at least partially disposed within cartridge body 164. Needle 166 is elongate along cartridge axis CA. Needle 166 is configured to shift along cartridge axis CA during operation. In the example shown, needle 166 extends out of cartridge body 164 through second end 250 of cartridge body 164. Needle 166 does not extend out of cartridge body 164 through first end 248 of cartridge body 164. As such, needle 166 does not extend fully axially through cartridge body 164.

Needle tip 180 is disposed at a first axial end of needle 166. Needle tip 180 is configured to engage with seat 168 with spray valve 122 in a closed state. Needle tip 180 is spaced from and disengaged from seat 168 with spray valve 122 in an open state. Needle tip 180 disengaging from seat 168 opens the flowpath through spray valve 122 and allows the spray fluid to flow to and through nozzle 128.

Needle body 182 extends axially from needle tip 180. Needle body 182 extends from within flow chamber 232 to outside of cartridge body 164. Needle body 182 extends through needle seal 170 and is engaged with needle seal 170. In the example shown, needle tip 180 is formed separately from needle body 182 and is connected to needle body 182. For example, needle tip 180 can mount to needle body 182 by a threaded connection. It is understood, however, that not all examples are so limited. For example, needle tip 180 and needle body 182 can be formed as a single component. Needle tip 180 and needle body 182 can be monolithically formed.

Needle neck 184 extends in first axial direction AD1 from needle body 182. Needle neck 184 is disposed at an opposite axial end of needle body 182 from needle tip 180. In the example shown, needle neck 184 has a smaller diameter than needle body 182, through it is understood that not all examples are so limited. For example, needle neck 184 can have the same diameter as needle body 182 with needle head 186 having a larger diameter than needle body 182.

Needle head 186 is disposed at an opposite axial end of needle 166 from needle tip 180. Needle head 186 is connected to needle neck 184. Needle head 186 projects radially outward from needle neck 184. Needle head 186 has a larger diameter than needle neck 184. Needle head 186 forms an axial end of needle 166 opposite the axial end formed by needle tip 180.

Spray valve 122 is formed between needle 166 and seat 168. Spray valve 122 is in an open state with needle 166 spaced from seat 168 such that spray fluid can flow downstream to and through nozzle 128 through the gap between needle 166 and seat 168. Spray valve 122 is in a closed state with needle 166 engaged with seat 168, thereby closing the gap between needle 166 and seat 168 and preventing spray fluid from flowing to and through nozzle 128.

Spray control assembly 138 does not include any springs that act on or bias needle 166. Needle 166 is movable along cartridge axis CA relative to cartridge body 164. In some examples, needle 166 can be removed from cartridge body 164 for servicing or replacement. For example, needle 166 can be pulled in first axial direction AD1 and out of cartridge body 164 through second end 250. A replacement needle 166 can be inserted into spray control assembly 138 through second end 250. The replacement needle 166 is pushed in second axial direction AD2 and initially enters into seal holder 178. The replacement needle 166 passes through needle seal 170 to engage with needle seal 170 and enters into flow chamber 232. The replacement needle 166 can be pushed to engage with seat 168, thereby installing the needle 166.

Spray control assembly 138 controls emission of spray fluid from spray gun 112. Spray control assembly 138 further directs one or more of the flows of compressed air. In the example shown, spray control assembly 138 directs both the atomization air, via baffle 218a and air passages 222, and the shaping air, via baffle 218b. In the example shown, ring 226 defines portions of the flowpaths for both the atomization air and shaping air. It is understood, however, that not all examples are so limited. For example, spray control assembly 138 can be configured to direct only one or the other of the atomization and shaping air flows. Nozzle 128 extends to spray orifice 129 through which the spray fluid is emitted. Spray orifice 129 is formed at an axial end of spray control assembly 138 in second axial direction AD2.

Spray control assembly 138 is mountable to and dismountable from spray gun 112 as a single module. The spray control assembly 138 forms the single module such that spray control assembly 138 mounts to and dismounts from spray gun 112 as one unit, without requiring assembly or manipulation of individual components of the spray control assembly 138. The spray control assembly 138 is mountable and dismountable by manipulating cartridge body 164, to form or break a connection interface between cartridge body 164 and gun body 134 of spray gun 112, and without having to manipulate or access other components of spray control assembly 138. The user does not have to access or manipulate any of the valving components of spray control assembly 138 during mounting and dismounting.

Spray control assembly 138 can be mounted to the spray gun 112 by shifting spray control assembly 138 in first axial direction AD1 and into the spray gun 112 (e.g., into gun bore 206 in gun body 134). Cartridge mount 212 is engaged with a corresponding mounting interface on spray gun 112, such as female threading configured to engage with the male threading of cartridge mount 212, among other connection options. As previously discussed, inserting spray control assembly 138 into spray gun 112 aligns needle 166 for selective engagement with the actuator of the spray gun 112 (e.g., piston 140 and valve lock 144). The driving connection between the needle 166 and the actuator is not formed on installation of spray control assembly 138; instead, the needle 166 is selectively engaged by the actuator and disengaged from the actuator depending on the spray state of the spray gun 112. Installing the spray control assembly 138 forms a mechanical connection between the spray control assembly 138 and gun body 134 and aligns needle 166 for selective engagement with the actuator but does not form a driving connection between the needle 166 and the actuator.

Spray control assembly 138 can be dismounted from the spray gun 112 by shifting spray control assembly in second axial direction AD2. The user breaks the connection between cartridge mount 212 and gun body 134 (e.g., by unthreading cartridge mount 212 from gun body 134) and can then pull the spray control assembly 138 axially out of gun body 134. The user does not have to access or manipulate any driving connection with the needle 166 because the driving connection is not engaged with the spray gun 112 in the non-spray state (FIG. 3A).

Spray control assembly 138 provides significant advantages. Spray control assembly 138 is mountable and dismountable as a single module, reducing the number of parts that have to be aligned and installed to assemble spray gun 112 and thereby providing for easier inventorying for the user and simpler assembly and disassembly of spray gun 112. A single mechanical connection is made between spray control assembly 138 and spray gun 112 during installation. That single mechanical connection secures spray control assembly 138 to spray gun 112 and aligns needle 166 for driving engagement with the actuator. Because the actuator selectively engages with needle 166 depending on the operating state of spray gun 112, the user does not have to affirmatively make or break any connection with the needle 166 during installation and removal of spray control assembly 138. A first spray control assembly 138 can be disconnected and removed by breaking the single mechanical connection and a second spray control assembly 138 can be inserted and connected by the single mechanical connection, reducing downtime and providing for more efficient spray operations. The spray control assembly 138 does not include any springs that displace the needle 166. Instead, the needle 166 is displaced by components of the spray gun 112 that are separate from spray control assembly 138. Such a configuration provides for a simpler and less expensive spray control assembly 138. Further, actuating components are not exposed to the spray fluid and do not experience wear due to the spray fluid.

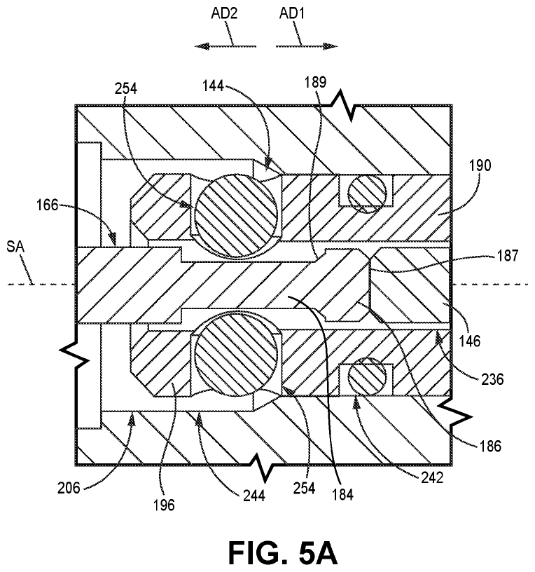

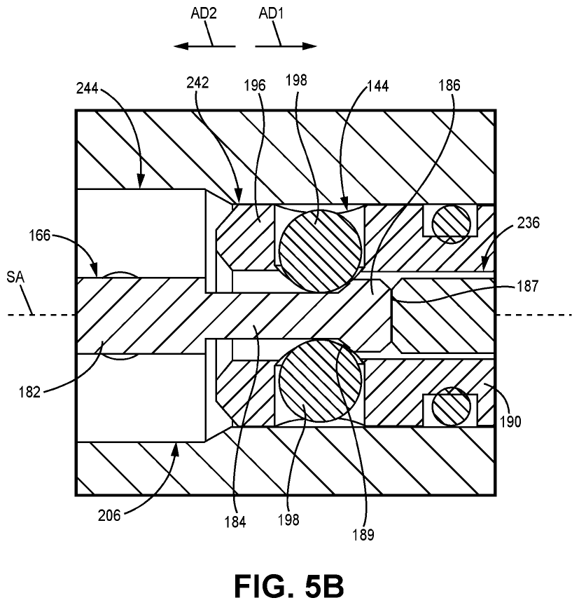

FIG. 5A is an enlarged view of detail 5 in FIG. 3A. FIG. 5B is an enlarged view of detail 5 in FIG. 3B. FIGS. 5A and 5B will be discussed together. The interface between valve lock 144 and needle 166 is shown in FIGS. 5A and 5B. As discussed above, the driving connection that displaces needle 166 relative to seat 168 to shift spray gun 112 from the non-spray state (FIG. 3A) to the spray state (FIG. 3B) is selectively engageable during operation. The driving connection is formed as spray gun 112 is actuated to the spray state and the driving connection is broken with the spray gun 112 in the non-spray state.

Valve lock 144 includes needle detents 198 that are supported by carrier 196. In the example shown, carrier 196 is formed by piston 140. More specifically, carrier 196 is formed by piston shaft 190. Needle detents 198 are configured to float within carrier passages 254 of the carrier 196. In the example shown, the carrier passages 254 each include an inner opening disposed closer to spray axis SA and an outer opening disposed further from spray axis SA. The inner opening can have a smaller diameter than the needle detents 198 to prevent the needle detents from falling into piston bore 236 when needle 166 is not present in piston bore 236. The outer openings can have a larger diameter than needle detents 198 to allow for installation, removal, servicing, etc. of the needle detents 198 from the carrier 196, though it is understood that not all examples are so limited. Needle detents 198 are configured to project through the inner openings to engage with needle 166 and exert a driving force on needle 166.

In the example shown, gun bore 206 forms a static sleeve that is configured to bias the needle detents 198 radially inwards and into engagement with needle 166. Unlike a quick connect fitting in which a sleeve is moved to bias detents or allow release of detents, the valve lock 144 is configured such that the needle detents 198 and carrier 196 shift relative to the static sleeve that selectively biases the needle detents 198.

In the example shown, gun bore 206 is formed from multiple coaxial bores of varying diameters. Release bore 244 has a larger diameter than lock bore 242. Release bore 244 is sized such that needle detents 198 can shift radially outwards away from the spray axis SA a sufficient distance to allow needle head 186 to pass axially by the needle detents 198 between the needle detents 198. Lock bore 242 is sized to bias the needle detents 198 radially inward such that needle detents 198 axially overlap with needle head 186. Lock bore 242 prevents the needle detents 198 from shifting radially outwards away from spray axis SA. Lock bore 242 aligns the needle detents 198 with an axial side of needle head 186 oriented in second axial direction AD2 such that needle detents 198 engage with and can exert an axial driving force on needle head 186.

In the example shown, needle detents 198 are configured to extend into an axial groove formed about needle neck 184. The groove extends fully annularly around spray axis SA. The groove extending fully annularly about the spray axis SA allows the needle detents 198 to extend into the groove from any circumferential position about the needle 166. Such a configuration provides for simplified assembly of spray gun 112 as spray control assembly 138 can be mounted (e.g., by a threaded interface) to radially overlap the groove with needle detents 198 without concern of any circumferential alignment.

During operation, spray gun 112 is initially in the non-spray state (FIGS. 3A and 5A). The needle 166 extends into piston bore 236 such that needle head 186 is disposed within piston bore 236 and such that needle neck 184 radially overlaps with needle detents 198. The needle detents 198 are disposed within release bore 244 such that needle detents 198 can move radially outward relative to spray axis SA. Needle 166 is disposed such that needle head 186 radially overlaps with lock bore 242. Needle head 186 being disposed in lock bore 242 positions needle head 186 such that the lock bore 242 will bias needle detents 198 radially inwards into the annular groove that extends around needle neck 184 and in second axial direction AD2 relative to needle head 186 prior to needle detents 198 shifting far enough in first axial direction AD1 to radially overlap with needle head 186.

To initiate spraying, the spray gun 112 is activated and piston 140 begins to shift in first axial direction AD1. The needle 166 remains stationary as piston 140 shifts relative to needle 166. As discussed above, the piston 140 shifting relative to needle 166 prior to valve lock 144 forming the driving engagement with needle 166 allows compressed air to begin flowing to air cap 192 prior to spray valve 122 shifting to the open state, proving high quality spray on initiation of spraying and preventing sputtering or spitting of the spray fluid.

As piston 140 shifts in first axial direction AD1 the needle detents 198 shift into lock bore 242. The smaller diameter of lock bore 242 relative to release bore 244 biases the needle detents 198 radially inwards towards spray axis SA. The needle detents 198 are biased inwards to axially overlap with needle head 186. As piston 140 continues to shift in first axial direction AD1 the needle detents 198 engage with the side of needle head 186 oriented in second axial direction AD2. The needle detents 198 exert an axial driving force on needle head 186. The needle detents 198 push on needle head 186 to pull needle 166 in first axial direction AD1. The needle 166 being pulled in first axial direction AD1 opens the spray valve 122 to allow for emission of spray fluid from the spray gun 112.

Valve lock 144 is in a disengaged state with spray gun 112 in the non-spray state (FIGS. 3A and 5A). Needle head 186 can pass through valve lock 144 in either first axial direction AD1 or second axial direction AD2 with valve lock 144 in the disengaged state. Valve lock 144 is in an engaged state with spray gun 112 in the spray state. Needle head 186 is prevented from passing through valve lock 144 by needle detents 198 with valve lock 144 in the engaged state.

The valve lock 144 selectively engages with needle 166 depending on the operating state of spray gun 112. With spray gun 112 in the non-spray state, the valve lock 144 is not drivingly engaged with needle 166. Needle 166 can pass axially through valve lock 144 in either of first axial direction AD1 and second axial direction AD2 with valve lock 144 in the disengaged state. Such a configuration facilitates simple and efficient mounting and dismounting of spray control assembly 138 from spray gun 112. The needle 166 is positioned relative to valve lock 144 such that valve lock 144 can engage with needle 166 to displace needle 166 during mounting of spray control assembly 138 to spray gun 112. However, the needle 166 is not drivingly engaged with valve lock 144 during such mounting. Instead, the valve lock 144 drivingly engages with needle 166 to displace needle 166 as the spray gun 112 is actuated to the spray state.

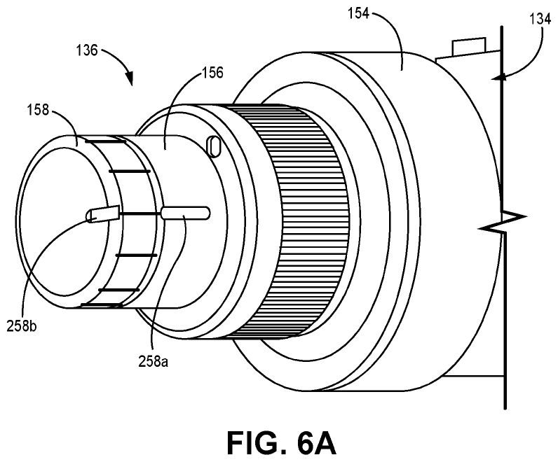

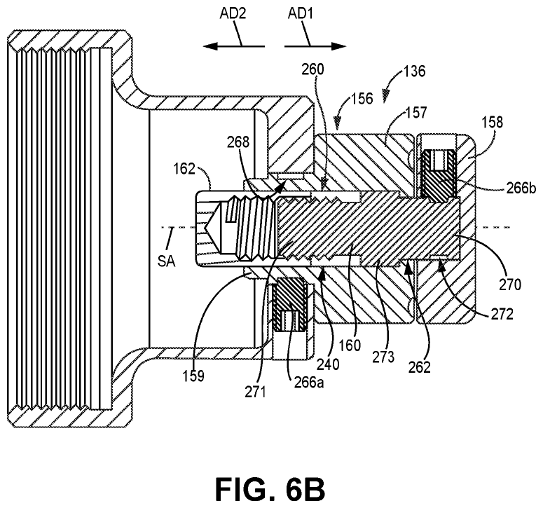

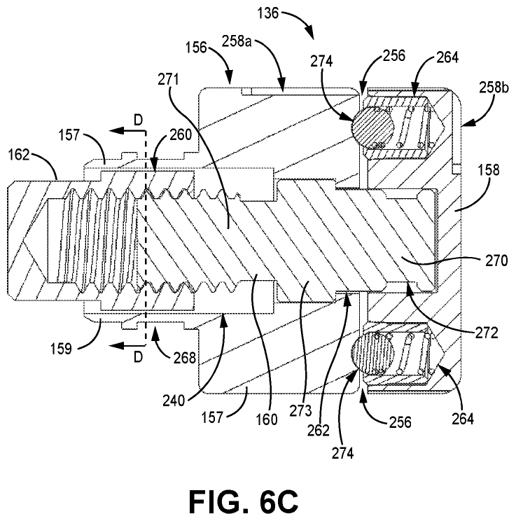

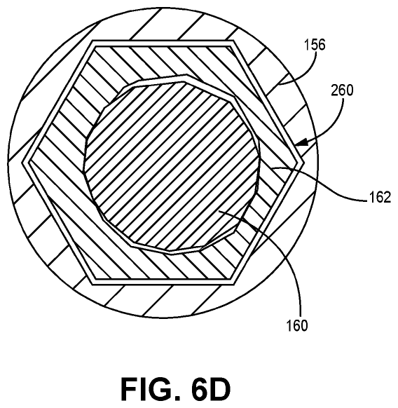

FIG. 6A is an enlarged view of detail 6 in FIG. 2B. FIG. 6B is a cross-sectional view showing displacement limiter 136 mounted to piston cap 154 of gun body 134. FIG. 6C is another cross-sectional view of displacement limiter 136. FIG. 6D is a cross-sectional view taken along line D-D in FIG. 6C. FIGS. 6A-6D will be discussed together. Limiter housing 156, knob 158, positioner 160, stop 162, and knob detents 256 of displacement limiter 136 are shown. Limiter housing 156 includes support body 157, mount body 158, indicator 258a and limiter bore 240 having guide bore 260 and shaft bore 262. Knob 158 includes indicator 258b and detent bores 264. Positioner 160 includes positioner head 270, positioner shaft 271, and positioner body 273.

Displacement limiter 136 is configured to set a degree of opening for the spray valve 122. Displacement limiter 136 is configured to limit the distance that needle 166 can shift to open the spray valve 122. Displacement limiter 136 can limit a distance that piston 140 can shift in automatic spray gun examples. In the example shown, displacement limiter 136 can be actuated to a zero flow state in which the displacement limiter 136 prevents the needle 166 from shifting in first axial direction AD1. In the zero flow state, the displacement limiter 136 can prevent the piston 140 from shifting to prevent the spray gun from outputting both spray fluid and compressed air.

Displacement limiter 136 is mounted to the gun body of the spray gun. In the example shown, displacement limiter 136 is mounted to piston cap 154, though it is understood that not all examples are so limited. Limiter housing 156 is connected to gun body 134 to secure displacement limiter 136 to gun body 134. Mount body 159 is configured to extend into the gun body to be disposed within the gun body. Support body 157 extends in second axial direction AD2 from mount body 159. Support body 157 can be disposed at least partially outside of the gun body in some examples. Mount body 159 has a smaller diameter than the support body 157 in the example shown. Support body 157 and mount body 159 can be formed monolithically, though it is understood that not all examples are so limited.

In the example shown, fastener 266a extends through gun body 134 to engage with the exterior of limiter housing 156 to fix limiter housing 156 to gun body 134. Fastener 266a is formed as a set screw in the example shown, though it is understood that not all examples are so limited. Fastener 266a extends into housing groove 268 formed on mount body 159. The housing groove 268 can be considered to form a limiter mount of the displacement limiter 136. The fastener 266a extending into housing groove 268 locks limiter housing 156 to gun body 134 to prevent limiter housing 156 from shifting axially off of gun body 134. While the limiter mount is shown as housing groove 268, it is understood that not all examples are so limited. For example, mount body 159 can include exterior threading configured to mate with threading of gun body 134.

Limiter bore 240 extends fully axially through limiter housing 156. Limiter bore 240 is formed from guide bore 260 that interfaces with the exterior of stop 162 and shaft bore 262 that extends in first axial direction AD1 from guide bore 260. Stop 162 is keyed to guide bore 260 to prevent rotation of stop 162 in guide bore 260. Guide bore 260 includes a non-circular cross-section taken in a plane normal to the spray axis SA. The exterior of stop 162 is non-circular. The interface between the interior surface of guide bore 260 and the exterior surface of stop 162 prevents stop 162 from rotating on spray axis SA with positioner 160. Instead, the stop 162 shifts axially along spray axis SA as positioner 160 is rotated to thread stop 162 further onto or further off of positioner 160. As shown in FIG. 6D, the exterior of stop 162 and guide bore 260 can be faceted. As shown in FIG. 6D, the exterior of stop 162 and guide bore 260 can be hexed to form the keyed interface.

Positioner body 273 is disposed within shaft bore 262. While guide bore 260 is contoured to prevent rotation of stop 162, shaft bore 262 can be circular and positioner body 273 can similarly be circular to allow for rotation of positioner 160 relative to shaft bore 262. A portion of limiter housing 256 extends to axially overlap with positioner body 273 to prevent positioner 160 from passing out of limiter bore 240 in first axial direction AD1.

Positioner 160 is partially disposed in limiter bore 240 and projects out of limiter bore 240 in first axial direction AD1. The positioner head 270 of positioner 160 extends out of limiter housing 156 and into knob 158. The positioner 160 does not extend fully axially through knob 158 in the example shown.

Positioner 160 is fixed to knob 158 such that knob 158 can drive rotation of the positioner 160 on spray axis SA. In the example shown, positioner 160 is connected to knob 158 by fastener 266b. Fastener 266b extends through the body of knob 158 and engages with an exterior of positioner 160 to fix positioner 160 to knob 158. Fastener 266b is formed as a set screw in the example shown, though it is understood that not all examples are so limited. Fastener 266b extends into shaft groove 272 formed on positioner 160. Shaft groove 272 is formed on positioner head 270 in the example shown. The fastener 266b extending into shaft groove 272 locks positioner 160 and knob 158 together to prevent relative axial movement therebetween. Fastener 266b extends radially through knob 158 to engage with positioner 160.

Stop 162 is mounted on positioner 160. In the example shown, stop 162 is mounted to positioner shaft 271 such that positioner shaft 271 extends into a bore of stop 162. The stop 162 includes a threaded bore while the positioner shaft 271 includes exterior threading that threadedly engages with the threaded bore of stop 162. The positioner 160 is configured to displace the stop 162 axially in either of first axial direction AD1 and second axial direction AD2 to adjust a distance that the needle 166 and/or piston 140 can displace in first axial direction AD1. As discussed above, the stop 162 is keyed to guide bore 260 to prevent rotation of the stop 162 on the spray axis SA. The threaded interface between positioner 160 and stop 162 displaces stop 162 axially as positioner 160 rotates.

Knob 158 is connected to positioner 160 to drive rotation of positioner 160. Knob 158 is configured to be grasped by a user and rotated to cause rotation of positioner 160 and thereby cause axial displacement of the stop 162. Detent bores 264 extend into knob 158. Detent bores 264 are open in second axial direction AD2. Knob detents 256 are disposed at least partially within detent bores 264. Knob detents 256 each include a spring that biases the knob detent 256 into engagement with limiter housing 156. In the example shown, knob detents 256 are ball detents that include a ball that is spring biased into engagement with limiter housing 156.

Catches 274 are formed on limiter housing 156. Catches 274 are formed on the exterior of limiter housing 156 oriented in first axial direction AD1. Limiter housing 156 includes an annular array of catches 274 extending about the spray axis SA. Catches 274 are configured to receive the knob detents 256 to fix a position of knob 158 relative to limiter housing 156. Catches 274 are formed as concavities on the face of limiter housing 156 in the example shown.

Indicator 258a is formed on an exterior of limiter housing 156. In the example shown, indicator 258a is formed as an elongate groove on the radial exterior of limiter housing 156. Indicator 258b is formed on an exterior of knob 158. In the example shown, indicator 258b is formed as an elongate groove on the axial exterior of knob 158. Indicators 258a, 258b are configured to provide visual feedback to the user regarding the position of stop 162 and thus the distance that needle 166 can shift relative to seat 168. For example, indicator 258a being aligned with indicator 258b can indicate to the user that the opening distance of spray valve 122 is set to zero such that spray gun 112 is locked in the non-spray state.

Displacement limiter 136 regulates both the flow of spray fluid through spray gun 112, by setting the opening distance of spray valve 122, and the flow of compressed air through spray gun 112, by setting the displacement distance of piston 140. During operation, the user can rotate knob 158 on spray axis SA to displace stop 162 and set the distance. As the knob 158 is rotated, the knob detents 256 enter into and exit from the catches 274 on limiter housing 156. The annular array of catches 274 provides multiple discrete set positions for knob 158 and thus for stop 162. The knob detents 256 advancing to a next catch 274 in the array of catches 274 incrementally advances or retracts stop 162. The knob 158 can thus be rotated in discrete angular increments, with each increment providing an adjustment to the allowable travel distance of needle 166 and/or piston 140.

The knob detents 256 provide feedback to the user regarding the incremental advancement or retraction of the stop 162. The knob detents 256 can emit an audible click when the knob detent 256 enters into a catch 274, providing audio feedback to the user that the knob 158 has advanced an angular increment. In some examples, the knob detents 256 can cause vibration when entering into a catch 274, providing haptic feedback to the user. Displacement limiter 136 is configured such that each incremental advancement of knob 158 shifts stop 162 a known axial distance.

In some examples, the limiter housing 156 can include additional indicators 258a disposed about the exterior of limiter housing 156. The multiple indicators 258a can provide visual information to the user regarding the actual position of stop 162 and thus the actual distances that needle 166 and piston 140 can displace. In some examples, the indicators 258a can be formed from or include markings (e.g., numerals, letters, other symbols, etc.) that provide information to the user regarding the position of stop 162. For example, the limiter housing 156 can include indicators 258a formed as numerals, with higher numerals indicating larger opening distances that allow for greater fluid flow and lower numerals indicating smaller opening distances that allow for smaller fluid flow.

As discussed above, displacement limiter 136 can be set to a true zero state in which the stop 162 prevents any axial displacement of needle 166 such that spray valve 122 is locked in the closed state. Displacement limiter 136 can be configured such that the indicator 258a aligning with the indicator 258b informs the user that the displacement limiter 136 is in the true zero state. For example, the user can rotate the knob 158 to displace stop 162 in the second axial direction AD2 until the stop 162 bottoms out on return block 147and cannot advance further in second axial direction AD2. The stop 162 being prevented from displacing in second axial direction AD2 indicates that the needle 166 is locked into engagement with seat 168.

The indicators 258a, 258b may not be initially aligned with the displacement limiter 136 in the true zero state. Fastener 266b can be accessed through the fastener bore in knob 158 and loosened such that knob 158 can rotate relative to positioner 160. The knob 158 can then be rotated to align indicator 258b with indicator 258a and the fastener 266b can then be tightened to resecure knob 158 to positioner 160. The user can then rotate knob 158 to displace stop 162 in first axial direction AD1, allowing needle 166 to displace in first axial direction AD1 and the spray valve 122 to shift to the open state. The circumferential distance between indicators 258a, 258b can provide visual feedback to the user regarding the distance that spray valve 122 can open.

Displacement limiter 136 provides significant advantages. Knob detents 256 engage with catches 274 to prevent undesired rotation of knob 158 on spray axis SA. Knob detents 256 further provide feedback to the user regarding the displacement of stop 162 by the knob detents 256 entering into catches and providing audio and/or haptic feedback to the user. The indicators 258a, 258b on the exterior of displacement limiter 136 provide visual information to the user regarding the position of stop 162. The displacement limiter 136 can be set to a true zero state to prevent any emission of spray fluid from spray gun 112. The displacement limiter 136 is manipulable after installation to align indicators 258a, 258b such that indicators 258a, 258b are aligned with displacement limiter 136 in the true zero state, indicating to the user that spray fluid can be emitted when the indicators 258a, 258b are misaligned. Fasteners 266a, 266b being formed as set screws allows for quick and simple installation or manipulation of the fastened components.

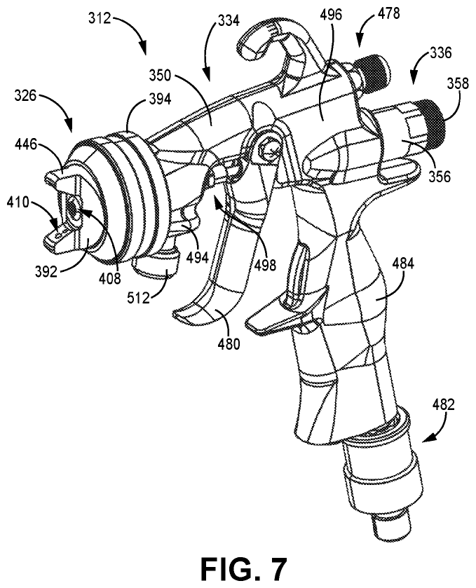

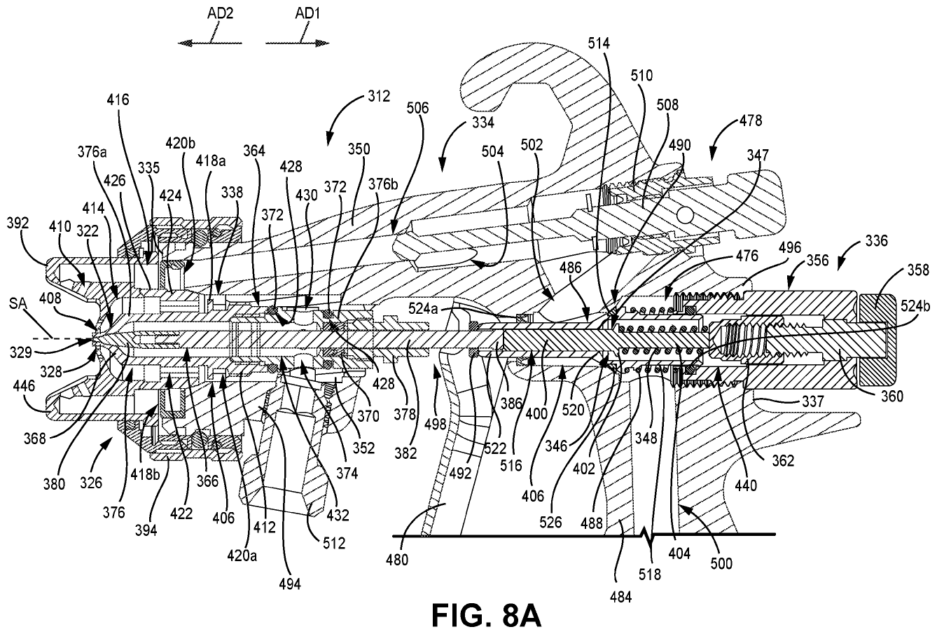

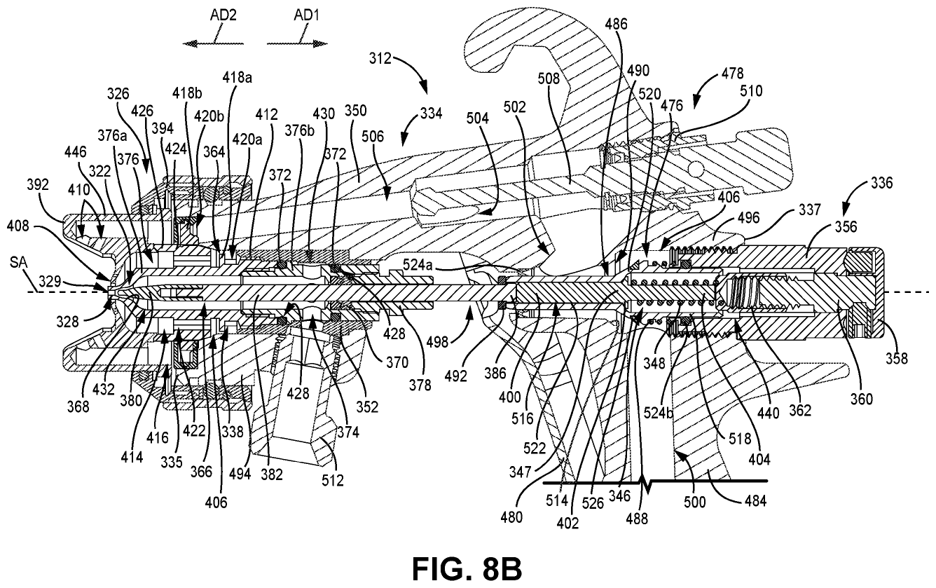

FIG. 7 is an isometric view of spray gun 312. FIG. 8A is a cross-sectional view taken along line 8-8 in FIG. 7 showing the spray valve 322 in a closed state. FIG. 8B is a cross-sectional view taken along line 8-8 in FIG. 7 showing the spray valve 322 in an open state. FIGS. 7-8B will be discussed together. Spray gun 312 is substantively similar to spray gun 112, and same or similar components of spray gun 312 as spray gun 112 are indicated with the same reference numeral except increased by “200”. Spray gun 312 is a manual spray gun configured to be held in the hand of a user and activated directly by the user to spray the spray fluid, while spray gun 112 is an automatic spray gun that is operated by a controller directing compressed gas to open the spray valve 122.

Spray gun 312 includes gun body 334, air cap assembly 326, spray control assembly 338, flow control assembly 476, fan valve 478, trigger 480, and metering valve 482. Gun body 334 includes main body 350, gun mount 352, and handle 484. Air cap assembly 326 includes air cap 392 and cap retainer 394. Flow control assembly 476 includes displacement limiter 336, needle return 346, valve seal 486, and valve spring 488. Displacement limiter 336 includes limiter housing 356, knob 358, positioner 360, and stop 362. Needle return 346 includes return block 347 and return spring 348. Spray control assembly 338 includes spray valve 322, nozzle 328, cartridge body 364, needle 366, seat 368, needle seal 370, cartridge seals 372, and fluid ports 374. Cartridge body 364 includes housing 376 and seal holder 378. Housing 376 includes inlet housing 376a and outlet housing 376b. Needle 366 includes needle tip 380, needle body 382, and needle head 386.

The spray gun 312 sprays along a spray axis SA. The axis also represents an upstream side or direction and a downstream side or direction, wherein spray fluid generally flow from the upstream direction towards the downstream direction. In the example shown, the downstream direction is the second axial direction AD2 and the upstream direction is the first axial direction AD1.

Spray gun 312 is configured as a manual spray gun that is held in a hand of the user and actuated between spray and non-spray states by the user. The user can grasp handle 484 to aim and manipulate spray gun 312. The user can hold spray gun 312 and actuate spray gun 312 between the spray and non-spray states with a single hand of the user. The user can depress trigger 480 with the fingers of the hand that is grasping handle 484 to actuate spray gun 312 between the spray and non-spray states. Trigger 480 controls actuation of the spray valve 322 and the air valve 490 to respective open states.

Spray gun 312 is configured to receive flows of spray fluid and compressed air and to emit an atomized spray of the spray fluid for application on a target surface. Spray gun 312 is configured as a manual spray gun, though it is understood that not all examples are so limited. Gun body 334 supports other components of spray gun 312.

Main body 350 supports other components of spray gun 312. Main body 350 includes front block 494 and rear block 496. Front block 494 at least partially defines flowpaths for both spray fluid and compressed gas to flow through spray gun 312. Rear block 496 at least partially defines flowpaths for compressed gas to flow through spray gun 312. In the example shown, rear block 496 does not define any passages for spray fluid and is not exposed to spray fluid. Trigger gap 498 is disposed axially between front block 494 and rear block 496. Trigger gap 498 is open towards a bottom side of spray gun 312. Trigger gap 498 is closed by a portion of main body 350 that spans between front block 494 and rear block 496.

Handle 484 extends from main body 350. Handle 484 projects from a lower side of main body 350. Handle 484 extends from rear block 496 of main body 350 in the example shown. Air inlet passage 500 is formed within and through handle 484. Air inlet passage 500 provides a flowpath for compressed gas to enter into gun body 334 and flow to the air passages within main body 350.

Metering valve 482 is mounted to gun body 334. Metering valve 482 is configured to connect to an air hose (such as air hose 32 (FIG. 1)) that supplies compressed air to spray gun 312. Metering valve 482 is mounted handle 484. Metering valve 482 is configured to control flow of compressed air to spray gun 312. Metering valve 482 is actuatable between an open state, in which the compressed air can flow into spray gun 312, and a closed state, in which the compressed air is prevented from flowing into spray gun 312. The metering valve is placed in and stays in a desired state. The metering valve 482 is not a check valve that is actuated between open and closed states by the flow of the compressed air.

Gun bore 406 extends fully axially though gun body 334. Gun bore 406 is open on both the front end 335 of spray gun 312 and the rear end 337 of spray gun 312. Gun bore 406 extends along spray axis SA. Gun bore 406 extends fully axially through front block 494 such that gun bore 406 is open on both axial sides of front block 494. The portion of gun bore 406 in front block 494 is open on front end 335 and open to trigger gap 498. Gun bore 406 extends fully axially through rear block 496 such that gun bore 406 is open on both axial sides of rear block 496. The portion of gun bore 406 in rear block 496 is open on rear end 337 and open to trigger gap 498.

A portion of gun bore 406 in rear block 496 is directly downstream from air inlet passage 500 and defines a portion of the compressed gas flowpath through gun body 334. Air valve 490 divides the gun bore 406 in rear block 496 into an upstream passage that is fluidly connected to air inlet passage 500 throughout operation and a downstream passage that is fluidly connected to air inlet passage 500 with air valve 490 in the open state and that is fluidly disconnected from air inlet passage 500 with air valve 490 in the closed state.

Common passage 502 extends from the portion of gun bore 406 in rear block 496 and forms a portion of the compressed air flowpath through spray gun 312. Common passage 502 receives compressed air from the gun bore 406 in rear block 496 when the air valve 490 is in the open state. The common passage 502 routes the compressed air to atomization air passage 504 (an inlet of which is shown) and shaping air passage 506. The atomization passage 504 extends to aperture 420a to output the atomization portion of the compressed air proximate baffle 418a. The shaping air passage 506 extends to aperture 420b to output the shaping portion of the compressed air proximate baffle 418b.

Fan valve 478 is mounted to gun body 334. Fan valve 478 is actuatable between an open state, in which shaping air passage 506 is open and fluidly connected to common passage 502 such that the shaping portion of the compressed air can flow to the air cap 392, and a closed state, in which the shaping air passage 506 is fluidly disconnected from the common passage 502 such that the shaping portion of the compressed air is prevented from flowing to the air cap 392. Fan valve 478 includes a fan valve shaft 508 that has a shaft head that is engageable with a seat within gun body 334 to place fan valve 478 in the closed state. The fan valve shaft 508 is accessible from outside of the gun body 334 to be manipulated by the user. In the example shown, the fan valve shaft 508 is mounted to a support housing 510 by a threaded interface, with the support housing 510 mounted to gun body 334. The fan valve shaft 508 is rotated relative to the support housing 510 to displace the fan valve shaft 508 and place the fan valve 478 in the open or closed states. The atomization air passage 504 is fluidly connected to the common passage 502 regardless of the state of the fan valve 478. As such, spray gun 312 is configured to emit atomization air during any spray operation while the shaping air can be turned on or shut off depending on the state of fan valve 478.

Gun mount 352 is disposed within main body 350. In the example shown, gun mount 352 is disposed within front block 494 of main body 350. Gun mount 352 can be press-fit, threaded, or otherwise secured within main body 350. Gun mount 352 at least partially defines the spray fluid pathway through spray gun 312. Gun mount 352 can be considered to form a wet component of spray gun 312 as gun mount 352 is exposed to the spray fluid during operation.

Spray fluid fitting 512 is mounted to gun body 334. Spray fluid fitting 512 is mounted to main body 350 in the example shown. Spray fluid fitting 512 is mounted to front block 494 of main body 350 in the example shown. Spray fluid fitting 512 is configured to connect with a hose (e.g., fluid hose 30 (FIG. 1)) that supplies spray fluid to spray gun 312 under pressure. Spray fluid fitting 512 can extend into gun mount 352 and can interface with gun mount 352. Spray fluid fitting 512 does not extend to axially overlap with spray control assembly 338. Spray fluid fitting 512 not axially overlapping with spray control assembly 338 allows spray control assembly 338 to be shifted into or out of gun bore 406 during mounting and dismounting without the user having to manipulate spray fluid fitting 512, as discussed in more detail below.

Air cap assembly 326 is disposed at a first axial end of gun body 334. Air cap assembly 326 is mounted to front block 494. Air cap 392 is configured to emit both atomizing air and shaping air. Central orifice 408 is formed through air cap 392. Central orifice 408 is disposed on spray axis SA. Central orifice 408 is configured to emit atomization air from air cap 392. Shaping orifices 410 are formed in horns 446 of air cap 392. Shaping orifices 410 are configured to emit shaping air from air cap 392.

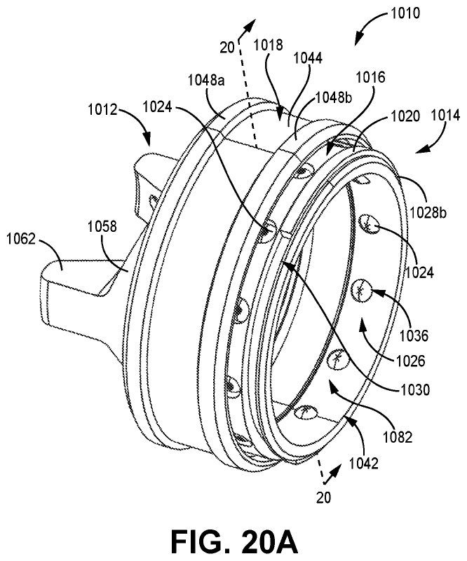

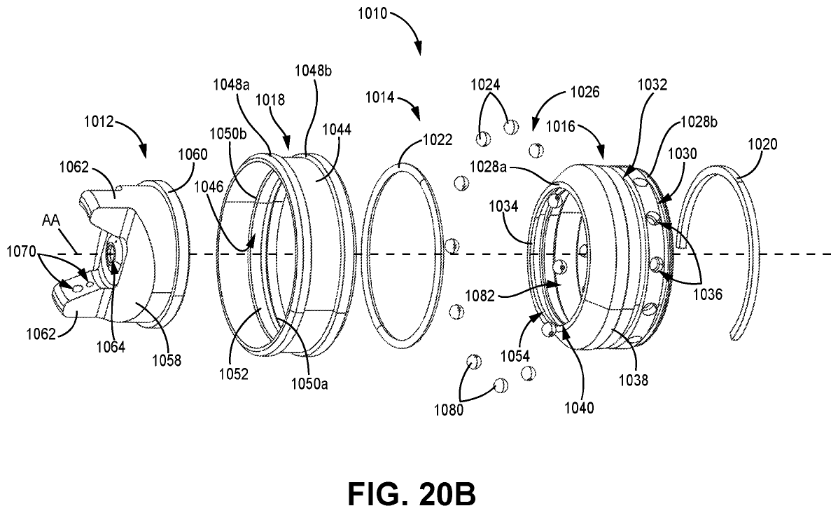

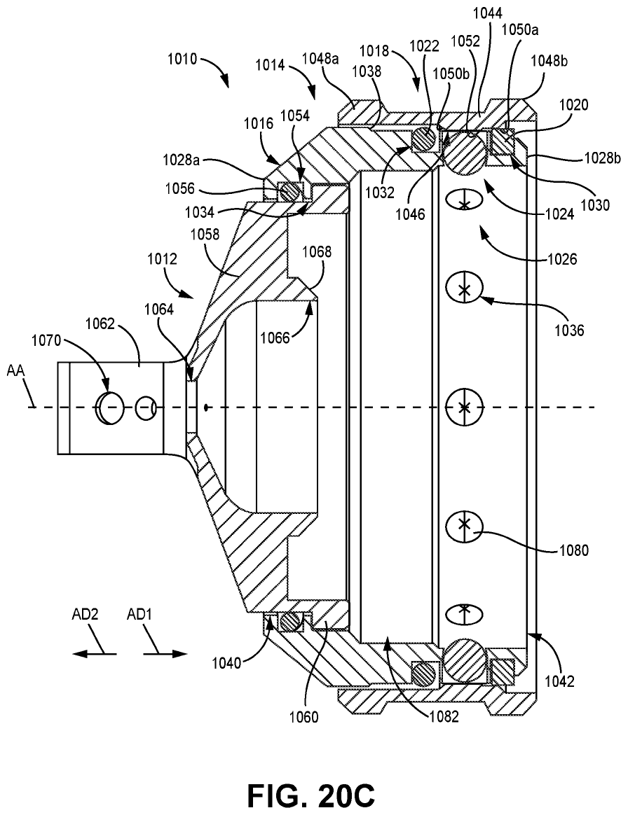

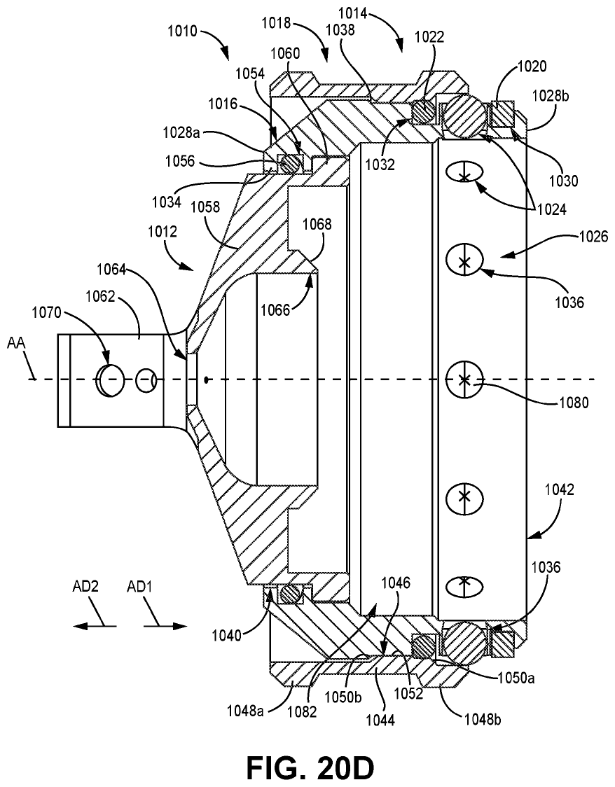

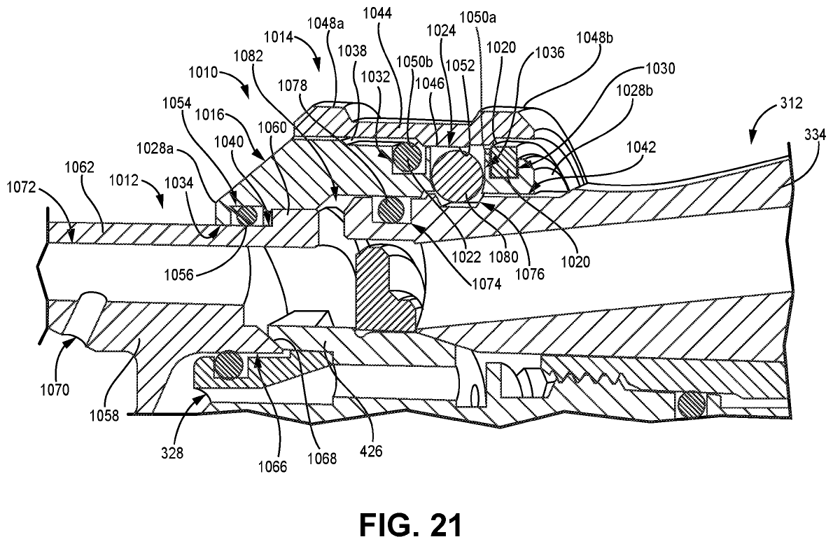

Air cap 392 is mounted to gun body 334 by cap retainer 394. Cap retainer 394 extends over air cap 392 and interfaces with gun body 334 to secure air cap 392 to gun body 334. Cap retainer 394 is connected to front block 494 in the example shown. Cap retainer 394 is mounted to gun body 334 by a quick connect interface (best seen in FIGS. 20A-21) in the example shown, though it is understood that other connection types are possible, such as a threaded connection. In the example shown, a portion of cap retainer 394 is configured to shift axially relative to spray axis SA to lock and unlock air cap 392 to gun body 334.

Spray control assembly 338 is configured to control emission of the spray fluid from spray gun 312. Spray control assembly 338 is mounted to gun body 334. In the example shown, spray control assembly 338 is mounted within front block 494 of main body 350. Spray control assembly 338 extends fully axially through front block 494 in the example shown. Spray control assembly 338 projects out of front block 494 in both first axial direction AD1 and second axial direction AD2 in the example shown.

Spray control assembly 338 is at least partially disposed within gun body 334. Spray control assembly 338 forms a fluid cartridge that is mountable to and dismountable from gun body 334 as a unitary assembly. The spray control assembly 338 is a single module that can be inserted into gun bore 406 through the front end 335 and can be removed from the gun bore 406 through front end 335 as the single module.

Cartridge body 364 supports other components of spray control assembly 338. Cartridge body 364 is at least partially disposed within gun body 334. Cartridge body 364 is secured within gun body 334 to secure spray control assembly 338 relative to gun body 334. In the example shown, cartridge body 364 is mounted to gun mount 352 at a location within front block 494. Cartridge body 364 extends into gun mount 352 to interface with gun mount 352. In the example shown, cartridge body 364 extends fully axially through gun mount 352 such that cartridge body 364 projects out of gun mount 352 in both first axial direction AD1 and second axial direction AD2. Cartridge body 364 is connected to gun mount 352 by a threaded interface in the example shown.

Cartridge body 364 includes housing 376 that is configured to interface with a portion of gun body 334 to mount spray control assembly 338 to gun body 334 and cartridge body 364 includes seal holder 378 that mounts to housing 376. Housing 376 and seal holder 378 form the exterior of cartridge body 364. In the example shown, nozzle 328 is formed by housing 376. Nozzle 328 is formed at a first axial end of housing 376 and seal holder 378 is mounted to a second axial end of housing 376 opposite the first axial end of housing 376. Spray fluid is emitted through spray orifice 329. Nozzle 328 extends to spray orifice 329 through which the spray fluid is emitted. Spray orifice 329 is formed at an axial end of spray control assembly 338 in second axial direction AD2.

Cartridge mount 412 is formed on an exterior of cartridge body 364. In the example shown, cartridge mount 412 is formed on housing 376. Cartridge mount 412 is configured to interface with a portion of gun body 334 to secure spray control assembly 338 to gun body 334. In the example shown, cartridge mount 412 is formed by threads on the exterior of outlet housing 376a. Cartridge mount 412 is configured to engage with threading on gun mount 352 to secure spray control assembly 338 to gun body 334.

Housing 376 at least partially defines flowpaths for spray fluid to flow to nozzle 328 and for compressed air to flow to air cap 392. In the example shown, housing 376 is formed from inlet housing 376b and outlet housing 376a mounted together. Inlet housing 376b is configured to receive spray fluid into spray control assembly 338. Outlet housing 376a is configured to emit spray fluid from spray control assembly 338. Inlet housing 376b and outlet housing 376a are connected together to form housing 376. In the example shown, inlet housing 376b and outlet housing 376a are connected together by a threaded interface. In the example shown, inlet housing 376b includes male threading configured to interface with female threading formed on outlet housing 376a. A portion of inlet housing 376b extends into outlet housing 376a to form the threaded interface therebetween.

Baffle 418a extends radially from the exterior of cartridge body 364. Baffle 418a extends radially from housing 376. In the example shown, baffle 418a extends radially from outlet housing 376a. In the example shown, baffle 418a is formed as a flange extending radially outwards from cartridge body 364. Baffle 418a extends annularly about cartridge body 364 in the example shown. Baffle 418a can be integrally formed with other portions of cartridge body 364. In some examples, baffle 418a can be formed monolithically with other portions of cartridge body 364. In the example shown, baffle 418a is monolithic with housing 376. In the example shown, baffle 418a is monolithic with outlet housing 376.

Baffle 418a is configured to distribute a first portion of the compressed air annularly about the spray axis SA as the first portion of the compressed air flows in second axial direction AD2. The first portion of the compressed air forms the atomization air in the example shown. Inner air chamber 414 is configured to route the first portion of the compressed air to the central orifice 408 of air cap 392. The inner air chamber 414 is formed about the spray axis SA. The inner air chamber 414 is disposed about an exterior of the cartridge body 364. In the example shown, a portion of the inner air chamber 414 is radially bracketed by the cartridge body 364 such that a radially outer side of that portion of the inner air chamber 414 is defined by the cartridge body 364 and a radially inner side of that portion of the inner air chamber 414 is defined by the cartridge body 364. The portion of the inner air chamber 414 radially bracketed by cartridge body 364 is a downstream portion of the inner air chamber 414. The inner air chamber 414 is disposed axially between gun mount 352 and central orifice 408. The downstream portion of the inner air chamber 414 is disposed axially between the air passages 422 and central orifice 408.

The atomization portion of the compressed air enters into the inner air chamber 414 through aperture 420a on one axial side of the baffle 418a. The atomization portion of the compressed air flows in second axial direction AD2 over baffle 418a, through air passages 422 in cartridge body 364 and downstream to central orifice 408. The first portion of the compressed air exits spray gun 312 through central orifice 408 in air cap 392. The first portion of the compressed air exits spray gun 312 through an annular ring formed about the portion of the cartridge body 364 defining nozzle 328.

Baffle 418b extends radially from the exterior of cartridge body 364. Baffle 418b extends radially from housing 376. In the example shown, baffle 418b extends radially from outlet housing 376b. More specifically, the baffle 418b extends radially outward from an outer radial surface of collar 424, in the example shown. Baffle 418b extends annularly about cartridge body 364. In the example shown, baffle 418b is formed as a portion of spray control assembly 338 such that baffle 418b mounts to spray gun 312 with spray control assembly 338 and is removed from spray gun 312 with spray control assembly 338. In some examples, baffle 418b can be formed separately from housing 376 and mounted to housing 376. In some examples, baffle 418b can be integrally formed with other portions of cartridge body 364. In some examples, baffle 418b can be formed monolithically with other portions of cartridge body 364. It is understood, however, that not all examples are so limited. For example, baffle 418b can be formed separately from housing 376 and be mounted within front block 494 such that spray control assembly 338 shifts relative to the baffle 418b during mounting and dismounting. Baffle 418b can be mounted within gun body 334 such that baffle 418b does not mount to and dismount from gun body 334 with spray control assembly 338.

Baffle 418b is configured to distribute a second portion of the compressed air annularly about the spray axis SA as the second portion of the compressed air flows in second axial direction AD2. The second portion of the compressed air forms the shaping air in the example shown. An outer air chamber 416 is configured to route the second portion of the compressed air to the shaping orifices 410. The outer air chamber 416 is formed about the spray axis SA. The outer air chamber 416 is disposed about an exterior of the cartridge body 364. In the example shown, a portion of the outer air chamber 416 radially overlaps with a portion of the inner air chamber 414. The outer air chamber 416 is disposed radially outward of the inner air chamber 414.

The shaping portion of the compressed air enters into the outer air chamber 416 through aperture 420b on one axial side of the baffle 418b. The shaping portion of the compressed air is distributed about the spray axis SA by baffle 418b and flows in second axial direction AD2 and downstream to shaping orifices 410. The shaping portion of the compressed air exits spray gun 312 through shaping orifices 410 in air cap 392.

Collar 424 is formed on outlet housing 376b. Collar 424 extends radially outward relative to other portions of outlet housing 376b. Collar 424 is disposed axially between nozzle 328 and baffle 418a. Collar 424 can extend fully annularly about the spray axis SA.

Air passages 422 extend through collar 424. Air passages 422 are configured to route the atomization portion of the compressed air from an upstream portion of the inner air chamber 414 to the downstream portion of the inner air chamber 414. In the example shown, a plurality of air passages 422 are formed through collar 424. An array of the air passages 422 can be disposed annularly about the spray axis SA.

Ring 426 projects in second axial direction AD2 from a main body portion of collar 424 through which air passages 422 are formed. Ring 426 is disposed radially between inner air chamber 414 and outer air chamber 416. Ring 426 projects to engage with an axially inner side of air cap 392, sealing with air cap 392 to fluidly separate inner air passage 414 and outer air passage 416. Ring 426 defines portions of inner air chamber 414 and outer air chamber 416 in the example shown. The portion of inner air chamber 414 radially bracketed by cartridge body 364 is disposed radially between ring 426 and outlet housing 376a.

Cartridge seals 372 are disposed between cartridge body 364 and gun body 334. Cartridge seals 372 fluidly separate wet portions and dry portions within gun body 334. In the example shown, cartridge seals 372 are disposed on the exterior of cartridge body 364. In the example shown, cartridge seals 372 are disposed between and engage with cartridge body 364 and gun mount 352. Cartridge seals 372 axially bracket the portion of the spray fluid flowpath outside of cartridge body 364 and inside of gun mount 352.

In the example shown, seal grooves 428 are formed on cartridge body 364. Cartridge seals 372 are disposed in seal grooves 428 such that cartridge seals 372 are mounted on cartridge body 364. A first one of seal grooves 428 is disposed axially between nozzle 328 and fluid ports 374. A second one of seal grooves 428 is disposed axially between fluid ports 374 and trigger gap 498.

Fluid passage 430 is disposed axially between the cartridge seals 372. The fluid passage 430 extends fully annularly about cartridge body 364. The fluid passage 430 defines an annular flowpath for the spray fluid to flow fully about cartridge body 364 to enter into fluid ports 374 to enter into flow chamber 432. The fluid passage 430 facilitates spray fluid entering into flow chamber 432 from locations disposed circumferentially about cartridge body 364 and spray axis SA. The flowpath from fluid passage 430 through fluid ports 374 and into flow chamber 432 does not restrict flow relative to outflow through nozzle 328, facilitating efficient and effective output of spray fluid for atomization during spray operations.

Fluid ports 374 are formed through cartridge body 364. Fluid ports 374 form flowpaths for the spray fluid to enter into flow chamber 432 within cartridge body 364. In the example shown, multiple fluid ports 374 are arrayed about the cartridge body 364. Each fluid port 374 includes an outer opening on the exterior of cartridge body 364 that allow spray fluid to enter into the fluid port 374 from fluid passage 430 and includes an inner opening that opens into flow chamber 432 and allows the spray fluid to enter into flow chamber 432. The fluid ports 374 are disposed axially between the cartridge seals 372. The fluid ports 374 are spaced in first axial direction AD1 from cartridge mount 412. The fluid ports 374 are disposed on an opposite axial side of the mating interface between cartridge body 364 and gun body 334 from nozzle 328.

Seal holder 378 is connected to housing 376. In the example shown, seal holder 378 is mounted to housing 376 by a threaded interface formed therebetween. Seal holder 378 is disposed at an opposite axial end of housing 376 from nozzle 328. Seal holder 378 extends into housing 376 to radially overlap with housing 376. Seal holder 378 is configured to interface with needle seal 370 to retain needle seal 370 within cartridge body 364.

Needle seal 370 is configured to interface with an exterior of needle 366. Needle seal 370 can be considered to form a dynamic seal as needle 366 shifts axially relative to needle seal 370 during operation. Needle seal 370 can be formed as a seal assembly including multiple individual sealing components. Needle seal 370 is disposed in the interior of cartridge body 364. The flow chamber 432 of spray control assembly 338 extends axially between nozzle 328 and needle seal 370. Needle seal 370 forms a sliding seal with the exterior of needle 366 as needle 366 shifts between open and closed states. Needle seal 370 engages with the exterior of needle 366 to inhibit spray fluid from leaking in first axial direction AD1 and out of cartridge body 364.

Spray valve 322 is formed between needle 366 and seat 368. Seat 368 is formed by cartridge body 364, in the example shown. Needle 366 is engaged with seat 368 with spray valve 322 in the closed state and needle 366 is disengaged from seat 368 with spray valve 322 in the open state. Needle 366 is configured as the movable component of spray valve 322.

Needle 366 is at least partially disposed within cartridge body 364. Needle 366 is configured to shift along spray axis SA to actuate spray valve 322 between open and closed states. Needle 366 is movable along spray axis SA and relative to seat 368 to place spray valve 322 in the open and closed states.

Needle tip 380 is configured to engage with seat 368 to place spray valve 322 in the closed state. Needle tip 380 is disposed at one axial end of needle 366. Needle body 382 extends axially from needle tip 380. In the example shown, needle tip 380 is formed separately from needle body 382 and connected to needle body 382, such as by a threaded interface. It is understood, however, that not all examples are so limited. For example, needle tip 380 and needle body 382 can be formed monolithically.

Needle body 382 extends in first axial direction AD1 from needle tip 380. Needle body 382 extends from within flow chamber 432 to outside of cartridge body 364. Needle body 382 extends through needle seal 370 and engages with needle seal 370. Needle body 382 engaging with needle seal 370 seals an axial end of flow chamber 432.

Needle head 386 is disposed at an opposite axial end of needle body 382 from needle tip 380. Needle head 386 has a larger diameter than needle body 382. In the example shown, the needle 366 can be considered to have a needle neck that is the same diameter as the needle body 382.

Coupler 492 is mounted on needle body 382. Coupler 492 is disposed on needle body 382 between needle head 386 and cartridge body 364. Coupler 492 is disposed outside of cartridge body 364. Coupler 492 rides on needle body 382 and is not fixed to needle body 382 such that coupler 492 can slide axially along needle body 382 relative to needle body 382. The opening through coupler 492 is sized such that needle head 386 cannot pass through coupler 492.

Coupler 492 is disposed on an opposite side of trigger 480 from cartridge body 364. Coupler 492 is sized such that trigger 480 cannot pass over coupler 492 as trigger 480 is actuated to cause spraying by spray gun 312. Instead, trigger 480 interfaces with coupler 492 such that trigger 480 can displace coupler 492 in first axial direction AD1. Trigger 480 displaces coupler 492 to cause coupler 492 to engage with needle head 386 and then drive needle 366 in first axial direction AD1 to actuate spray valve 322 to the open state. While spray control assembly 338 is described as including coupler 492, it is understood that not all examples are so limited. For example, spray gun 312 can include a valve lock (similar to valve lock 144 (best seen in FIGS. 5A and 5B) that forms a selectively engageable connection with needle 366 to actuate spray valve 322 from the closed to the open state, as discussed in more detail below.

Flow control assembly 476 is configured to control flow of compressed air through spray gun 312. Flow control assembly 476 includes sealing components that are configured to shift along spray axis SA to actuate air valve 490 between an open state, in which the compressed air can flow through air valve 490 and downstream to air cap 392, and a closed state, in which the compressed air is prevented from flowing downstream to air cap 392. In the example shown, valve seal 486 forms the movable valving component of air valve 490. Air valve 490 is formed between flow control assembly 476 and gun body 334 in the example shown. In the example shown, the air seat 514 that the movable valve member of air valve 490 engages is formed by gun body 334. It is understood, however, that not all examples are so limited. For example, flow control assembly 476 can include a housing that forms the air seat 514 of air valve 490 such that both the seat and the movable valving member that define air valve 490 are formed as components of flow control assembly 476.

Flow control assembly 476 is also configured to manage flow of the spray fluid through spray gun 312, though flow control assembly 476 is a dry component that does not contact the spray fluid. Flow control assembly 476 manages the flow of the spray fluid by limiting a displacement distance of the needle 366 in first axial direction AD1. Flow control assembly 476 thereby sets the distance that needle 366 can displace from seat 368, thereby setting the opening size of spray valve 322. Flow control assembly 476 also manages the flow of the spray fluid by actuating the spray valve 322 from the open state to the closed state.

Flow control assembly 476 is disposed coaxially with spray control assembly 338. Flow control assembly 476 is elongate along spray axis SA. Flow control assembly 476 is mounted to gun body 334. In the example shown, flow control assembly 476 is mounted within rear block 496 of gun body 334. In the example shown, flow control assembly 476 is mounted directly to rear block 496. Flow control assembly 476 is mounted to gun body 334 by a threaded interface in the example shown, though it is understood that other connection types are possible.

Flow control assembly 476 extends fully axially through the portion of the gun bore 406 formed in rear block 496. Flow control assembly 476 is mounted to rear block 496 such that flow control assembly 476 projects out of rear block 496 in both first axial direction AD1 and second axial direction AD2. Flow control assembly 476 projects out of rear end 337 of spray gun 312. A portion of flow control assembly 476 projects into trigger gap 498 formed between front block 494 and rear block 496.

Flow control assembly 476 is configured to mount to spray gun 312 as a single unitary component. Flow control assembly 476 forms a flow cartridge that is mountable and dismountable as a single module. The single module is mountable through rear end 337 and dismountable through rear end 337. Flow control assembly 476 and spray control assembly 338 mount in opposite axial directions and dismount in opposite axial directions. The spray control assembly 338 shifts in first axial direction AD1 during mounting and the flow control assembly 476 shifts in first axial direction AD1 during dismounting. The flow control assembly 476 shifts in second axial direction AD2 during mounting and the spray control assembly 338 shifts in second axial direction AD2 during dismounting. The spray control assembly 338 and flow control assembly 476 shift axially towards each other during mounting and shift axially away from each other during dismounting.

Displacement limiter 336 forms a portion of flow control assembly 476. Displacement limiter 336 is mounted to gun body 334. Displacement limiter 336 is mounted to rear block 496 at a location within rear block 496. Displacement limiter 336 is disposed at an opposite axial end of spray gun 312 from nozzle 328. In the example shown, displacement limiter 336 mounts to gun body 334 to secure other components of flow control assembly 476 to gun body 334. The interface between displacement limiter 336 and gun body 334 fixes flow control assembly 476 along spray axis SA. The interface between displacement limiter 336 and gun body 334 is the only mechanical connection that holds flow control assembly 476 to gun body 334 in the example shown.

Limiter housing 356 is mounted to gun body 334. In the example shown, limiter housing 356 is mounted to rear block 496 of gun body 334. Limiter housing 356 is disposed partially within gun body 334 and partially outside of gun body 334. Limiter bore 440 extends axially through limiter housing 356. Limiter bore 440 is disposed coaxially on spray axis SA. In the example shown, limiter bore 440 extends fully axially through limiter housing 356.

Positioner 360 is at least partially disposed within limiter housing 356. Stop 362 is mounted to positioner 360. In the example shown, positioner 360 includes exterior threads that engage with interior threads formed on stop 362. Stop 362 is at least partially disposed within limiter bore 440. Stop 362 is keyed to limiter housing 356 such that stop 362 does not rotate on spray axis SA. For example, at least a portion of the limiter bore 440 can include a non-circular cross-section taken in a plane normal to the spray axis SA and an exterior surface of the stop 362 can be of the same cross-sectional shape as the surface of the limiter bore 440. In some examples, the exterior of stop 362 can be faceted and the limiter bore 440 can be similarly faceted to mate with the stop 362. The stop 362 can limiter bore 440 can be hexed, among other options. The keyed interface prevents stop 362 from rotating on spray axis SA due to rotation of positioner 360. Instead, rotation of positioner 360 causes stop 362 to displace axially along spray axis SA due to the threaded interface between positioner 360 and stop 362.

Stop 362 is configured to interface with needle return 346 to limit displacement of needle return 346, and thus of needle 366, in second axial direction AD2. Stop 362 is configured to define a maximum opening distance of spray valve 322. Stop 362 defines the maximum distance that needle 366 can shift away from seat 368 and relative to seat 368 to open spray valve 322.

Knob 358 is mounted on positioner 360. Knob 358 is fixed to positioner 360 such that rotation of knob 358 causes rotation of positioner 360. Knob 358 is disposed outside of gun body 334. Knob 358 is disposed outside of limiter housing 356. Knob 358 is accessible by a user such that the user can manipulate knob 358 to rotate positioner 360 and displace stop 362 to adjust the maximum opening distance.

Needle return 346 is disposed within gun body 334. Needle return 346 is disposed at least partially within the interior of flow control assembly 476. Needle return 346 is disposed coaxially with displacement limiter 336 in the example shown. Needle return 346 is disposed at least partially within limiter bore 440 in the example shown. Return block 347 extends axially into limiter bore 440 of limiter housing 356. Needle return 346 is configured to interface with needle 366 and bias needle 366 in second axial direction AD2 and into engagement with seat 368.

Return block 347 is a portion of needle return 346 that interfaces with needle 366. Return block 347 is movable along the spray axis SA. Return block 347 is independent of and not connected to valve seal 486. Valve seal 486 and return block 347 can move relative to each other along spray axis SA.

Return rod 400 of return block 347 extends in second axial direction AD2 and is at least partially disposed in needle bore 516 of valve seal 486. Return rod 400 is configured to abut and engage with needle 366. In the example shown, return rod 400 engages with needle head 386. Return rod 400 abuts needle head 386 but is not fixed to needle head 386 in the example shown. Return rod 400 interfaces with a face of needle head 386 oriented in first axial direction AD1.

Return flange 402 extends radially outward from an exterior of return block 347. Return flange 402 provides a bearing surface for return spring 348 to engage with. Return body 404 forms a portion of needle return 346 extending in first axial direction AD1 from return flange 402. Return body 404 is disposed within return spring 348 and can assist in aligning return spring 348 relative to needle return 346. Return body 404 can be considered to form a spring guide that assists in aligning return spring 348 on spray axis SA.

Return spring 348 is disposed within gun body 334 and engages with return block 347. Return spring 348 is disposed within an interior of flow control assembly 476 such that return spring 348 is isolated from and not exposed to the compressed air flowing through spray gun 312, in the example shown. Return spring 348 is disposed radially within valve seal 486 and extends into limiter bore 440 in the example shown. In the example shown, return spring 348 engages with return flange 402 of return block 347. Return spring 348 also engages with displacement limiter 336. In the example shown, return spring 348 braces on stop 362. Return spring 348 is configured to bias return block 347, and thus needle 366 due to the engagement of return rod 400 and needle head 386, in second axial direction AD2. Return spring 348 is configured to bias needle 366 into engagement with seat 368 to place spray valve 322 in the closed state.

Return spring 348 is disposed outside of the flowpath of the spray fluid through spray gun 312. Return spring 348 is a dry component that is not exposed to the spray fluid during operation. Spray control assembly 338 does not include any springs in the flow chamber 432. In the example shown, the spray control assembly 338 does not include any springs that are part of the spray control assembly 338. Spray control assembly 338 is mountable and dismountable as a single module that does not include any springs. The only spring that exerts a biasing force on needle 366 is return spring 348, which does not directly interface with needle 366. Instead, the return spring 348 is indirectly connected to the needle 366 via the intermediate needle return 346. The return spring 348 exerts a biasing force on needle return 346 and needle return 346 exerts a biasing force on needle 366. The needle 366 is a portion of a first module mountable to the gun body 334 and the return spring 348 is a portion of a second module mountable to the gun body 334.

Valve seal 486 is at least partially disposed within gun body 334. Valve seal 486 is elongate along spray axis SA. Valve seal 486 is hollow in the example shown such that a passage extends fully axially through valve seal 486. The passage is open in both the first axial direction AD1 into an interior of valve seal 486 and in second axial direction AD2 towards nozzle 328. Valve seal 486 includes seal body 518, seal shoulder 520, and valve shaft 522.

Valve shaft 522 is elongate along spray axis SA. Valve shaft 522 is formed as cylinder in the example shown, though it is understood that not all examples are so limited. Valve shaft 522 projects axially out of gun bore 406 and into trigger gap 498 in the example shown. Valve shaft 522 extends through and engages with air seal 524a. Valve shaft 522 forms a sliding seal with air seal 524a as valve shaft 522 can slide axially relative to air seal 524a. Air seal 524a is supported by rear block 496 in the example shown. Air seal 524a is formed as a U-cup seal in this example shown, though it is understood that not all examples are so limited. The sealed interface between air seal 524a and valve shaft 522 prevents compressed air from leaking out of rear block 496 in second axial direction AD2.

Valve seal 486 retains needle return 346 within the interior of flow control assembly 476. The diameter of the needle bore 516 through valve shaft 522 is smaller than the diameter of return flange 402 of needle return 346. The return flange 402 will interface with the interior side of seal shoulder 520 to prevent further movement of needle return 346 in second axial direction AD2, retaining return block 347 in the interior of flow control assembly 476.

Needle 366 and needle return 346 interface at a location within valve seal 486. Specifically, needle 366 and return block 347 interface at a location within valve shaft 522. Needle 366 and return block 347 interface within needle bore 516. Valve shaft 522 can locate both return block 347 and needle 366 on spray axis SA to maintain concentricity therebetween. Maintaining the axial alignment between return block 347 and needle 366 reduces wear on needle 366 by driving needle 366 on axis SA, preventing wear to needle 366 or seat 368 that can occur due to non-coaxial engagement therebetween.

Seal shoulder 520 extends between and connects valve shaft 522 and seal body 518. Seal shoulder 520 extends radially outward between valve shaft 522 and seal body 518. A diameter of valve seal 486 enlarges along seal shoulder 520 between valve shaft 522 and seal body 518. In the example shown, seal shoulder 520 is sloped between valve shaft 522 and seal body 518 such that seal shoulder 520 extends both axially and radially between valve shaft 522 and seal body 518.

Seal body 518 extends in first axial direction AD1 from seal shoulder 520. Seal body 518 extends from seal shoulder 520 and into limiter housing 356. Seal body 518 has a larger diameter than valve shaft 522 in the example shown. Seal body 518 is cylindrical in the example shown, though it is understood that not all examples are so limited.

Seal body 518 extends into limiter housing 356 and engages with air seal 524b. Air seal 524b engages with an exterior surface of seal body 518. Air seal 524b is supported by limiter housing 356 in the example shown. Air seal 524b engaging with seal body 518 and limiter housing 356 inhibits leakage of compressed air therebetween in first axial direction AD1. Air seal 524b seals an interior of flow control assembly 476 and prevents compressed air from flowing into the interior of flow control assembly 476.

Valve seal 486 engages with air seat 514 with air valve 490 in the closed state and is disengaged from air seat 514 with air valve 490 in the open state. In the example shown, flow seal 526, which is supported by valve seal 486, is configured to directly interface with the air seat 514 to place air valve 490 in the closed state. Flow seal 526 is supported by seal shoulder 520 in the example shown. Flow seal 526 is formed separately from valve seal 486 and mounted on valve seal 486 in the example shown. Flow seal 526 is configured to engage with air seat 514 to place air valve 490 in a closed state. Flow seal 526 is spaced from air seat 514 with air valve 490 in an open state. While flow control assembly 476 is described as including flow seal 526, it is understood that not all examples are so limited. For example, valve seal 486 can be configured to directly interface with air seat 514 to place air valve 490 in the closed state.

Valve spring 488 interfaces with valve seal 486 and biases air valve 490 to the closed state. Valve spring 488 biases valve seal 486 in second axial direction AD2 and into engagement with air seat 514. Valve spring 488 extends axially between limiter housing 356 and valve seal 486. In the example shown, seal body 518 of valve seal 486 is disposed radially within valve spring 488 and extends through valve spring 488. Valve spring 488 is disposed on an exterior of flow control assembly 476. Valve spring 488 is disposed such that valve spring 488 is exposed to the airflow through spray gun 312.

Valve spring 488 is configured to bias air valve 490 to the closed state. Return spring 348 is configured to bias spray valve 322 to the closed state. Both valve spring 488 and return spring 348 are disposed within rear block 496 in the example shown. Valve spring 488 and return spring 348 are both formed as dry components that are not exposed to the spray fluid flowing through spray gun 312. Valve spring 488 and return spring 348 are disposed coaxially on spray axis SA. Valve spring 488 and return spring 348 radially overlap with each other. Valve spring 488 is disposed radially outward of return spring 348.

During operation, compressed air is provided to spray gun 312 through air inlet passage 500 and spray fluid is provided to spray gun 312 through spray fluid fitting 512. The spray valve 322 and the air valve 490 are normally in respective closed states. The compressed air flows through air inlet passage 500 and into the gun bore 406 in rear block 496. The valve seal 486 is maintained in engagement with the air seat 514 by valve spring 488 exerting an axial biasing force on valve seal 486 in second axial direction AD2 such that the air valve 490 is in the closed state, preventing flow of compressed air in second axial direction AD1 past air valve 490. The spray fluid flows through spray fluid fitting 512 and enters into fluid passage 430. The spray fluid flows through fluid ports 374 and enters into flow chamber 432 in the interior of spray control assembly 338. The needle 366 is maintained in engagement with seat 368 by return spring 348 exerting a force in second axial direction AD2 on needle return 346 and needle return 346 exerting a force on needle 366 in second axial direction AD2 to bias needle 366 into engagement with seat 368. The spray valve 322 is thus in the closed state, preventing flow of the spray fluid through nozzle 328.

To cause spraying the user depresses trigger 480. The trigger 480 shifts in first axial direction AD1 and engages with coupler 492. For example, the trigger can pivot on a pivot point through the gun body 334. The coupler 492 exerts an axial driving force on valve seal 486 at valve shaft 522. The force of valve spring 488 is overcome and valve seal 486 displaces in first axial direction AD1. Valve seal 486 disengages from air seat 514 and a flowpath is opened between valve seal 486 and air seat 514. Valve spring 488 is compressed between valve seal 486 and limiter housing 356. Air valve 490 is thus in the open state.

With air valve 490 in the open state, the compressed air flows through the air valve 490 and downstream to the common passage 502. The compressed air flows through common passage 502 and to the atomization passage 504 and shaping air passage 506. The atomization portion of the compressed air flows through the atomization passage 504 and out through central orifice 408 in air cap 392. The shaping portion of the compressed air flows through shaping air passage 506 if fan valve 478 is in the open state. With fan valve 478 in the open state the shaping portion of the compressed air flows downstream through shaping air passage 506 and exits from air cap 392 through shaping orifices 410.

The atomization portion of the compressed air flows through atomization passage 504 and to the portion of gun bore 406 in front block 494. The atomization air enters into inner air chamber 414 through aperture 420a. The atomization air encounters baffle 418a, which interrupts the flow and distributes the flow of the atomization air around the spray axis SA. The atomization air continues over baffle 418a and flows through air passages 422 in second axial direction AD2. The atomization air exits air passages 422 and flows through the downstream portion of inner air chamber 414 to central orifice 408. The atomization air exits from central orifice 408 as a ring about nozzle 328.

The shaping portion of the compressed air flows through shaping air passage 506 and encounters baffle 418b. Baffle 418b interrupts the flow of the shaping portion and the distributes the shaping portion about the spray axis SA. The shaping air flows through outer air chamber 416 and to air cap 392. The shaping air exits from shaping orifices 410 in air cap 392.

Air valve 490 shifts to the open state prior to spray valve 322 shifting to the open state. The flow control assembly 476 is configured such that valve seal 486 displaces axially before needle 366 is engaged to displace axially. The air valve 490 shifting to the open state prior to the spray valve 322 shifting to the open state causes the spray gun 312 to emit compressed air from air cap 392 prior to spray gun 312 emitting spray fluid through nozzle 328. The spray gun 312 emitting the compressed air prior to emitting the spray fluid ensures that the atomization air will impact and atomize the spray fluid, preventing sputtering and spitting of the spray fluid that could otherwise occur.

In the example shown, needle head 386 is recessed within valve shaft 522 in first axial direction AD1 such that the coupler 492 contacts the valve seal 486 prior to encountering the needle head 386. As such, the trigger encounters and displaces the valve seal 486 prior to encountering and displacing the needle 366. In examples in which the spray gun 312 includes a valve lock, the valve lock is positioned such that the valve seal 486 displaces axially prior to the needle detents encountering and engaging needle head 386 to displace needle 366, ensuring emission of atomization air prior to emission of spray fluid.

Trigger 480 continues to displace and coupler 492 (in some examples a valve lock) encounters needle head 386 and exerts an axial driving force on needle 366 in first axial direction AD1. The needle 366 encounters return block 347 and exerts an axial driving force on return block 347. The force of return spring 348 is overcome and needle 366 and needle return 346 displace in first axial direction AD1. Return spring 348 is compressed between needle return 346 and stop 362. The needle 366 disengages from seat 368. Spray valve 322 is thereby placed in the open state.

In some examples, valve seal 486 can assist in displacement of the spray valve 322 to the open state. Flow control assembly 476 can be configured such that the interior side of seal shoulder 520 engages with the sloped face of return flange 402 oriented in second axial direction AD2. The valve seal 486 can engage with return flange 402 at the same time as the coupler 492 engages with needle head 386. The coupler 492 can thereby exert driving force on needle 366 at needle head 386 and can exert driving force on needle return 346 through valve seal 486.

Displacement of needle 366 in first axial direction AD1 can be limited by stop 362. Stop 362 can be disposed on spray axis SA and positioned such that return block 347 encounters stop 362 prior to needle 366 shifting a full possible displacement distance in first axial direction AD1. The stop 362 provides a hard stop that limits further axial displacement of return block 347 and needle 366. The trigger 480 is preventing from being further displaced by the return block 347 encountering the stop 362.

With spray valve 322 in the open state, the spray fluid flows through the gap between needle tip 380 and seat 368. The spray fluid flows downstream through nozzle 328 and is emitted from spray gun 312. The atomization air exiting through central orifice 408 impinges on and atomizes the spray fluid exiting from nozzle 328. The shaping air encounters the atomized spray fluid and shapes the atomized spray fluid into a desired pattern.

To stop spraying the user releases the trigger 480. The air valve 490 and spray valve 322 are independent such that air valve 490 is actuated to the closed state independent of the spray valve 322 being actuated to the closed state. Similarly, the air valve 490 and spray valve 322 are independently actuated to respective open states.

Valve spring 488 exerts biasing force on valve seal 486 in second axial direction AD2 and displaces valve seal 486 in second axial direction AD2. Return spring 348 exerts biasing force on return block 347 in second axial direction AD2 and displaces needle return 346 in second axial direction AD2. The needle return 346 exerts a biasing force on needle 366 and displaces needle 366 in second axial direction AD2 until needle 366 engages with seat 368 such that spray valve 322 is in the closed state.

As discussed above, spray gun 312 is configured such that air valve 490 opens prior to spray valve 322 opening. The valve seal 486 displaces a first distance along spray axis SA in first axial direction AD1 prior to needle 366 beginning to shift in first axial direction AD1. Both the valve seal 486 and needle 366 shift together along the spray axis SA a second axial distance. The total displacement of the needle 366 is the second axial distance and the total displacement of the valve seal 486 is a third axial distance, which is a sum of the first axial distance and the second axial distance. The third axial distance is greater than the second axial distance.

Valve seal 486 then needs to displace the third axial distance back to closed while the needle 366 needs to displace the shorter second axial distance back to closed. The spray valve 322 can shift to the closed state prior to the air valve 490 shifting to the closed state. The spray valve 322 closing prior to the air valve 490 closing causes the spray gun 312 to stop emitting spray fluid prior to the spray gun 312 stopping emission of the compressed air. The spray gun 312 continuing to emit the compressed air up to and after the spray gun 312 stops emitting spray fluid prevents sputtering and spitting of the spray fluid at the end of spraying. Atomization air is emitted prior to, during, and after emission of the spray fluid, providing a high quality spray for the duration of spray fluid emission from spray control assembly 338.

Spray gun 312 provides significant advantages. Spray control assembly 338 is mountable as a single, unitary component. Spray control assembly 338 can be mounted and dismounted through front end 335 of spray gun 312. The user does not have to access other components spaced in first axial direction AD1 from spray control assembly 338 to make or break the driving connection that actuates needle 366 during operation. Instead, the user can simply and easily access spray control assembly 338 at front end 335. With the air cap 392 dismounted and trigger 480 shifted to not block movement of coupler 492 in second axial direction AD2, only the cartridge housing 376 needs to be manipulated to install or remove the spray control assembly 338. The spray fluid fitting 512 does not need to be manipulated for mounting or dismounting of spray control assembly 338 as the spray fluid fitting 512 does not extend to interfere with axial movement of the spray control assembly 338.

Spray control assembly 338 does not include any springs that bias needle 366. Needle 366 is actuated to engage seat 368 to place spray valve 322 in the closed state by return spring 348 that is disposed in rear block 496 and does not directly interface with needle 366. No spring is disposed in the spray fluid pathway or exposed to the spray fluid. No springs are disposed in front block 494 to actuate needle 366. Isolating springs from the wet portions of spray gun 312 prevents material accumulation on any such spring that could cause the spring to stick or otherwise lead to required maintenance.

Flow control assembly 476 is mountable to and dismountable from spray gun 312 as a single, unitary component. Flow control assembly 476 is a single module that can be mounted to and dismounted through rear end 337 of spray gun 312. The flow control assembly 476 both controls flow of compressed air and affects operation of the spray valve 322. The flow control assembly sets the distance that needle 366 can space from the seat 368 thereby controlling an opening size of spray valve 322, via displacement limiter 336. The flow control assembly 476 also actuates the spray valve 322 from the open state to the closed state. The air valve 490 and spray valve 322 are independently actuated to the closed state by components of the flow control assembly 476.

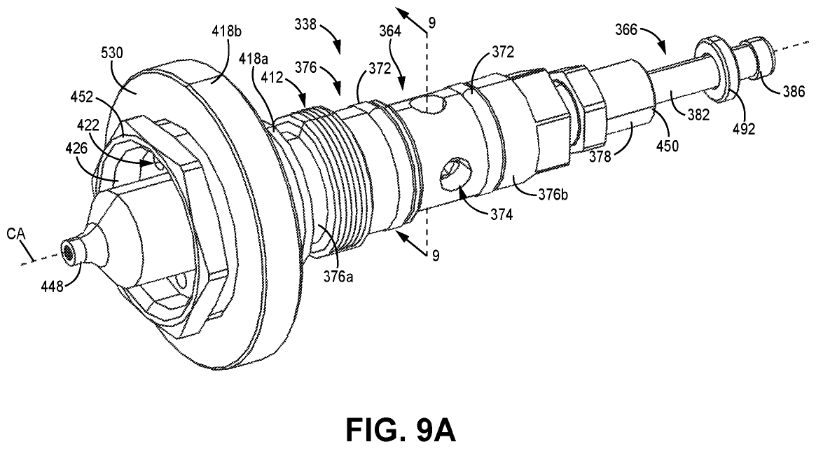

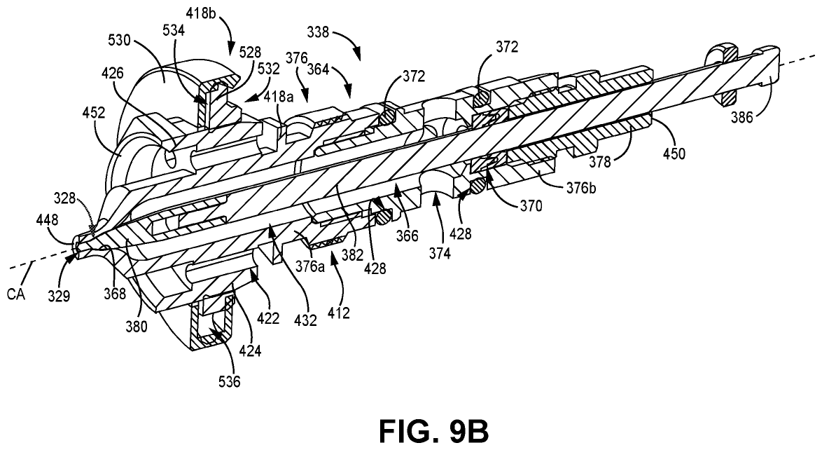

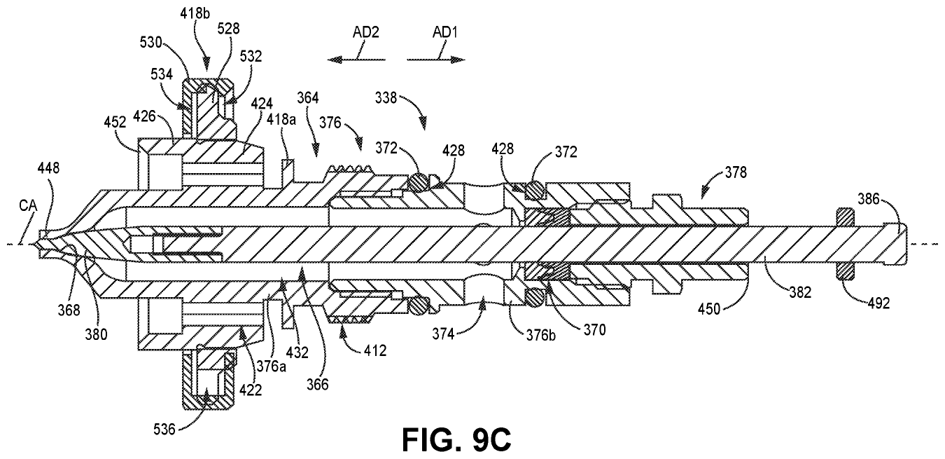

FIG. 9A is an isometric view of spray control assembly 338. FIG. 9B is an isometric cross-sectional view of spray control assembly 338 taken along line 9-9 in FIG. 9A. FIG. 9C is an elevational cross-sectional view of spray control assembly 338 taken along line 9-9 in FIG. 9A. FIGS. 9A-9C will be discussed together. Spray control assembly 338 includes nozzle 328, cartridge body 364, needle 366, seat 368, needle seal 370, cartridge seals 372, seal grooves 428, baffle 418a, baffle 418b, and fluid ports 374. Cartridge body 364 includes housing 376 and seal holder 378. Housing 376 includes inlet housing 376a and outlet housing 376b. Needle 366 includes needle tip 380, needle body 382, and needle head 386.

Spray control assembly 338 is configured to control emission of spray fluid from a spray gun, such as spray gun 312. Spray control assembly 338 forms a single module that is mountable to and dismountable from the spray gun 312 as the single module. The spray control assembly 338 is mountable to the spray gun 312 such that only a single mounting interface is formed between spray control assembly 338 and spray gun 312.

Cartridge body 364 forms an exterior of spray control assembly 338. Cartridge body 364 is elongate along cartridge axis CA. Cartridge axis CA can be disposed coaxially with spray axis SA with spray control assembly 338 mounted to gun body 334.

Cartridge body 364 defines flow chamber 432. Flow chamber 432 is formed within cartridge body 364 and is a chamber that routes pressurized spray fluid to nozzle 328 for spraying. In the example shown, flow chamber 432 is formed such that the spray fluid enters into flow chamber 432 through fluid ports 374 and then exits from flow chamber 432 through nozzle 328. The spray fluid remains within flow chamber 432 within cartridge body 364 between fluid ports 374 and nozzle 328.

Cartridge body 364 includes housing 376 and seal holder 378 mounted together. Seal holder 378 extends into housing 376 such that a portion of housing 376 is disposed around a portion of seal holder 378. In the example shown, housing 376 and seal holder 378 are connected together at a threaded interface.

Housing 376 is formed from inlet housing 376b and outlet housing 376a in the example shown. Inlet housing 376b extends into outlet housing 376a to connect to outlet housing 376a. A portion of outlet housing 376a is disposed outside of and around a portion of inlet housing 376b. In the example shown, inlet housing 376b and outlet housing 376a are connected together by a threaded interface. While housing 376 is formed from inlet housing 376b and outlet housing 376a, it is understood that in some examples inlet housing 376b and outlet housing 376a can be formed as a single component. In some examples, inlet housing 376b and outlet housing 376a can be formed as a monolithic component.

Fluid ports 374 extend through cartridge body 364 and provide flowpaths for spray fluid to enter into flow chamber 432. In the example shown, fluid ports 374 are formed through inlet housing 376b. Fluid ports 374 are disposed radially through cartridge body 364. During operation, pressurized spray fluid flows radially through fluid ports 374 to enter into flow chamber 432 and the pressurized spray fluid flows axially through nozzle 328 to exit from flow chamber 432. Spray control assembly 338 redirects the spray fluid from a radial inlet flow to an axial outlet flow.

Outlet housing 376a extends in second axial direction AD2 from inlet housing 376b. Nozzle 328 is formed through outlet housing 376a. Nozzle 328 is formed by outlet housing 376a in the example shown. Nozzle 328 is disposed at first end 448 of cartridge body 364. Spray orifice 329 is an opening through cartridge body 364 at a downstream end of nozzle 328 that is configured to emit the spray fluid from the cartridge body 364.

Cartridge mount 412 is formed on an exterior of cartridge body 364. Cartridge mount 412 is configured to interface with the gun body 334 of the spray gun 312 to secure spray control assembly 338 to the gun body 334. In the example shown, cartridge mount 412 is formed as threading on an exterior of cartridge body 364. The cartridge mount 412 configured to interface with threads in the gun body 334.

Cartridge mount 412 is disposed axially between fluid ports 374 and nozzle 328. As such, the spray control assembly 338 is fixed to the gun body 334 at a location axially between the locations where the spray fluid enters into spray control assembly 338 and where the spray fluid exits from the spray control assembly 338. Cartridge mount 412 is disposed axially between dry portions of the exterior of cartridge body 364, which dry portions do not contact the spray fluid during operation, and wet portions of the exterior of the cartridge body 364, which wet portions do contact the spray fluid during operation. The wet exterior portion of cartridge body 364 is disposed axially between cartridge seals 372.

Cartridge mount 412 is disposed axially between ports in cartridge body 364 that route the spray fluid (e.g., fluid ports 374) and ports in the cartridge body 364 that route compressed air (e.g., air passages 422). While cartridge mount 412 is shown as exterior threads, it is understood that not all examples are so limited. For example, spray control assembly 338 can be configured to mount via a bayonet style connection with spray gun 312. In such an example, cartridge mount 412 can be formed as one or more projections or slots configured to interface with mating slots or projections of gun body 334.

Collar 424 is formed as a radial enlargement of cartridge body 364. Air passages 422 extend through collar 424 and define pathways for compressed air to flow from a first axial side of collar 424 to a second axial side of collar 424. Air passages 422 extend axially in the example shown. Air passages 422 extend along passages axes that are parallel to the cartridge axis CA in the example shown.

Ring 426 is a portion of collar 424 that projects in second axial direction AD2. Ring 426 does not radially overlap with air passages 422 in the example shown. Ring 426 extends around and defines an annular chamber, which forms a portion of inner air chamber 414, that the atomization air enters into after exiting from the air passages 422. In the example shown, ring 426 includes a faceted exterior surface. The faceted exterior forms a tool interface on which a tool, such as a wrench, can interface with cartridge body 364 to torque cartridge body 364 during installation and removal.

Ring 426 projects to ring lip 452. Ring lip 452 is configured to interface with air cap 392 to seal against air cap 392 and fluidly separate the inner air chamber 414 and outer air chamber 416, thereby separating the atomization and shaping portions of the compressed air.

Baffle 418a extends radially from cartridge body 364. Baffle 418a extends radially outward to axially overlap with air passages 422. During operation, compressed air (e.g., the atomization air) flows over and around baffle 418a to reach air passages 422 and flow downstream to central orifice 408 in air cap 392. The baffle 418a facilitates distribution of the compressed air about the cartridge axis CA.

Baffle 418b extends radially from cartridge body 364. In the example shown, baffle 418b extends radially outward from collar 424. Baffle 418b is disposed radially outward from baffle 418a. In the example shown, baffle 418b does not axially overlap with baffle 418a. During operation, compressed air (e.g., the shaping air) is impeded by baffle 418b and flows around baffle 418b to reach air cap 392 and flow to the shaping orifices 410 in air cap 392. Baffle 418b is configured such that the compressed air flows between an inner radial edge of baffle 418b and cartridge body 364. The baffle 418b facilitates distribution of the compressed air about the cartridge axis CA.

Baffle 418b includes inner baffle 528 and outer baffle 530. Inner baffle 528 is mounted to cartridge body 364. In the example shown, inner baffle 528 is mounted on collar 424 of outlet housing 376b. A flow groove 532 is formed on the axial face of inner baffle 528 oriented in second axial direction AD1. The flow groove 532 is an annular groove that is configured to distribute the atomization air circumferentially about the cartridge axis CA. Outer baffle 530 is mounted to inner baffle 528 in the example shown. The radially inner side of outer baffle 530 is spaced radially outward from the exterior surface of cartridge body 364. A radial gap is formed between outer baffle 530 and cartridge body 364. The radial gap can extend fully annularly about the cartridge body 364 and cartridge axis CA.

A flow gap 534 is formed between outer baffle 530 and inner baffle 528. The flow gap 534 is disposed axially between outer baffle 530 and inner baffle 528. The flow gap 534 extends fully annularly about the cartridge body 364 and cartridge axis CA. One or more axial apertures 536 extend through inner baffle 528 and provide flow passages for compressed air to flow between the flow groove 532 in inner baffle 528 and the flow gap 534 between inner baffle 528 and outer baffle 530. In the example shown, the axial apertures 536 are disposed on an opposite side of cartridge axis CA from the flow opening formed in inner baffle 528 through which the compressed air enters into baffle 418b. Having the axial apertures 536 disposed on an opposite side of cartridge axis CA facilitates distribution of the compressed air fully annularly about the cartridge axis CA. The compressed air exits from baffle 418b through the radial gap between outer baffle 530 and cartridge body 364 and continues downstream for emission from air cap 392.

Seal grooves 428 are formed on the exterior of cartridge body 364. Seal grooves 428 extend radially into cartridge body 364. A first seal groove 428 is spaced in second axial direction AD2 from fluid ports 374. A second seal groove 428 is spaced in first axial direction AD1 from fluid ports 374. In the example shown, the first seal groove 428 is formed between inlet housing 376b and outlet housing 376a. The first seal groove 428 is partially defined by inlet housing 376b and partially defined by outlet housing 376a. In the example shown, the seal groove 428 is formed by inlet housing 376b.

Cartridge seals 372 are disposed in seal grooves 428. The cartridge seals 372 are configured to engage with gun body 334 to inhibit leakage of spray fluid about the exterior of cartridge body 364 in either first axial direction AD1 or second axial direction AD2. Cartridge seals 372 are disposed on opposite axial sides of the fluid ports 374. A first cartridge seal 372 is disposed axially between the fluid ports 374 and cartridge mount 412. The first cartridge seal 372 is disposed axially between the fluid ports 374 and nozzle 328. The first cartridge seal 372 is disposed axially between the fluid ports 374 and baffle 418a. The first cartridge seal 372 is disposed axially between the fluid ports 374 and baffle 418b. A second cartridge seal 372 is disposed axially between fluid ports 374 and needle head 386. Cartridge seals 372 can be of any configuration suitable for creating a fluid-tight seal to inhibit leakage of spray fluid. For example, cartridge seals 372 can be configured as elastomer seals, such as O-rings, among other options. In the example shown, the first cartridge seal 372 has a larger diameter than the second cartridge seal 372.

Needle seal 370 is disposed within cartridge body 364. In some examples, needle seal 370 can be mounted to seal holder 378. In some examples, needle seal 370 can be clamped between seal holder 378 and housing 376. Needle seal 370 is configured to engage an exterior of needle 366. Needle seal 370 prevents spray fluid from leaking out of cartridge body 364 between needle 366 and cartridge body 364. The interface between needle seal 370 and needle 366 is a sliding interface as needle 366 slides axially relative to needle seal 370 during operation.

Needle 366 is at least partially disposed within cartridge body 364. Needle 366 is elongate along cartridge axis CA. Needle 366 is configured to shift along cartridge axis CA during operation. In the example shown, needle 366 extends out of cartridge body 364 through second end 450 of cartridge body 364. Needle 366 does not extend out of cartridge body 364 through first end 448 of cartridge body 364. Needle radially overlaps with a portion of the axial length of housing 376. Needle radially overlaps with a full axial length of seal holder 378.

Needle tip 380 is disposed at a first axial end of needle 366. Needle tip 380 is configured to engage with seat 368 with spray valve 322 in a closed state. Needle tip 380 is spaced from and disengaged from seat 368 with spray valve 322 in an open state. Needle tip 380 disengaging from seat 368 opens the flowpath between needle 366 and seat 368 and through spray valve 322 and allows the spray fluid to flow to and through nozzle 328.

Needle body 382 extends axially from needle tip 380. Needle body 382 extends from within flow chamber 432 to outside of cartridge body 364. Needle body 382 extends through needle seal 370 and engages with needle seal 370. In the example shown, needle tip 380 is formed separately from needle body 382 and is connected to needle body 382. For example, needle tip 380 can mount to needle body 382 by a threaded connection. It is understood, however, that not all examples are so limited. For example, needle tip 380 and needle body 382 can be formed as a single component. Needle tip 380 and needle body 382 can be monolithically formed.

Needle head 386 is connected to needle body 382. In the example shown, needle head 386 projects radially outward relative to needle body 382. Needle head 386 has a larger diameter than needle body 382. Needle head 386 forms an axial end of needle 366 opposite the axial end formed by needle tip 380. It is understood that some examples of needle 366 can include a needle neck having a smaller diameter than needle body 382 and needle head 386 that extends between and connects needle body 382 and needle head 386.

Spray valve 322 is formed between needle 366 and seat 368. Spray valve 322 is in an open state with needle 366 spaced from seat 368 such that spray fluid can flow downstream to and through nozzle 328 through the gap between needle 366 and seat 368. Spray valve 322 is in a closed state with needle 366 engaged with seat 368, thereby preventing spray fluid from flowing to and through nozzle 328.

Spray control assembly 338 does not include any springs that act on or bias needle 366. Needle 366 is actuated to engage with seat 368 by a biasing component disposed outside of and separate from spray control assembly 338. Needle 366 is actuated to disengage from seat 368 by an actuator disposed outside of and separate from spray control assembly 338.

Needle 366 is movable along cartridge axis CA relative to cartridge body 364. In some examples, needle 366 can removed from cartridge body 364 for servicing or replacement. For example, needle 366 can be pulled in first axial direction AD1 and out of cartridge body 364 through second end 450. A replacement needle 366 can be inserted into spray control assembly 338 through second end 450. The replacement needle 366 is pushed in second axial direction AD2 and initially enters into seal holder 378. The replacement needle 366 passes through needle seal 370 to engage with needle seal 370 and enters into flow chamber 432.

Spray control assembly 338 controls emission of spray fluid from spray gun 312. Spray control assembly 338 further directs one or more of the flows of compressed air. In the example shown, spray control assembly 338 directs both the atomization air, via baffle 418a and air passages 422, and the shaping air, via baffle 418b. It is understood, however, that not all examples are so limited. For example, spray control assembly 338 can be configured to direct only one or the other of the atomization and shaping air flows.

Spray control assembly 338 is mountable to and dismountable from spray gun 312 as a single module. The spray control assembly 338 forms the single module such that spray control assembly 338 mounts to and dismounts from spray gun 312 as one unit, without requiring assembly or manipulation of individual components of the spray control assembly 338. The spray control assembly 338 is mountable and dismountable by manipulating cartridge body 364, to form or break a connection interface between cartridge body 364 and gun body 334 of spray gun 312.

Spray control assembly 338 can be mounted to the spray gun 312 by shifting spray control assembly 338 in first axial direction AD1 and into the spray gun 312 (e.g., into gun bore 406 in gun body 334). Cartridge mount 412 is engaged with a corresponding mounting interface on spray gun 312, such as female threading configured to engage with the male threading of cartridge mount 412, among other connection options. The needle 366 extends into the needle bore 516 within valve shaft 522. The trigger 480 can be reattached to gun body 334 or repositioned relative to gun body 334 such that trigger 480 can engage with coupler 492.

In some examples, the manual spray gun 312 can include a valve lock such that the driving connection between the needle 366 and the actuator 24 is not formed on installation of spray control assembly 338; instead, the needle 366 is engaged by the actuator and disengaged from the actuator depending on the spray state of the spray gun 312. Installing the spray control assembly 338 can form a mechanical connection between the spray control assembly 338 and gun body 334 and align needle 366 for selective engagement with the actuator while not forming a connection between the needle 366 and the actuator.

Spray control assembly 338 can be dismounted from the spray gun 312 by shifting spray control assembly in second axial direction AD2. The user breaks the connection between cartridge mount 412 and gun body 334 (e.g., by unthreading cartridge mount 412 from gun body 334) and can then pull the spray control assembly 338 axially out of gun body 334.

Spray control assembly 338 provides significant advantages. Spray control assembly 338 is mountable and dismountable as a single module, reducing the number of parts that have to be aligned and installed to assemble spray gun 312 and thereby providing for easier inventorying for the user and simpler assembly and disassembly of spray gun 312. A single mechanical connection is made between spray control assembly 338 and spray gun 312 during installation. That single mechanical connection secures spray control assembly 338 to spray gun 312. A first spray control assembly 338 can be disconnected and removed by breaking the single mechanical connection and a second spray control assembly 338 can be inserted and connected by the single mechanical connection, reducing downtime and providing for more efficient spray operations.

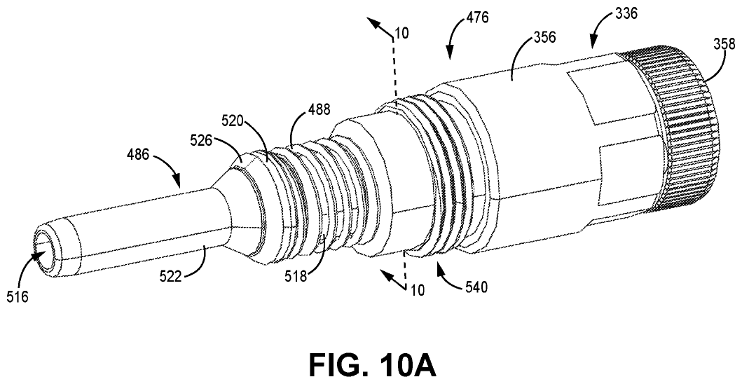

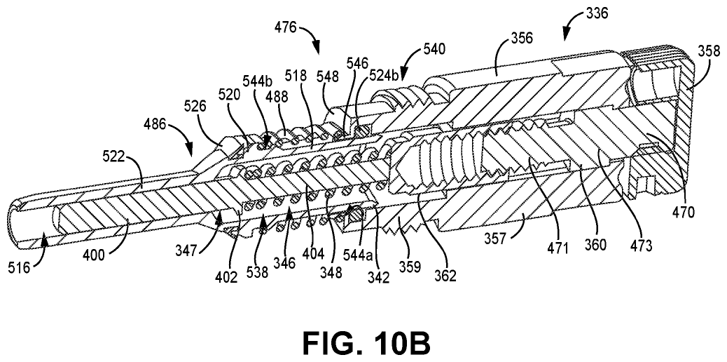

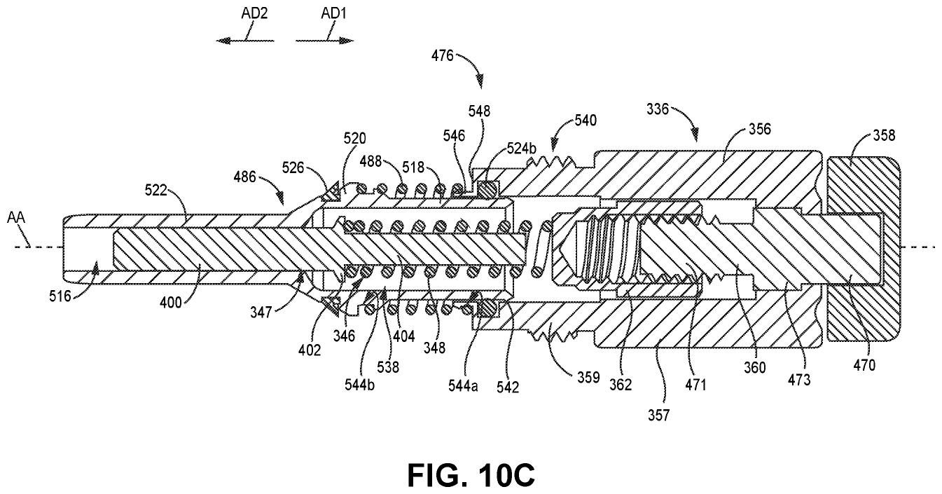

FIG. 10A is an isometric view of flow control assembly 476. FIG. 10B is an isometric cross-sectional view of flow control assembly 476 taken along line 10-10 in FIG. 10A. FIG. 10C is an elevational cross-sectional view of flow control assembly 476 taken along line 10-10 in FIG. 10A. FIGS. 10A-10C will be discussed together. Flow control assembly 476 includes displacement limiter 336, needle return 346, valve seal 486, and valve spring 488. Displacement limiter 336 includes limiter housing 356, knob 358, positioner 360, and stop 362. Needle return 346 includes return block 347 and return spring 348. Return block 347 includes return rod 400, return flange 402, and return body 404.

Flow control assembly 476 is configured to control flow of compressed air downstream through gun body 334 to air cap 392. Flow control assembly 476 is further configured to control flow of spray fluid out of spray gun 312. Flow control assembly 476 is a dry component that is not contacted by spray fluid during operation. Flow control assembly 476 controls flow of the spray fluid out of spray gun 312 by setting a maximum opening distance of the needle 366 relative to the seat 368, thereby setting a flow area through the spray valve 322. Flow control assembly 476 is elongate along assembly axis AA. Assembly axis AA can be disposed coaxially with cartridge axis CA with spray control assembly 338 and flow control assembly 476 both mounted to a spray gun 312.

Displacement limiter 336 forms a portion of flow control assembly 476. Displacement limiter 336 is mounted to gun body 334. Displacement limiter 336 is configured to mount to gun body 334 to fix flow control assembly 476 to gun body 334.

In the example shown, limiter housing 356 is configured to mount to gun body 334. Limiter housing 356 is disposed partially within gun body 334 and partially outside of gun body 334. Limiter bore 440 extends axially through limiter housing 356.

Positioner 360 is at least partially disposed within limiter housing 356. Stop 362 is mounted to positioner 360. Stop 362 is mounted on the positioner shaft 471 of positioner 360. In the example shown, positioner shaft 471 includes exterior threads that engage with interior threads formed on stop 362. Rotation of positioner 360 displaces stop 362 axially along cartridge axis RA. Stop 362 is keyed to limiter bore 440 to prevent rotation of stop 362 on assembly axis AA. The keyed interface causes axial displacement of stop 362 due to rotation of positioner 360. Positioner body 473 is disposed within limiter bore 440 and can include a circular exterior to facilitate rotation of positioner 360. Positioner head 470 extends out of limiter housing 356 and knob 358 is mounted to positioner head 470, such as by a fastener such as a set screw.

Stop 362 is configured to interface with return block 347 to limit a distance that return block 347 can displace in first axial direction AD1. Knob 358 is mounted on positioner 360. Knob 358 is disposed outside of limiter housing 356. Knob 358 is accessible by a user such that the user can manipulate knob 358 to adjust the axial position of stop 362 and thus set a maximum opening distance that needle 366 can shift along the cartridge axis CA. Knob 358 is connected to positioner 360 such that rotation of knob 358 causes rotation of positioner 360, thereby causing axial displacement of stop 362 along cartridge axis RA.

Needle return 346 is disposed at least partially within limiter housing 356 in the example shown. Needle return 346 is disposed coaxially with displacement limiter 336 in the example shown. Needle return 346 is configured to interface with needle 366 and bias needle 366 in second axial direction AD2 and into engagement with seat 368.

Return block 347 is movable along the assembly axis AA and relative to valve seal 486. Return block 347 is disposed at least partially within valve seal 486. Needle return 346 is independent of and not connected to valve seal 486 such that valve seal 486 and return block 347 can move relative to each other along cartridge axis CA.

Return rod 400 extends in second axial direction AD2 and is at least partially disposed in needle bore 516 of valve seal 486. Return rod 400 is configured to abut and engage with needle 366. Return rod 400 extends into needle bore 516 such that needle bore 516 and return rod 400 are disposed coaxially on assembly axis AA. The return rod 400 and valve shaft 522 interface and assist in maintaining concentricity between return block 347 and valve seal 486. Return flange 402 extends radially outward from an exterior of return block 347. Return flange 402 extends radially outward to have a larger diameter than needle bore 516. Return flange 402 provides a bearing surface for return spring 348 to engage with. Return body 404 forms a portion of return block 347 extending in first axial direction AD1 from return flange 402. Return body 404 is disposed within return spring 348 and can assist in aligning return spring 348 relative to return block 347. Return body 404 can be considered to form a spring guide. In the example shown, return rod 400 has a larger diameter than return body 404, though it is understood that not all examples are so limited.

Return spring 348 is disposed within an interior of flow control assembly 476. Return spring 348 is disposed radially within valve seal 486 and extends into limiter bore 440 in the example shown. Return spring 348 radially overlaps with limiter housing 356 and valve seal 486 in the example shown.

Return spring 348 extends between and engages with return block 347 and stop 362. In the example shown, return spring 348 engages with return flange 402 to bias return block 347 in second axial direction AD2. Return spring 348 is configured to bias needle 366 into engagement with seat 368 to place spray valve 322 in the closed state.

Valve seal 486 is elongate along cartridge axis CA. Valve seal 486 is hollow in the example shown such that a passage extends fully axially through valve seal 486. The passage is open in both the first axial direction AD1 into an interior of flow control assembly 476 and in second axial direction AD2 towards nozzle 328. The passage is formed as needle bore 516 and return bore 538. The needle bore 516 is defined by valve shaft 522. Return bore 538 is defined by seal body 518. In the example shown, return block 347 extends into but not through needle bore 516. In the example shown, return block 347 extends fully axially through return bore 538 during at least some phases of operation of spray gun 312.

Valve shaft 522 is elongate along assembly axis AA. Valve shaft 522 is formed as cylinder in the example shown, though it is understood that not all examples are so limited. Seal shoulder 520 extends between and connects valve shaft 522 and seal body 518. Seal shoulder 520 extends radially outward between valve shaft 522 and seal body 518. A diameter of valve seal 486 enlarges along seal shoulder 520 between valve shaft 522 and seal body 518. In the example shown, seal shoulder 520 is sloped between valve shaft 522 and seal body 518 such that seal shoulder 520 extends both axially and radially between valve shaft 522 and seal body 518.

Seal body 518 extends in first axial direction AD1 from seal shoulder 520. Seal body 518 extends from seal shoulder 520 and into limiter housing 356 in the example shown. Seal body 518 has a larger diameter than valve shaft 522 in the example shown. Seal body 518 is cylindrical in the example shown, though it is understood that not all examples are so limited.

Seal body 518 extends into limiter housing 356 and engages with air seal 524b. Air seal 524b engages with an exterior surface of seal body 518 to inhibit leakage of compressed air therebetween in first axial direction AD1. Air seal 524b is supported by limiter housing 356 in the example shown. Air seal 524b seals an interior of flow control assembly 476 and prevents compressed air from flowing into the interior of flow control assembly 476.

Flow seal 526 is supported by seal shoulder 520 in the example shown. Flow seal 526 is formed separately from valve seal 486 and mounted on valve seal 486. Flow seal 526 can be formed as an elastomer seal, among other options. Flow seal 526 is formed as a cup seal in the example shown, with the cup open in first axial direction AD1 such that compressed air upstream of flow seal 526 can energize flow seal 526 and facilitate engagement of flow seal 526 with air seat 514 to close air valve 490.

Valve spring 488 interfaces with valve seal 486 and biases valve seal 486 in second axial direction AD2. Valve spring 488 extends axially between limiter housing 356 and valve seal 486. In the example shown, seal body 518 of valve seal 486 is disposed radially within valve spring 488 and extends axially through valve spring 488.

Valve spring 488 is configured to bias air valve 490 to the closed state. Return spring 348 is configured to bias spray valve 322 to the closed state. Both valve spring 488 and return spring 348 are disposed within rear block 496 with flow control assembly 476 mounted to spray gun 312. Valve spring 488 and return spring 348 are both formed as dry components that are not exposed to the spray fluid flowing through spray gun 312. Valve spring 488 and return spring 348 are disposed coaxially on spray axis SA. Valve spring 488 and return spring 348 radially overlap with each other. Valve spring 488 is disposed radially outward of return spring 348.

The exterior of flow control assembly 476 includes a static portion that does not shift along cartridge axis CA during operation and a dynamic portion that does shift along assembly axis AA during operation. The dynamic portion shifts axially along assembly axis AA relative to the static portion such that an axial length of flow control assembly 476 varies during operation. The axial length of flow control assembly 476 is relatively shorter with spray gun 312 in a spray state and the axial length of flow control assembly 476 is relatively longer with spray gun in the non-spray state.

Limiter housing 356 forms the static exterior component of flow control assembly 476 and is configured to be fixed to gun body 334. Limiter mount 540 is formed on an exterior of limiter housing 356. In the example shown, limiter mount 540 is formed on mount body 359 of limiter housing 356. The mount body 359 is configured to extend into the gun bore 406 to be disposed within gun body 334. Support body 357 extends in second axial direction AD2 from mount body 359. Support body 357 can be disposed at least partially outside of the gun bore 406 in some examples.

Limiter mount 540 is configured to interface with a portion of gun body 334 to fix flow control assembly 476 to gun body 334. Limiter mount 540 is formed exterior threads on limiter housing 356 in the example shown. While limiter mount 540 is shown as exterior threads configured to interface with interior threads on gun body 334, it is understood that not all examples are so limited. For example, flow control assembly 476 can be configured to mount to gun body 334 by a bayonet style connection, in which example the limiter mount 540 can be formed as an array of slots or projections configured to interface with respective projections or slots of the gun body 334. In other examples, limiter mount 540 can be formed as a groove, similar to housing groove 268, that receives a fastener, such as a set screw, to fix flow control assembly 476 to spray gun 312.

Valve seal 486 forms the dynamic exterior component of flow control assembly 476. Valve seal 486 is supported by limiter housing 356. Valve seal 486 can be supported by air seal 524b such that valve seal 486 can be considered to ride on air seal 524b. Air seal 524b can support valve seal 486 in coaxial alignment on assembly axis AA. In the example shown, air seal 524b can support valve seal 486 such that valve seal 486 does not contact limiter housing 356. Air seal 524b can be formed as an energized o-ring seal. Air seal 524b can be formed as an elastomer seal.

Catch lip 542 is formed on valve seal 486. Catch lip 542 projects radially outward from the surface of seal body 518 that engages with air seal 524b. Catch lip 542 extends to axially overlap with air seal 524b. Catch lip 542 retains valve seal 486 connected to limiter housing 356 such that flow control assembly 476 is maintained as a single module. In the example shown, catch lip 542 is configured to catch on air seal 524b. The interface between catch lip 542 and air seal 524b holds valve seal 486 and prevents further displacement of valve seal 486 in second axial direction AD2.

Valve spring 488 is disposed on an exterior of flow control assembly 476 such that valve spring 488 is configured to be exposed to the airflow through spray gun 312. Valve spring 488 is disposed in retaining groove 544a. Retaining groove 544a is formed by a portion of limiter housing 356 in the example shown. Retaining groove 544a is formed on axial projection 546 of limiter housing 356. The axial projection 546 extends in second axal direction AD2 relative to a face 548 of limiter housing 356. Axial projection 546 can be formed as an annular projection about cartridge axis CA. Retaining groove 544a extends radially into axial projection 546 and is disposed on an outer radial side of the axial projection 546. One end of valve spring 488 can be disposed within the retaining groove 544a such that a lip of axial projection 546 axially overlaps with that end of valve spring 488.

Valve spring 488 is disposed in retaining groove 544b. Retaining groove 544b is formed by a portion of valve seal 486 in the example shown. Retaining groove 544b extends radially into the exterior of valve seal 486 and is disposed on an outer radial side of the valve seal 486. Retaining groove 544 extends into a surface of seal shoulder 520 formed on the exterior of valve seal 486 and oriented in first axial direction AD1. One end of valve spring 488 can be disposed within the retaining groove 544b such that a lip defining the retaining groove 544b axially overlaps with that end of valve spring 488.

The valve spring 488 forms a connector that retains valve seal 486 connected to limiter housing 356 while also biasing valve seal 486 away from limiter housing 356. Valve spring 488 is disposed in both retaining groove 544a and retaining groove 544b. The walls of retaining groove 544a prevent valve spring 488 from shifting in second axial direction AD2 and off of limiter housing 356. The walls of retaining groove 544b prevent valve seal 486 from shifting in second axial direction AD2 and off of valve seal 486. Valve spring 488 connects valve seal 486 to limiter housing 356 such that flow control assembly 476 is formed as a single module that is mountable and dismountable as a single part.

In the example shown, flow control assembly 476 is connected to limiter housing 356 by dual retainers to maintain flow control assembly 476 as a single module. The valve spring 488 and the catch lip 542 form the retainers that hold the valve seal 486 to the limiter housing 356. Retaining valve seal 486 in connection with limiter housing 356 reduces the number of parts and provides for simplified installation and removal of flow control assembly 476.

Flow control assembly 476 provides significant advantages. Flow control assembly 476 is mountable and dismountable as a single module. The single module reduces parts, providing for simpler assembly and disassembly, reducing inventory for a user, and decreasing downtime. Flow control assembly 476 is configured to actuate both the air valve 490 and the spray valve 322 to respective closed states. The flow control assembly 476 is a dry component that actuates the wet spray valve 322 to the closed state. The flow control assembly 476 further sets the possible displacement distance of the needle retaining groove 544, thereby setting the maximum flow area of the spray valve 322. The flow control assembly 476 actuating the spray valve 322 closed, controlling flow of air through air valve 490, and setting an opening size of spray valve 322 provides for a simpler, more compact arrangement that utilizes less parts to both control flow of spray fluid and air and control the volumetric flow through spray valve 322.

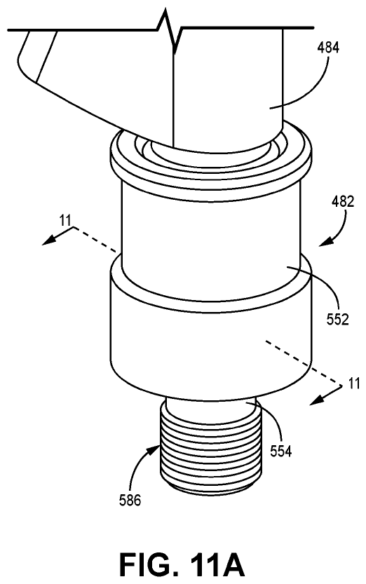

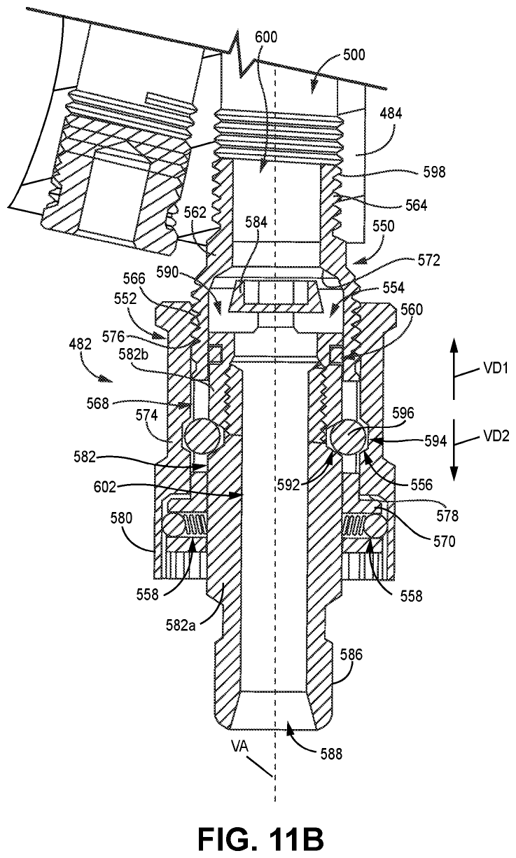

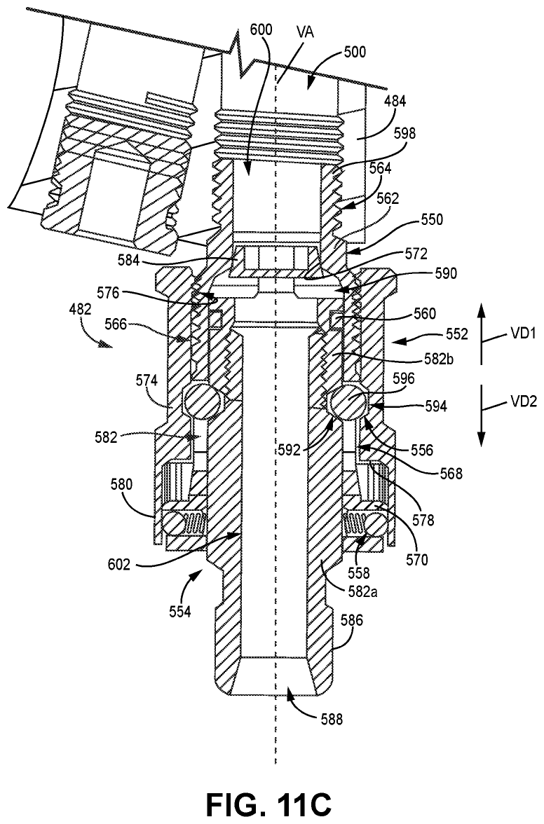

FIG. 11A is an isometric view showing a metering valve 482 mounted to a spray gun 312. FIG. 11B is a cross-sectional view taken along line 11-11 in FIG. 11A showing metering valve 482 in an open state. FIG. 11C is a cross-sectional view taken along line 11-11 in FIG. 11A showing metering valve 482 in a closed state. Metering valve 482 includes meter mount 550, meter sleeve 552, meter piston 554, bearing 556, meter detents 558, and meter seal 560. Meter mount 550 includes mount body 562, gun connector 564, sleeve connector 566, bearing passage 568, retaining flange 570, and meter seat 572. Meter sleeve 552 includes sleeve body 574, mount connector 576, sleeve shoulder 578, and sleeve collar 580. Meter piston 554 includes meter piston body 582, seal head 584, hose connector 586, inlet port 588, and outlet ports 590. Bearing 556 includes inner race 592, outer race 594, and balls 596.

Metering valve 482 is configured to control flow of compressed gas to spray gun 312. Metering valve 482 is actuatable between an open state, in which seal head 584 is spaced from meter seat 572 to open a flowpath through metering valve 482, and a closed state, in which seal head 584 is engaged with meter seat 572 to close the flowpath through metering valve 482. Metering valve 482 is elongate along valve axis VA. First valve direction VD1 is a first axial direction along valve axis VA and second valve direction VD2 is a second axial direction along valve axis VA that is opposite to first valve direction VD1.

Meter mount 550 is connectable to the spray gun 312 to mount metering valve 482 to the spray gun 312. Meter mount 550 is connected to the handle 484 of the spray gun 312 in the example shown. Gun connector 564 is configured to interface with spray gun 312 to connect meter mount 550 to spray gun 312. In the example shown, gun connector 564 is formed as exterior threading on the meter mount 550 that is configured to interface with interior threads formed on the spray gun 312. Meter mount 550 is at least partially disposed within handle 484 with metering valve 482 mounted to spray gun 312. Gun connector 564 is formed at a mount end 598 of meter mount. The mount end 598 is a first axial end of meter mount 550.

Supply port 600 is formed through meter mount 550. Supply port 600 is an aperture through which the compressed gas exits from metering valve 482 and enters into spray gun 312. The supply port 600 is disposed at mount end 598 of meter mount 550. The supply port 600 is spaced axially from the meter piston 554 and meter sleeve 552. The supply port 600 is disposed within the spray gun 312. In the example shown, the supply port 600 is disposed within the handle 484 of the spray gun 312. The supply port 600 is oriented to output the compressed gas axially along the valve axis VA.

Sleeve connector 566 is configured to interface with meter sleeve 552 to mount meter sleeve 552 to meter mount 550. In the example shown, sleeve connector 566 is formed as exterior threading and mount connector 576 is formed as interior threading such that meter sleeve 552 is threadedly connected to meter mount 550.

Bearing passages 568 are axial slots through mount body 562. Bearing passages 568 are axially elongate. Bearing passages 568 are configured to allow bearing 556 to shift axially along valve axis VA and relative to meter mount 550. Bearing passages 568 can be formed in an annular array with ligaments interspersed with the bearing passages 568. At least one ball 596 of the bearing 556 can be disposed within each bearing passage 568. The balls 596 can traverse axially within the bearing passages 568 while still allowing relative rotational movement of meter piston 554 relative to meter sleeve 552 and meter mount 550.

Retaining flange 570 is disposed at an opposite axial end of mount body 562 from gun connector 564. Retaining flange 570 is disposed at a second axial end of mount body 562 opposite the mount end 598. Retaining flange 570 extends radially outward relative to other portions of meter mount 550. Retaining flange 570 is spaced in second valve direction VD2 from bearing passages 568. Retaining flange 570 axially overlaps with a portion of meter sleeve 552. Retaining flange 570 is configured to prevent meter sleeve 552 from passing off of meter mount 550 in second valve direction VD2.

Meter seat 572 is formed by meter mount 550 in the example shown. Meter seat 572 is formed on a radially inner surface of meter mount 550. In the example shown, meter seat 572 is formed by the radially inner surface of meter mount 550. The diameter of the passage through meter mount 550 increases in second valve direction VD2 along meter seat 572.

Meter detents 558 are disposed in bores that extend within meter mount 550. The meter detents 558 are disposed at an opposite axial end of meter mount 550 from gun connector 564, in the example shown. The meter detents 558 are mounted within the retaining flange 570 in the example shown. In the example shown, meter detents 558 are formed as spring-biased detents that are biased radially outwards and into engagement with meter sleeve 552. The spring of each meter detent 558 biases the ball of each meter detent 558 radially outward. While meter detents 558 are shown as including balls, it is understood that other configurations are possible.

In the example shown, meter detents 558 are disposed in bores that extend radially within retaining flange 570. In some examples, the bores that the meter detents 558 are disposed within can extend fully radially through the meter mount 550 such that openings are formed on the outer radial side of meter mount 550 and on the inner radial side of meter mount 550. In such an example, the springs of the meter detents 558 can ride on the outer surface of meter piston 554. In some examples, the bores that the meter detents 558 are disposed within extend only partially through the meter mount 550 such that the bores include a single opening on the outer radial side of meter mount 550. In such an example, the springs of the meter detents 558 do not ride on the meter piston 554.

Meter sleeve 552 is mounted to meter mount 550. Meter sleeve 552 includes mount connector 576 formed at one axial end of the meter sleeve 552. Mount connector 576 is configured to interface with meter mount 550 to connect meter sleeve 552 to meter mount 550. In the example shown, the mount connector 576 is formed as interior threading. The mount connector 576 forms a threaded interface with sleeve connector 566 of meter mount 550 in the example shown.

Meter sleeve 552 is mounted to meter mount 550 such that meter sleeve 552 can shift axially relative to meter mount 550. In the example shown, meter sleeve 552 displaces axially relative to meter mount 550 by rotation of meter sleeve 552 on valve axis VA relative to meter mount 550. The meter sleeve 552 can be rotated in a first rotational direction (e.g., one of clockwise and counterclockwise) to open the gap between seal head 584 and meter seat 572 and meter sleeve 552 can be rotated in a second opposite rotational direction (e.g., the other one of clockwise and counterclockwise) to close the gap between seal head 584 and meter seat 572.

Sleeve shoulder 578 is formed at an opposite axial end of sleeve body 574 from mount connector 576. Sleeve shoulder 578 extends radially outward from an inner radial side of sleeve body 574. Sleeve shoulder 578 forms an axially oriented surface of meter sleeve 552. The surface of sleeve shoulder 578 is oriented in second valve direction VD2. Sleeve shoulder 578 extends to axially overlap with retaining flange 570. Sleeve shoulder 578 axially overlaps with retaining flange 570 such that sleeve shoulder 578 cannot pass over retaining flange 570 in second valve direction VD2. The interface between sleeve shoulder 578 and retaining flange 570 prevents meter sleeve 552 from shifting off of meter mount 550 in second valve direction VD2.

Sleeve collar 580 extends in second valve direction VD2 from sleeve shoulder 578. Sleeve collar 580 radially overlaps with meter detents 558. Meter detents 558 are spring biased to engage with an inner radial surface of sleeve collar 580. In the example shown, the inner radial surface of sleeve collar 580 is textured such that the sleeve collar 580 pushes the balls of meter detents 558 radially inward and then the springs of meter detents 558 push the balls back radially outwards during rotation of meter sleeve 552 relative to meter mount 550. For example, the inner radial surface can include a circumferential array of interspersed ridges and grooves such that the ridges push the meter detents 558 inwards and then the meter detents 558 snap back into the grooves. The textured surface of the sleeve collar 580 interfacing with the meter detents 558 provides feedback to the user regarding rotation of meter sleeve 552 and thus displacement of meter piston 554. For example, the meter detents 558 springing radially outward can cause an audible clicking sound to provide audio feedback to the user, the meter detents 558 springing radially outward can cause vibration to provide haptic feedback to the user, etc. While metering valve 482 is described as including meter detents 558 and sleeve collar 580, it is understood that not all examples are so limited. Some examples of metering valve 482 may not include meter detents 558 or an associated sleeve collar 580.

Meter piston 554 is at least partially disposed within meter mount 550. Meter piston 554 is disposed at least partially within sleeve collar 580. Meter piston 554 extends fully axially through meter sleeve 552 in the example shown. Meter piston 554 is engaged with meter seat 572 with metering valve 482 in the closed state and meter piston 554 is disengaged from meter seat 572 with metering valve 482 in the open state.

Meter piston body 582 is elongate along valve axis VA. In the example shown, meter piston body 582 is formed from piston body 582a mounted to piston body 582b. Piston body 582a is mounted to piston body 582b by a threaded interface in the example shown, though it is understood that not all examples are so limited. For example, meter piston body 582 can be formed as a unitary component. Meter piston body 582 can be formed as a monolithic component. In the example shown, piston body 582a extends into piston body 582b to mount to piston body 582b. The inner race 592 of bearing 556 is formed at the interface between piston body 582a and piston body 582b in the example shown.

Seal head 584 is disposed at a first axial end of meter piston 554. Seal head 584 is configured to engage with meter seat 572 to place metering valve 482 in the closed state. Seal head 584 includes a sloped exterior surface that is configured to engage with meter seat 572. In the example shown, a portion of seal head 584 projects in first valve direction VD1 relative to meter seat 572 with metering valve 482 in the closed state.

Outlet ports 590 extent through meter piston 554 between an exterior surface of meter piston 554 and the piston passage 602 through meter piston 554. The outlet ports 590 direct the compressed gas radially outwards. The outlet ports 590 provides openings for compressed gas to exit from piston passage 602 through meter piston 554. Outlet ports 590 are disposed axially between seal head 584 and meter seal 560.

Meter seal 560 is mounted on meter piston 554. Meter seal 560 is disposed in a seal groove formed on the exterior of meter piston 554. Meter seal 560 is configured to engage with the exterior of meter piston 554 and with an interior surface of meter mount 550. Meter seal 560 forms a fluid tight seal between meter piston 554 and meter mount 550 such that compressed gas is prevented from leaking in second valve direction VD2 between meter piston 554 and meter mount 550. Meter seal 560 is mounted on meter piston 554 such that meter seal 560 travels along valve axis VA with meter piston 554. Meter seal 560 can be considered to form a dynamic seal that statically engages with meter piston 554 and dynamically engages with meter mount 550.

Hose connector 586 is disposed at a second axial end of meter piston 554 opposite from seal head 584. Hose connector 586 is configured to interface with a fitting of a air hose (e.g., air hose 32 (FIG. 1)) that supplies compressed gas to spray gun 312. In the example shown, hose connector 586 includes exterior threading configured to form a threaded connection with the fitting of the air hose.

Inlet port 588 is formed through the axial end of meter piston 554 opposite seal head 584. Inlet port 588 is formed through hose connector 586. Inlet port 588 provides an opening through which compressed air can enter into piston passage 602. Inlet port 588 is oriented axially such that the compressed gas flows axially along valve axis VA into piston passage 602. In the example shown, meter piston 554 includes a single inlet port 588 and multiple outlet ports 590. In the example shown, meter piston 554 receives an axial flow of compressed air and outputs multiple radial flows of compressed.

Bearing 556 supports meter piston 554 within metering valve 482. Bearing 556 supports meter piston 554 on meter sleeve 552. Inner race 592 is formed by an annular groove on the exterior of meter piston 554. Outer race 594 is formed by an annular groove on the interior of meter sleeve 552. Balls 596 are partially disposed in the inner race 592 and outer race 594. Bearing 556 includes an annular array of balls 596 disposed about the valve axis VA. The bearing 556 is spaced in second valve direction VD2 from meter seal 560. The bearing 556 is disposed axially between inlet port 588 and outlet ports 590.

Bearing 556 is configured to displace meter piston 554 axially along valve axis VA. Bearing 556 is configured to displace meter piston 554 in first valve direction VD1 and into engagement with meter seat 572 to place metering valve 482 in the closed state, and bearing 556 is configured to displace meter piston 554 in second valve direction VD2 to disengage meter piston 554 from meter seat 572 and place metering valve 482 in the open state.

Bearing 556 further rotatably supports meter piston 554 on valve axis VA. Meter piston 554 can rotate on valve axis VA relative to meter sleeve 552 and relative to meter mount 550. Bearing 556 rotatably supporting meter piston 554 allows meter piston 554 to freely swivel on valve axis VA. Meter piston 554 is not connected to meter sleeve 552 except via bearing 556. Meter piston 554 being able to rotate on valve axis VA facilitates easy and efficient operation of the spray gun 312. The user can turn and pivot the spray gun 312 during spraying and the meter piston 554 will rotate on valve axis VA which allows the air hose connected to hose connector 586 to remain in a desired position as spray gun 312 is pivoted. The user does not have to be concerned about the air hose kinking or manipulating the air hose. The meter sleeve 552 maintains the meter piston 554 at a desired location along the valve axis VA while the meter piston 554 rotates on valve axis VA. As such, rotation of the meter piston 554 does not axially displace the meter piston 554.

Bearing 556 is configured to hold meter piston 554 at a location along valve axis VA while allowing meter piston 554 to swivel on valve axis VA. Bearing 556 fixes meter piston 554 relative meter sleeve 552 along valve axis VA.

Balls 596 extend between and are at least partially disposed within inner race 592 and outer race 594. Rotating meter sleeve 552 causes axial displacement of meter sleeve 552 along valve axis VA due to the threaded interface between meter sleeve 552 and meter mount 550. The meter sleeve 552 exerts an axial force on balls 596 at the interface between balls 596 and outer race 594. The balls 596 exert an axial force on meter piston 554 at the interface between balls 596 and inner race 592.

During operation, metering valve 482 is actuatable between the open and closed states. Metering valve 482 is assumed to initially be in the closed state (FIG. 11C) with seal head 584 engaging meter seat 572 for purposes of the example discussed. The air hose is mounted to meter piston 554 at hose connector 586. Metering valve 482 is actuated to the open state to allow the compressed air to flow into spray gun 312.

To actuate metering valve 482 to the open state, meter sleeve 552 is rotated in a first rotational direction about the valve axis VA (e.g., one of clockwise or counterclockwise). Rotating the meter sleeve 552 in the first rotational direction causes the threaded interface between meter sleeve 552 and meter mount 550 to displace meter sleeve 552 in second valve direction VD2. The meter sleeve 552 displacing in second valve direction VD2 exerts an axial force on balls 596 in second valve direction VD2 to displace balls 596 in second valve direction VD2. The balls 596 exert an axial force on meter piston 554 to displace meter piston 554 in second valve direction VD2. The meter piston 554 displaces along valve axis VA such that seal head 584 disengages from meter seat 572 and a flowpath is opened therebetween.

Meter sleeve 552 can displace in second valve direction VD2 until shoulder 578 encounters retaining flange 570. Retaining flange 570 engaging with shoulder 578 inhibits further displacement of meter sleeve 552, and thus of meter piston 554, in second valve direction VD2. Metering valve 482 is thus in the fully open state (FIG. 11B).

The compressed air enters into metering valve 482 through inlet port 588 in meter piston 554, flows through piston passage 602 of meter piston 554 and exits from meter piston 554 through outlet ports 590. The compressed air exits from meter piston 554 and into meter mount 550 at a location axially between meter seat 572 and meter seal 560. The compressed air continues in first valve direction VD1 and exits from metering valve 482 and into spray gun 312 through supply port 600 in meter mount 550. In the example shown, the compressed gas enters metering valve 482 as an axial flow through inlet port 588, is directed radially outwards from meter piston 554 through outlet ports 590 and then continues downstream and exits from metering valve 482 as an axial flow through supply port 600.

Metering valve 482 can be actuated back to the closed state to shut off the supply of compressed air to spray gun 312. To actuate metering valve 482 to the closed state the meter sleeve 552 is rotated in a second rotational direction opposite the first rotational direction (e.g., the other of clockwise and counterclockwise). Rotating meter sleeve 552 in the second rotational direction displaces meter sleeve 552 in first valve direction VD1 due to the threaded interface between meter sleeve 552 and meter mount 550. The meter sleeve 552 displacing in first valve direction VD1 exerts an axial force on balls 596 in first valve direction VD1 to displace balls 596 in first valve direction VD1. The balls 596 exert an axial force on meter piston 554 to displace meter piston 554 in first valve direction VD1. The meter piston 554 displaces along valve axis VA until seal head 584 engages with meter seat 572 and seals the flowpath through metering valve 482, thereby preventing compressed air flow into spray gun 312. Seal head 584 engaging with meter seat 572 limits displacement of meter piston 554 in first valve direction VD1 in the example shown.

Metering valve 482 is actuated between the open and closed states by the user. The metering valve 482 is not a check valve that is actuated by compressed air flow through the metering valve 482. Instead, the metering valve 482 remains in the desired state as set by the user until actuated from that state by the user. Metering valve 482 remains in the open state or in the closed state until actuated to the other state by the user.

Metering valve 482 provides significant advantages. Typical air spray guns include a fitting that connects to the air supply hose and an internal valve that controls flow of the compressed air. Metering valve 482 provides a single point that connects with the air hose and that can shut off or turn on flow of the compressed air to the spray gun 312. Metering valve 482 thereby provides for simply, efficient control of the flow of compressed gas. During operation, the flow of compressed air is turned off to allow bleeding of spray fluid from the spray gun 312. The user can simply and easily rotate meter sleeve 552 to actuate metering valve 482 to the closed state.

Metering valve 482 provides a mounting location for the air hose and also controls flow of the compressed air into the spray gun 312. The air hose mounts directly to meter piston 554. Meter piston 554 also forms the movable valving component of metering valve 482. Bearing 556 supports meter piston 554 such that meter piston 554, and thus the air hose, can freely pivot on valve axis VA during operation. Rotation of the meter piston 554 is independent of the state of the metering valve 482. The meter piston 554 rotating on the valve axis VA does not actuate the metering valve 482 between the open and closed states. Bearing 556 rotatably supporting meter piston 554 allows the user to freely manipulate and aim the spray gun 312 without having to reposition the air hose to avoid kinking or tangling, facilitating more efficient and easier spray operations.

In addition to rotatably supporting meter piston 554, the bearing 556 exerts the axial driving force on meter piston 554 to displace meter piston 554 along valve axis VA. The bearing 556 both rotatably supporting meter piston 554 and axially displacing meter piston 554 provides for a compact, easy to use metering valve 482.

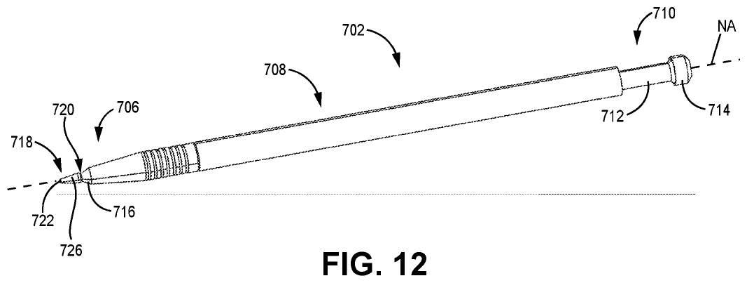

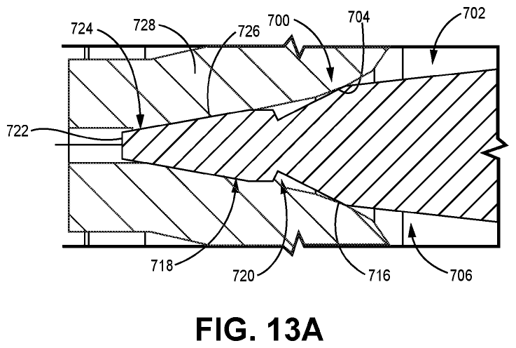

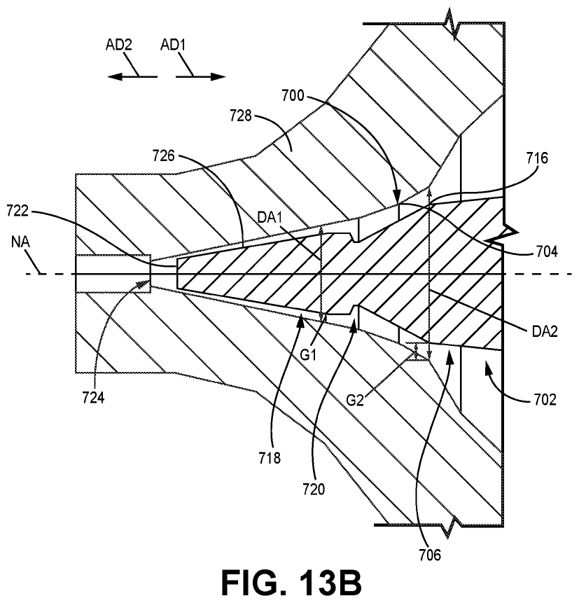

FIG. 12 is an isometric view of needle 702 for a spray valve. FIG. 13A is a cross-sectional view showing a spray valve 700 in a closed state. FIG. 13B is a cross-sectional view showing the spray valve 700 in an open state. FIGS. 12-13B are discussed together. Spray valve 700 is formed at the interface between needle 702 and seat 704. Needle 702 includes needle tip 706, needle body 708, needle neck 712, and needle tail 710. Needle tail 710 includes needle neck 712 and needle head 714. Needle tip 706 includes seal region 716 and wear head 718. Needle 702 can be used as needle 166 in spray gun 112. Needle 702 can be used as needle 366 in spray gun 312. Needle 702 can be used a needle of a spray valve in automatic spray gun applications and/or manual spray gun operations.

Needle 702 is elongate along needle axis NA. The needle axis NA is disposed coaxially with the spray axis SA with needle mounted on a spray gun. Needle tip 706 is disposed at a first axial end of needle 702 and needle tail 710 is disposed at a second axial end of needle 702. Needle body 708 is elongate along needle axis NA. Needle body 708 extends between needle tip 706 and needle tail 710. In the example shown, needle tail 710 includes needle neck 712 and needle head 714 to facilitate engagement with a valve lock, such as valve lock 144 (best seen in FIGS. 5A and 5B). It is understood, however, that not all examples are so limited. The needle tail 710 can be of any desired configuration for connecting to an actuator that displaces the needle 702 axially relative to the seat of the spray valve 700. For example, needle tail 710 can include threads configured to engage with a nut that fixes the needle 702 to the actuator, among other connection options.

Needle tip 706 is the downstream portion of needle 702. Needle tip 706 is engaged with seat 704 with the spray valve 700 in the closed state and needle tip 706 is disengaged from the seat 704 with spray valve 700 in the open state. Seal region 716 is the portion of needle tip 706 configured to directly engage with seat 704 with spray valve 700 in the closed state. Needle tip 706 can be formed monolithically with needle body 708 or can be formed separately from needle body 708 and assembled to needle body 708. For example, needle tip 706 can be configured to connect to needle body 708 by a threaded interface.

Wear head 718 is formed on needle tip 706. Wear head 718 extends annularly about needle axis NA. Wear head 718 is formed as a radial enlargement on needle tip 706. In the example shown, wear head 718 is formed as an annular ring extending fully about the needle axis NA, though it is understood that not all examples are so limited. Wear head 718 projects radially outward relative to portions of needle tip 706 immediately upstream of wear head 718. Trench 720 is formed axially between wear head 718 and seal region 716. Wear head 718 projects radially outward relative to trench 720. In the example shown, wear head 718 is disposed downstream of seal region 716 and spaced in second axial direction AD2 from seal region 716. Wear head 718 is disposed axially between seal region 716 and distal end 722 of needle tip 706. Wear head 718 is disposed downstream of the interface between seal region 716 and seat 704. It is understood, however, that not all examples are so limited. In some examples, needle 702 includes a wear head 718 disposed upstream of seal region 716. In some examples, needle 702 includes a first wear head 718 upstream of seal region 716 and a second wear head 718 downstream of seal region 716.

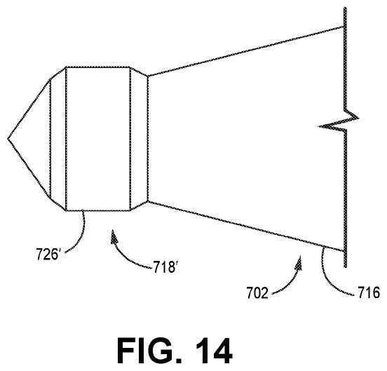

Wear head 718 includes wear surface 726 on the outer radial side of wear head 718. The restricted flowpath is formed radially between wear surface 726 and the inner radial surface of nozzle body 728. Nozzle body 728 defines nozzle 724. Seat 704 is formed by nozzle body 728 in the example shown. Wear surface 726 is a sloped surface in the example shown. Wear surface 726 extends radially inward as wear surface 726 extends in second axial direction AD2 in the example shown. It is understood, however, that not all examples are so limited. For example, the needle 702 shown in FIG. 14 includes a wear head 718′ that has an axially extending wear surface 726′. The wear surface 726′ is not sloped and instead extends parallel to the needle axis NA.

Needle 702 is configured to shift axially relative to seat 704 to actuate the spray valve 700 between open and closed states. The interface between seal region 716 and seat 704 controls flow of the spray fluid through spray valve 700. To initiate spraying, the needle 702 is displaced in first axial direction AD1. Seal region 716 disengages from seat 704 and a flowpath is opened therebetween. The spray fluid flows through the gap opened between seal region 716 and seat 704 and downstream in second axial direction AD2. The spray fluid flows over wear head 718 and through the gap formed around the exterior of wear head 718. The wear head 718 constricts the flowpath of the spray fluid at a location spaced axially from the seal region 716. As best seen in FIG. 13B, the flow area around needle 702 is smaller at locations radially overlapping with wear head 718 than at locations radially overlapping with seal region 716. The constricted flowpath forms the region of highest fluid velocity, which is also the region that experiences the greatest wear due to the high velocity spray fluid flowing over the surfaces defining the constricted flowpath.

As shown in FIG. 13B, the diameter DA1 of the flowpath at locations radially overlapping with wear head 718 is smaller than the diameter DA2 of the spray fluid flowpath at locations radially overlapping with seal region 716 as the needle 702 transitions towards the fully open state. The gap G1 between wear head 718 and nozzle body 728 is smaller than the gap G2 between seal region 716 and nozzle body 728. The larger diameter DA2 provides a greater flow area than the smaller diameter DA1 even if the gaps G1 and G2 were the same size. In the example shown, the gap G2 is greater than the gap G1, further restricting the flowpath radially around wear head 718 such that that portion of the flowpath experiences greater velocities, and thus portions of the needle 702 in that area of the flowpath experience greater wear, than the lower velocity portion radially overlapping with seal region 716. Wear head 718 thereby protects seal region 716 from wear, providing for a longer operating life of needle 702.

The spray fluid can include particulate that wears on the surfaces of needle 702. The particulate can cause gouging, scoring, or other damage to the exterior surface of needle 702. Such damage occurring in the seal region 716 compromises the sealing integrity of needle 702 such that the spray fluid can leak between seal region 716 and seat 704 with the spray valve 700 in the closed state. The wear head 718 shifts the region of needle 702 that experiences wear due to the high flow velocities axially relative to seal region 716. Wear head 718 does not form a sealing surface of needle 702. Wear head 718 is spaced axially from seal region 716 and does not engage with seat 704 during operation. The wear head 718 being the component of needle 702 that defines the smallest flow area and thus experiences the greatest wear protects the sealing integrity of needle 702. The wear head 718, not the seal region 716, defines the smallest flow area for the spray fluid upstream of the orifice through which spray fluid is emitted from nozzle 724. The wear head 718 is not a sealing component and thus the wear head 718 experiencing wear does not affect the seal integrity between needle 702 and seat 704.

Needle 702 provides significant advantages. Wear head 718 is spaced axially from seal region 716. Wear head 718 defines the smallest flow area through spray valve 700 as spray valve 700 actuates from the closed state to the open state. The smallest flow area is the region that experiences the greatest fluid velocity and thus the greatest wear. The wear head 718 is not a sealing component and does not form a fluid seal. As such, the wear head 718 experiencing the wear does not affect the integrity of the seal formed between seal region 716 and seat 704. The wear head 718 shifting the region of highest velocity axially relative to seal region 716 protects seal region 716 from such wear, increasing the operational life of needle 702, decreasing costs, and providing for more efficient spray operations with less downtime.

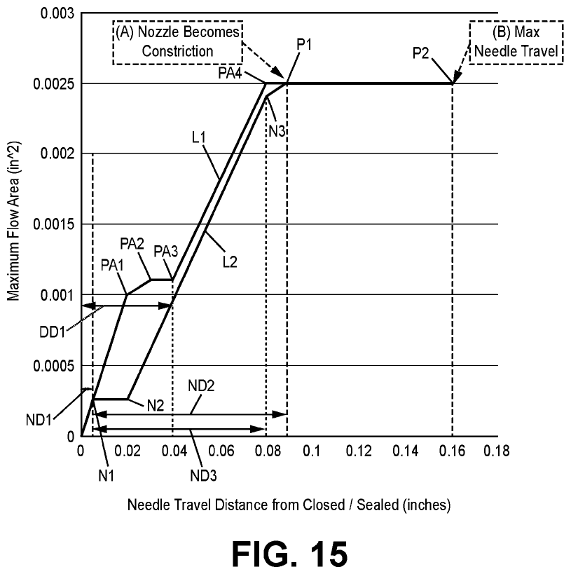

FIG. 15 is a graph illustrating the flow area through spray valve 700 for needle 702 including wear head 718 versus a prior art needle that does not include a wear head. The Y-axis is the size of the flow area through the spray valve 700, as measured in square inches. The X-axis is the distance that the needle has traveled from the closed position in which the seal region 716 is engaged with the seat 704 of the spray valve 700, measured in inches of linear travel. Line L1 indicates flow area vs. travel distance for needle 702. Line L2 indicates flow area vs. travel distance for the prior art needle that does not include a wear head.

The flow area for the needle 702 generally increases until the size of the nozzle defines the flow area, which is reached at point P1. At point P1, the flow area is defined by the nozzle 724 through which the spray fluid is output rather than by a gap radially between the needle 702 and the nozzle body. The flow area for the prior art needle increases to points PA4, where the nozzle defines the flow area. As shown, the flow area remains steady for line L1 (representing a prior art needle) from point PA4 to point P2. As shown, the flow area remains steady for lines L1 from point P1 to point P2. Point P2 is the maximum needle travel distance relative to seat 704. The wear head 718 protects the seal region 716 from experiencing wear as the needle 702 is actuated from the closed state.

For the prior art needle, the flow area generally increases linearly to point PA1 and then has a decreased rate of change to point PA2. The flow area remains steady between points PA2 and PA3. The flow area again increases at a generally steady rate from point PA2 to the maximum flow area at point PA4. For the prior art needle, the sealing region defines the constriction between the origin and point PA3. Portions of the needle downstream of the sealing region (e.g., a conical tip) define the flow area between points PA3 and PA4. The seal region of the prior art needle defines the constriction for displacement distance DD1.

For needle 702, the flow area generally increases to point N1 and then remains steady for additional displacement of needle 702 to point N2. The sealing region 716 defines the constriction between the origin and point N1. The needle displacement distance from the origin to point N1 is associated with initially cracking the spray valve 700 to an open state. In the example shown, the point N1 occurs at about 0.005 inches (about 0.0127 millimeters) of needle displacement. The wear head 718 defines the constriction between points N1 and N2. In the example shown, point N2 is associated with the needle 702 being displaced about 0.02 inches (about 0.0508 millimeters). The flow area then increases generally linearly between point N2 and point N3. Point N3 occurs before needle is in the fully open state at point P1. The displacement distance along X-axis between points N3 and P1 is less than the displacement distance along X-axis between points N2 and N3. The wear head 718 defines the constriction between points N2 and N3. The flow area increases linearly between points N3 and P1 but at a slower rate than the linear increase between points N2 and N3. A portion of the needle 702 downstream of the wear head 718 (e.g., extending axially between wear head 718 and distal end 722) defines the constriction between points N3 and P1. There is no concern about wear occurring on the wear head 718 and the portion downstream of the wear head 718 as those components do not form fluid seals.

The flow profile of needle 702 facilitates predictable feathering of the flow of spray fluid emitted through nozzle 724. Feathering occurs when needle 702 is displaced a distance less than to the fully open state, resulting in restricted fluid flow through nozzle 724, allowing the user to perform light spraying such as for touching up or delicate spray. The predictable change in the size of the flow area provided by needle 702 (indicated by slope of line L2 between points N2 and N3) facilitates feathering to provide high quality spray finishes. The steady rate of change of the flow area provided by needle 702 provides confidence for the user to feather the spray and provide fine finishes.

The seal region 716 of the needle 702 defines the constriction for a needle displacement distance of ND1. The seal region 716 does not define the constriction, and is thereby protected from undesirable wear, for all displacement beyond the needle displacement distance ND1. Portions of needle 702 other than the seal region 716 define the constriction for needle displacement distance ND2. The wear head 718 defines the constriction for needle displacement distance ND3. Needle displacement distances ND2 and ND3 are greater than needle displacement distance ND1. In the example shown, needle displacement distance ND1 plus needle displacement distance ND2 constitutes the full displacement distance of needle 702 until the nozzle forms the constriction. The needle displacement distance ND2 can be at least three times as large as needle displacement distance ND1. The needle displacement distance ND2 can be at least five times as large as needle displacement distance ND1. The needle displacement distance ND2 can be at least ten times as large as needle displacement distance ND1. The needle displacement distance ND2 can be at least fifteen times as large as needle displacement distance ND1. The needle displacement distance ND2 being significantly larger than the needle displacement distance ND1 protects seal region 716 by portions of the needle 702 downstream of the seal region 716 defining the constriction. The portion of the needle 702 defining the constriction is subjected to the greatest amount of wear such that shifting the portion of needle 702 defining the constriction downstream of seal region 716 protects seal region 716.

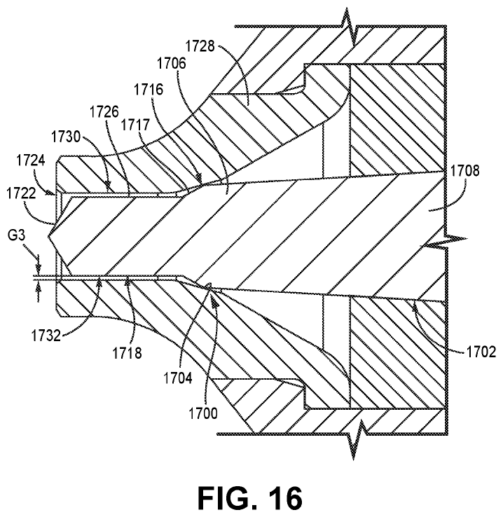

FIG. 16 is an enlarged cross-sectional view showing a spray valve 1700 in a closed state. Spray valve 1700 is formed by needle 1702 and seat 1704. Needle tip 1706 and needle body 1708 of needle 1702 are shown. Needle tip 1706 includes seal region 1716, shoulder 1717, and wear head 1718. Needle 1702 can be used as needle 166 in spray gun 112. Needle 1702 can be used as needle 366 in spray gun 312. Needle 1702 can be used a needle of a spray valve in automatic spray gun applications and/or manual spray gun operations. Needle 1702 is substantively similar to needle 702 (FIGS. 12-14) and is configured to define a smallest flow area at locations downstream of the seal region 1716. Components of spray valve 1700 similar to spray valve 700 are described with the same reference number but increased by “1000” (e.g., needle 1702 and needle 1702).

Needle 1702 is elongate along a needle axis NA. The needle axis NA is disposed coaxially with the spray axis SA with needle mounted on a spray gun, though it is understood that not all examples are so limited. Needle tip 1706 is disposed at a first axial end of needle 1702. Needle body 1708 is elongate along needle axis NA.

Needle tip 1706 is the downstream portion of needle 1702. Needle tip 1706 is engaged with seat 1704 with the spray valve 1700 in the closed state and needle tip 1706 is disengaged from the seat 1704 with spray valve 1700 in the open state. Seal region 1716 is the portion of needle tip 1706 configured to directly engage with seat 1704 with spray valve 1700 in the closed state. Needle tip 1706 can be formed monolithically with needle body 1708 or can be formed separately from needle body 1708 and assembled to needle body 1708. For example, needle tip 1706 can be configured to connect to needle body 1708 by a threaded interface, such as by a threaded shank of one of needle tip 1706 and needle body 1708 extending into a threaded bore on the other one of needle tip 1706 and needle body 1708.

Wear head 1718 is formed on needle tip 1706. Wear head 1718 extends axially from seal region 1716. In the example shown, shoulder 1717 extends between seal region 1716 and wear head 1718. Shoulder 1717 extends radially inward as shoulder 1717 extends from seal region 1716 to wear head 1718. As such, the diameter of needle 1702 can be considered to decrease along shoulder 1717. In some examples, needle 1702 can be configured such that no portion of needle 1702 downstream of seal region 1716 contacts nozzle body 1728.

Wear head 1718 can be cylindrical, among other options. Wear head 1718 extends into nozzle bore 1730. Gap G3 is formed radially between the wear surface 1726 of wear head 1718 and the interior surface defining nozzle bore 1730. An annular pathway is formed about wear head 1718 and between wear head 1718 and the inner radial surface of nozzle body 1728 that defines nozzle bore 1730. Wear head 1718 is disposed downstream of seal region 1716 and spaced in second axial direction AD2 from seal region 1716. Wear head 1718 is disposed axially between seal region 1716 and distal end 1722 of needle tip 1706. Wear head 1718 is disposed downstream of the interface between seal region 1716 and seat 1704 with spray valve 1700 in the closed state.

Wear head 1718 includes wear surface 1726 on the outer radial side of wear head 1718. The restricted flowpath is formed radially between wear surface 1726 and the inner radial surface of nozzle body 1728 defining nozzle bore 1730. Nozzle bore 1730 extends axially to nozzle 1724 through which spray fluid is output during operation. Wear surface 1726 is an axially extending surface in the example shown. Wear surface 1726 extends axially such that wear head 1718 can be considered to have a cylindrical exterior. The wear surface 1726′ is not sloped in the example shown and instead extends parallel to the needle axis NA.

Needle 1702 is configured to shift axially relative to seat 1704 to actuate the spray valve 1700 between open and closed states. The interface between seal region 1716 and seat 1704 controls flow of the spray fluid through spray valve 1700. To initiate spraying, the needle 1702 is displaced in first axial direction AD1. Seal region 1716 disengages from seat 1704 and a flowpath is opened therebetween. The spray fluid flows through the gap opened between seal region 1716 and seat 1704 and downstream in second axial direction AD2. The spray fluid flows through the gap formed around the exterior of wear head 1718 and between wear head 1718 and nozzle body 1728. The wear head 1718 constricts the flowpath of the spray fluid at a location spaced axially from the seal region 1716. The flow area around needle 1702 is smaller at locations radially overlapping with wear head 1718 than at locations radially overlapping with seal region 1716 with spray valve 1700 in the open state. The constricted flowpath forms the region of highest fluid velocity, which is also the region that experiences the greatest wear due to the high velocity spray fluid flowing over the surfaces defining the constricted flowpath.

The wear head 1718 is axially elongate and extends into the axially elongate nozzle bore 1730. The passage 1732 formed between wear head 1718 and nozzle bore 1730 is axially elongate. An axial length of the passage 1732 decreases as needle 1702 shifts in axial direction AD1 from the closed state to the open state. In some examples, the wear head 1718 can remain within the nozzle bore 1730 to radially overlap portions of nozzle bore 1730 with needle 1702 fully displaced in the first axial direction AD1 such that the spray valve 1700 is fully open. In some examples, the wear head 1718 is disposed outside of the nozzle bore 1730 with spray valve 1700 fully open.

The axially elongate wear head 1718 extending into the axially elongate nozzle bore 1730 maintains the small flow area of passage 1732 between wear head 1718 and nozzle bore 1730 as the needle 1702 transitions in axial direction AD1. The axially elongated passage 1732 restricts flow as needle 1702 transitions and can assist in feathering the flow emitted from the spray gun. As needle 1702 transition opens the length of the restrictive passage 1732 decreases, increasing volumetric flow through nozzle 1724. The axial length of passage 1732 facilitates feathering of the emitted spray, such as for touch ups and other detail spray work.

The gap between wear head 1718 and the surfaces defining nozzle bore 1730 restricts the flowpath radially around wear head 1718 such that that portion of the flowpath experiences greater velocities, and thus portions of the needle 1702 in that area of the flowpath experience greater wear, than the lower velocity portion radially overlapping with seal region 1716. Wear head 1718 thereby protects seal region 1716 from wear, providing for a longer operating life of needle 1702.

The spray fluid can include particulate that wears on the surfaces of needle 1702. The particulate can cause gouging, scoring, or other damage to the exterior surface of needle 1702. Such damage occurring in the seal region 1716 compromises the sealing integrity of needle 1702 such that the spray fluid can leak between seal region 1716 and seat 1704 with the spray valve 1700 in the closed state. The wear head 1718 shifts the region of needle 1702 that experiences wear due to the high flow velocities axially relative to seal region 1716. Wear head 1718 does not form a sealing surface of needle 1702. Wear head 1718 is spaced axially from seal region 1716 and does not engage with seat 1704 during operation. The wear head 1718 being the component of needle 1702 that defines the smallest flow area and thus experiences the greatest wear protects the sealing integrity of needle 1702. The wear head 1718, not the seal region 1716, defines the smallest flow area for the spray fluid upstream of the orifice through which spray fluid is emitted from nozzle 1724. The wear head 1718 is not a sealing component and thus the wear head 1718 experiencing wear does not affect the seal integrity between needle 1702 and seat 1704.

Needle 1702 provides significant advantages. Wear head 1718 is spaced axially from seal region 1716. Wear head 1718 defines the smallest flow area through spray valve 1700 as spray valve 1700 actuates from the closed state to the open state. The smallest flow area is the region that experiences the greatest fluid velocity and thus the greatest wear. The wear head 1718 is not a sealing component and does not form a fluid seal. As such, the wear head 1718 experiencing the wear does not affect the integrity of the seal formed between seal region 1716 and seat 1704. The wear head 1718 shifting the region of highest velocity axially relative to seal region 1716 protects seal region 1716 from such wear, increasing the operational life of needle 1702, decreasing costs, and providing for more efficient spray operations with less downtime. The passage 1732 is axially elongate and has a variable axial length as needle 1702 displaces during operation, providing for controllable and precise flow when feathering, providing for accurate spraying during precision spraying, such as during touch up spraying.

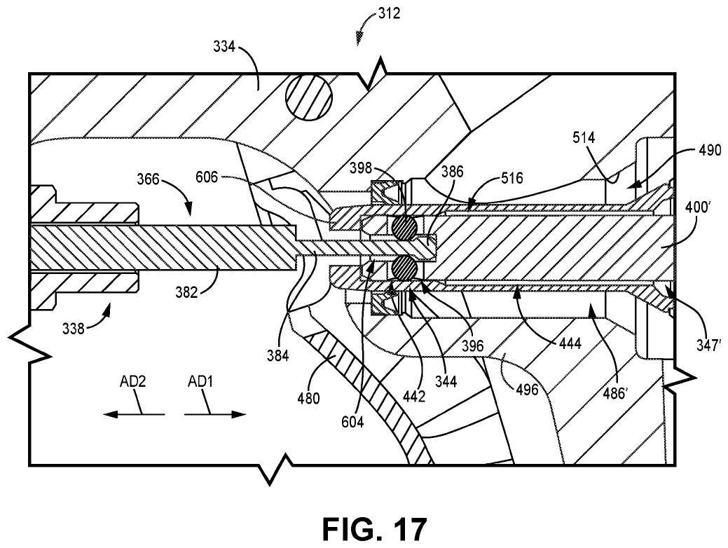

FIG. 17 is an elevational cross-sectional view of a portion of a manual spray gun 312 with a valve lock 344 for selectively engaging with needle 366 to actuate spray valve 322 to the open state. In the example shown, the return block 347′ forms the carrier 396 for the needle detents 398. A receiving chamber 604 is formed in return rod 400′ of return block 347′. The needle head 386 extends into and is disposed within the receiving chamber 604. A portion of the return rod 400′ defining the receiving chamber 604 forms the carrier 396. Valve seal 486′ includes drive lip 606 at a distal end of valve seal 486′.

In the manual spray gun example shown, the lock bore 442 and release bore 444 are formed by valve seal 486′. Specifically, the needle bore 516 through valve seal 486′ includes multiple diameters to bias needle detents 398 radially inward into driving engagement with needle 366 or to allow needle detents 398 to shift radially outward such that valve lock 344 is drivingly disengaged from needle 366 and needle head 386 can pass axially by needle detents 398 (e.g., in first axial direction AD1 for mounting and second axial direction AD2 for dismounting).

While valve lock 344 is shown as including lock bore 442 and release bore 444 formed by valve seal 486′ and the carrier 396 formed by return block 347′, it is understood that not all examples are so limited. For example, valve seal 486′ can form the carrier 396 and portions of gun bore 406 in rear block 496 of gun body 334 can be configured to form the lock bore 442 and release bore 444, similar to the configuration of valve lock 144 in spray gun 112.

In the example shown, the lock bore 442 and release bore 444 are formed as portions of a dynamic sleeve that shifts relative to the needle detents 398 to drivingly engage and drivingly disengage the valve lock 344 from the needle 366. Lock bore 442 is disposed axially between release bore 444 and nozzle 328 in the example shown.

Drive lip 606 extends radially inward to axially overlap with return block 347′. The drive lip 606 is configured to engage with return block 347′ to exert an axial driving force on return block 347′ to displace return block 347′ in first axial direction AD1.

Spray control assembly 338 is mountable as a single module. The spray control assembly 338 can be mounted and dismounted without manipulation of trigger 480. During mounting, the spray control assembly 338 is shifted in second axials direction AD2 and the needle 366 passes through the trigger 480 and enters into the receiving chamber 604 to align with needle detents 398. Needle neck 384 is radially overlapped by needle detents 398. The spray control assembly 338 is fixed to the gun body 334.

During operation, the user actuating the trigger 480 causes the trigger 480 to engage with the valve seal 486′. The trigger 480 displaces the valve seal 486′ in the second axial direction AD2. The displacing valve seal 486′ causes the lock bore 442 to pass over the needle detents 398 to drive the needle detents radially inwards to axially overlap with needle head 386. As discussed with regard to spray gun 112, the spray gun 312 is configured such that the compressed air flowpaths open prior to the spray valve 322 opening. The valve seal 486′ is an air valving component and the valve seal 486′ shifting in first axial direction AD1 opens the airflow pathways allowing compressed air to flow past air valve 490. The lock bore 442 biases the needle detents 398 inwards. The needle detents 398 engage with the needle head 386. The drive lip 606 engages with the return block 347′ to drive return block 347′ in first axial direction AD1. The return block 347′ carries the needle detents 398 and the needle detents 398 exert an axial driving force on needle head 386. The needle is driven in first axial direction AD1 to open the spray valve 322 by the trigger exerting a force on valve seal 486′, valve seal 486′ exerting a driving force on return block 347′, the return block 347′ carrying the needle detents 398 in first axial direction AD1, and the needle detents 398 driving needle 366 in first axial direction AD1 by driving engagement with needle head 386.

Valve lock 344 provides significant advantages. As shown in FIGS. 8A and 8B, typical manual spray guns require a coupler 492 to facilitate the manual trigger 480 displacing the needle 366. The trigger 480 needs to be manipulated (e.g., removed from the gun body 334 and reattached to the gun body 334) to facilitate positioning of the coupler 492 on the needle 366. Valve lock 344 selectively engages with the needle 366 depending on the operating state of the spray gun 312 and the user can mount and dismount the spray control assembly 338 without manipulating the trigger 480. Such a configuration provides for less downtime and for easier and quicker assembly and disassembly of the spray gun 312.

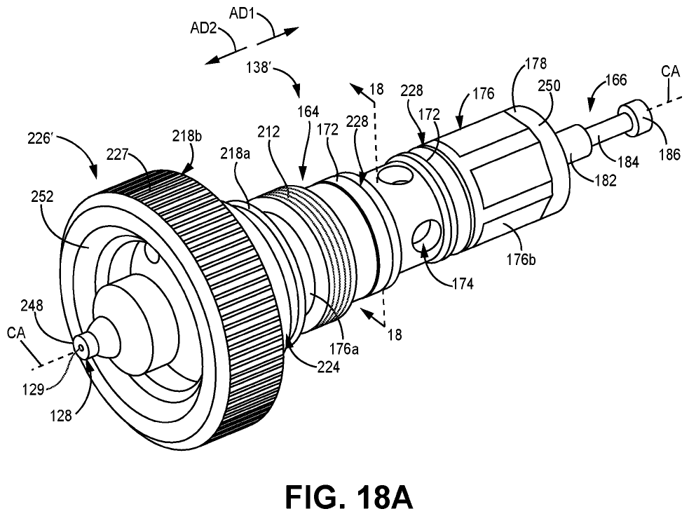

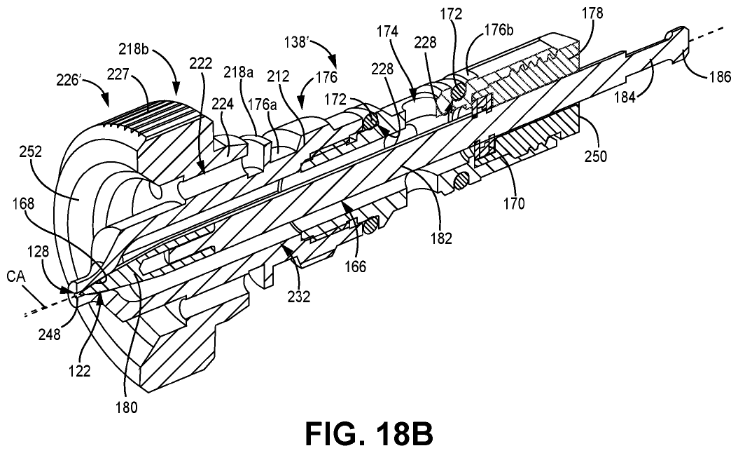

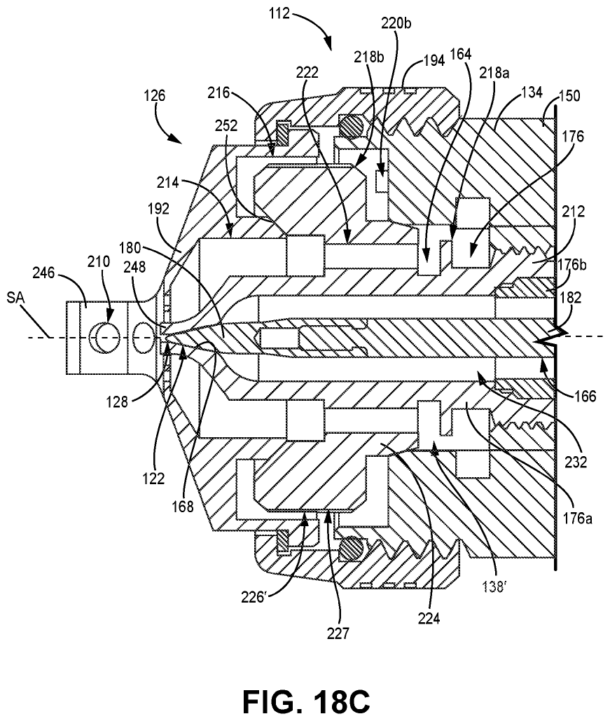

FIG. 18A is an isometric view of spray control assembly 138′. FIG. 18B is an isometric cross-sectional view of spray control assembly 138′ taken along line 18-18 in FIG. 4A. FIG. 4C is an enlarged cross-sectional view of a portion of spray control assembly 138′ and spray gun 112 showing spray control assembly 138′ mounted to a spray gun 112. FIGS. 18A-18C will be discussed together. Spray control assembly 138′ is substantively similar to spray control assembly 138 except that spray control assembly 138′ is configured for toolless installation and removal on spray gun 112. Spray control assembly 138′ includes spray valve 122, nozzle 128, cartridge body 164, needle 166, seat 168, needle seal 170, cartridge seals 172, baffle 218a, baffle 218b, and fluid ports 174. Cartridge body 164 includes housing 176 and seal holder 178. Housing 176 includes outlet housing 176a and inlet housing 176b. Needle 166 includes needle tip 180, needle body 182, needle neck 184, and needle head 186.

Spray control assembly 138′ is configured to control emission of spray fluid from a spray gun, such as spray gun 112 (FIGS. 2A-3B). Spray control assembly 138′ forms a single module that is mountable to and dismountable from the spray gun 112 as the single module. The spray control assembly 138′ is mountable to the spray gun 112 such that only a single locking interface is formed between spray control assembly 138′ and spray gun 112.

Cartridge body 164 forms an exterior of spray control assembly 138′. Cartridge body 164 is elongate along cartridge axis CA. Cartridge axis CA can be disposed coaxially with spray axis SA with spray control assembly 138′ mounted to gun body 134. Cartridge body 164 defines flow chamber 232. Flow chamber 232 is formed within cartridge body 164 and is a chamber that routes pressurized spray fluid to nozzle 128 for spraying. Flow chamber 232 is a wet chamber through which spray fluid flows during operation. The interior surfaces of cartridge body 164 that define flow chamber 232 are wet surfaces that are exposed to the spray fluid. The exterior surfaces of cartridge body 164 spaced in second axial direction AD2 from the first cartridge seal 172 that is disposed axially between fluid ports 174 and cartridge mount 212 and exterior surfaces of cartridge body 164 spaced in first axial direction AD1 from the second cartridge seal 172 that is disposed axially between fluid ports 174 and needle head 186 are dry surfaces that do not define spray fluid flowpaths. At least some of the exterior surfaces of cartridge body define flowpaths for compressed air.

Cartridge body 164 includes housing 176 and seal holder 178 mounted together. Seal holder 178 extends into housing 176 such that a portion of housing 176 is disposed around a portion of seal holder 178. In the example shown, housing 176 and seal holder 178 are connected together at a threaded interface.

Housing 176 is formed from inlet housing 176b and outlet housing 176a in the example shown. Inlet housing 176b extends into outlet housing 176a to connect to outlet housing 176a. Fluid ports 174 are formed through inlet housing 176b to admit spray fluid into flow chamber 232 and nozzle 128 is formed by outlet housing 176a to emit spray fluid from flow chamber 232. Outlet housing 176a can be considered to form a nozzle body of the nozzle 128. Nozzle 128 extends to spray orifice 129 through which the spray fluid is emitted.

Cartridge mount 212 is formed on an exterior of cartridge body 164. Cartridge mount 212 is configured to interface with the gun body 134 of the spray gun 112 to secure spray control assembly 138′ to the gun body 134. In the example shown, cartridge mount 212 is formed as threading formed on an exterior of cartridge body 164.

Cartridge mount 212 is disposed axially between fluid ports 174 and nozzle 128. As such, the spray control assembly 138′ is fixed to the gun body 134 at a location axially between the locations where the spray fluid enters into spray control assembly 138′ and where the spray fluid exits from the spray control assembly 138′.

Collar 224 is formed as a radial enlargement of cartridge body 164. Air passages 222 extend through collar 224 and define pathways for compressed air to flow from a first axial side of collar 224 to a second axial side of collar 224.

Ring 226′ projects in second axial direction AD2 relative to a portion of collar 224 defining air passages 222. Ring 226′ projects radially outward from collar 224. In the examples shown, ring 226′ does radially overlap with at least a portion of the air passages 222. Ring 226′ extends around and defines an annular chamber that the atomization air enters into after exiting from the air passages 222. Exterior surface 227 of ring 226′ is spaced radially outward from other portions of spray control assembly 138′. The exterior surface 227 is formed as an annular surface in the example shown. The exterior surface 227 is configured to be gripped by the hand of a user to rotate spray control assembly 138′ during installation and removal. Exterior surface 227 is textured to facilitate hand gripping during installation and removal. In the example shown, exterior surface 227 is knurled, though it is understood that other types of grip texturing are possible. As shown, the exterior surface 227 is textured by alternating grooves and ridges that extend axially. Ring 226′ projects to ring lip 252. Ring lip 252 is configured to interface with air cap 192 to form a seal that separates the atomization and shaping portions of the compressed air.

Baffle 218a extends radially from cartridge body 164. Baffle 218a extends radially outward to axially overlap with air passages 222. During operation, compressed air (e.g., the atomization air) flows over and around baffle 218a to reach air passages 222 and flow downstream to central orifice 208 in air cap 192. The baffle 218a facilitates distribution of the compressed air about the cartridge axis CA. Distributing the atomization air about the cartridge axis CA provides an evenly distributed flow to impinge on and atomize the spray fluid. Distributing the atomization air about the cartridge axis CA provides for effective atomization, preventing spitting or incomplete atomization.

In the example shown, ring 226′ forms baffle 218b. The exterior surface 227 of ring 226′, over which the compressed air flows, is disposed radially outward from baffle 218a. In the example shown, ring 226′ does not axially overlap with baffle 218a. During operation, compressed air (e.g., the shaping air) flows over and around ring 226′ to reach air cap 192 and flow to the shaping orifices 210 in air cap 192. Baffle 218b is configured such that the compressed air flows over the outer radial edge of baffle 218b. The baffle 218b facilitates distribution of the compressed air about the cartridge axis CA. Distributing the shaping air about the cartridge axis CA provides an evenly distributed flow to shape the atomized spray fluid. The compressed air first encounters the axial face of ring 226′ oriented in first axial direction AD1 and then flows radially outward to the exterior surface 227. As discussed above, the grooves on the textured exterior surface 227 facilitate flow of the compressed air in second axial direction AD2 and towards air cap 192. Distributing the shaping air about the cartridge axis CA provides for effective flow to all sets of shaping orifices to effectively shape the spray pattern.

As shown in FIG. 18C, there is no radial projection separate from ring 226′ that axially overlaps with ring 226′. The ring 226′ itself forms the baffle 218b and directs the compressed air. Exterior surface 227 of ring 226′ is radially closer to air cap than any other baffle and any other portion of spray control assembly 138′.

Seal grooves 228 are formed on the exterior of cartridge body 164. A first seal groove 228 is spaced in second axial direction AD2 from fluid ports 174. A second seal groove 228 is spaced in first axial direction AD1 from fluid ports 174.

Cartridge seals 172 are disposed in seal grooves 228. The cartridge seals 172 are configured to engage with gun body 134 to inhibit leakage of spray fluid about the exterior of cartridge body 164 in either first axial direction AD1 or second axial direction AD2.

Needle seal 170 is disposed within cartridge body 164. Needle seal 170 is configured to engage an exterior of needle 166. Needle seal 170 prevents spray fluid from leaking out of cartridge body 164 between needle 166 and cartridge body 164. The interface between needle seal 170 and needle 166 is a sliding interface as needle 166 slides axially relative to needle seal 170 during operation.

Needle 166 is at least partially disposed within cartridge body 164. Needle 166 is elongate along cartridge axis CA. Needle 166 is configured to shift along cartridge axis CA during operation. In the example shown, needle 166 extends out of cartridge body 164 through second end 250 of cartridge body 164. Needle 166 does not extend out of cartridge body 164 through first end 248 of cartridge body 164. As such, needle 166 does not extend fully axially through cartridge body 164.

Needle tip 180 is disposed at a first axial end of needle 166. Needle tip 180 is configured to engage with seat 168 with spray valve 122 in a closed state. Needle body 182 extends axially from needle tip 180. Needle body 182 extends from within flow chamber 232 to outside of cartridge body 164. Needle body 182 extends through needle seal 170 and is engaged with needle seal 170. Needle neck 184 extends in first axial direction AD1 from needle body 182. Needle head 186 is disposed at an opposite axial end of needle 166 from needle tip 180. Needle head 186 is connected to needle neck 184. Needle head 186 projects radially outward from needle neck 184. Needle head 186 is disposed at an opposite axial end of needle neck 184 from needle body 182.

Spray valve 122 is formed between needle 166 and seat 168. Spray valve 122 is in an open state with needle 166 spaced from seat 168 such that spray fluid can flow downstream to and through nozzle 128 through the gap between needle 166 and seat 168. Spray valve 122 is in a closed state with needle 166 engaged with seat 168, thereby closing the gap between needle 166 and seat 168 and preventing spray fluid from flowing to and through nozzle 128.

Spray control assembly 138′ controls emission of spray fluid from spray gun 112. Spray control assembly 138′ further directs one or more of the flows of compressed air. In the example shown, spray control assembly 138′ directs both the atomization air, via baffle 218a and air passages 222, and the shaping air, via ring 226′. In the example shown, ring 226′ defines portions of the flowpaths for both the atomization air and shaping air. In the example shown, the ring 226′ defines the construction for the shaping air through the outer air chamber 216. The ring 226′ defines a narrowest radial portion of the flowpath in outer air chamber 216. In the example shown, ring 226′ does not define the constriction for air flowing within inner air chamber 214.

Spray control assembly 138′ is mountable to and dismountable from spray gun 112 as a single module. The spray control assembly 138′ forms the single module such that spray control assembly 138′ mounts to and dismounts from spray gun 112 as one unit, without requiring assembly or manipulation of individual components of the spray control assembly 138′. The spray control assembly 138′ is mountable and dismountable by manipulating cartridge body 164 by hand gripping on exterior 227, to form or break a connection interface between cartridge body 164 and gun body 134 of spray gun 112, and without having to manipulate or access other components of spray control assembly 138′. The user does not have to access or manipulate any of the valving components of spray control assembly 138′ during mounting and dismounting.

Spray control assembly 138′ can be mounted to the spray gun 112 by shifting spray control assembly 138′ in first axial direction AD1 and into the spray gun 112 (e.g., into gun bore 206 in gun body 134). Cartridge mount 212 is engaged with a corresponding mounting interface on spray gun 112, such as female threading configured to engage with the male threading of cartridge mount 212, among other connection options. The user can grip the textured exterior surface 227 to rotate spray control assembly 138′ and engage cartridge mount 212 with the mounting portion of spray gun 112.

Spray control assembly 138′ can be dismounted from the spray gun 112 by shifting spray control assembly in second axial direction AD2. The user breaks the connection between cartridge mount 212 and gun body 134 (e.g., by gripping exterior surface 227 and unthreading cartridge mount 212 from gun body 134) and can then pull the spray control assembly 138′ axially out of gun body 134.

Spray control assembly 138′ provides significant advantages. Spray control assembly 138′ is mountable and dismountable as a single module, reducing the number of parts that have to be aligned and installed to assemble spray gun 112 and thereby providing for easier inventorying for the user and simpler assembly and disassembly of spray gun 112. Ring 226′ forms an interface for the user that facilitates toolless installation and removal of spray control assembly 138′. The ring 226′ can form the baffle 218b that directs a portion of the compressed air and distributes that portion of the compressed air around the cartridge axis CA. The ring 226′ forming the baffle 218b provides for a simpler configuration with less parts. The ring 226′ both provides a grip surface for toolless installation and routes compressed air.

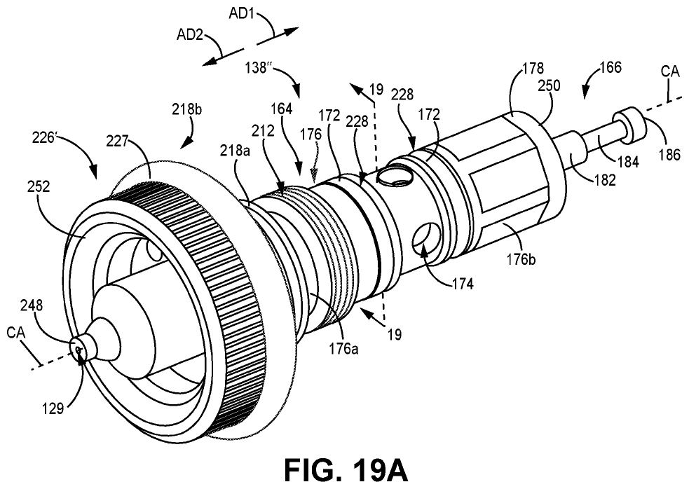

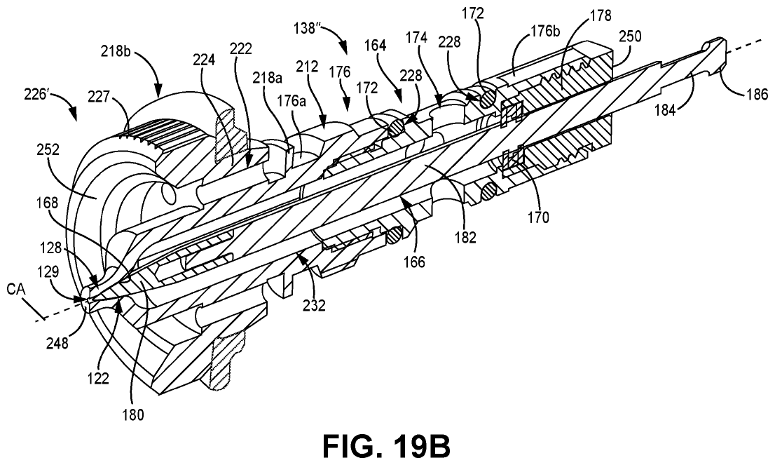

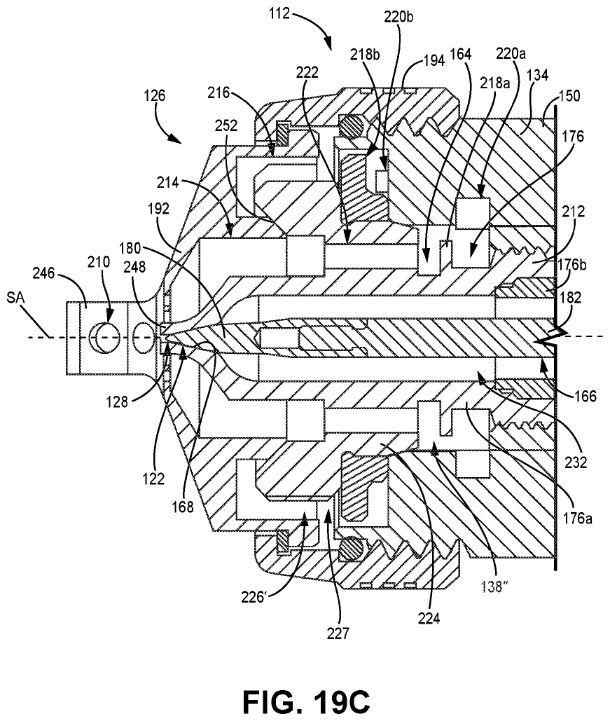

FIG. 19A is an isometric view of spray control assembly 138″. FIG. 19B is an isometric cross-sectional view of spray control assembly 138″ taken along line 19-19 in FIG. 19A. FIG. 19C is an enlarged cross-sectional view of a portion of spray control assembly 138″ and spray gun 112 showing spray control assembly 138″ mounted to a spray gun 112. FIGS. 19A-19C will be discussed together. Spray control assembly 138″ is substantively similar to spray control assembly 138′ (FIGS. 18A-18C) except that spray control assembly 138″ includes a baffle 218b formed separately from ring 226′.

In the example shown, the baffle 218b is spaced in first axial direction AD1 from the ring 226′. Ring 226′ extends radially outward to axially overlap with baffle 218b. In some examples, the axial face of ring 226′ oriented in first axial direction AD1. Ring 226′ can support baffle 218b axially while collar 224 supports baffle 218b radially. Baffle 218b can be formed separately from cartridge body 164 or can be formed integral with cartridge body 164, such as monolithically with outlet housing 176a.

In the example shown, baffle 218b projects further radially outward from cartridge axis CA than exterior surface 227. Exterior surface 227 of ring 226′ is spaced radially outward from other portions of cartridge body 164 in the example shown. The exterior surface 227 is formed as an annular surface in the example shown. The exterior surface 227 is configured to be gripped by the hand of a user to rotate spray control assembly 138″ during installation and removal. Exterior surface 227 is textured to facilitate hand gripping during installation and removal. In the example shown, exterior surface 227 is knurled, though it is understood that other types of grip texturing are possible. As shown, the exterior surface 227 is textured by alternating grooves and ridges that extend axially.

FIG. 20A is an isometric view of a cap assembly 1010. FIG. 20B is an exploded view of cap assembly 1010. FIG. 20C is a cross-sectional view of cap assembly 1010 taken along line 20-20 in FIG. 20A showing cap assembly 1010 in a locked state. FIG. 20D is a cross-sectional view of cap assembly 1010 taken along line 20-20 in FIG. 20A showing cap assembly 1010 in an unlocked state. FIG. 21 is an enlarged isometric cross-sectional view showing cap assembly 1010 mounted to the gun body of a spray gun. FIGS. 20A-21 are discussed together.

Cap assembly 1010 (similar to cap assemblies 26, 126, 326) includes air cap 1012 (similar to air cap 192, air cap 392) and cap retainer 1014 (similar to cap retainer 194, cap retainer 394). Cap retainer 1014 includes retainer body 1016, cap lock 1018, stop block 1020, position lock 1022, and detents 1024. Retainer body 1016 extends between body ends 1028a, 1028b and includes block retainer 1030 lock retainer 1032, shoulder 1034, detent bores 1036. Cap opening 1040 and body opening 1042 are formed through retainer body 1016. Cap lock 1018 includes lock body 1044, blocker 1046, and grips 1048a, 1048b. End faces 1050a, 1050b are formed at opposite axial ends of blocker 1046. Blocker 1046 includes inner face 1052. Cap body 1058, retaining flange 1060, horns 1062, cap orifice 1064, flow separator 1066, separator face 1068, horn outlets 1070, and horn passages 1072 of air cap 1012 are shown. Cap assembly 1010 is configured to mount to the gun body 334 of spray gun 312. Body groove 1074 and detent receiver 1076 of the gun body are shown.

Spray gun 312 is configured to receive pressurized spray fluid and to output that spray fluid as an atomized fluid spray. While cap assembly 1010 is shown mounted to a manual spray gun 312, it is understood that cap assembly 1010 can be similarly mounted to an automatic spray gun 112. The spray gun is configured to emit the spray fluid along spray axis SA. Gun body 334 (in some examples, gun body 134) supports other components of the spray gun. Cap assembly 1010 is disposed at a first axial end of the gun body. Cap assembly 1010 is supported by the gun body. Cap assembly 1010 is configured to mount directly to the gun body. In the example shown, cap assembly 1010 is a quick-connect cap assembly in that cap assembly 1010 can be placed in a locked or unlocked state for mounting and dismounting. Cap assembly 1010 does not require rotation about assembly axis AA during mounting and dismounting. Cap assembly 1010 can be mounted to or removed from the gun body while in the unlocked state and can be placed in the locked state to mount to the gun body. In the example shown, cap assembly 1010 is linearly actuated between the locked state and the unlocked state by relative movement along the actuator axis AA. The movement can be along the spray axis SA, which spray axis SA can be disposed coaxially with the actuator axis AA.

Cap assembly 1010 is configured to direct compressed air flows for atomizing and, in some examples, shaping of the spray fluid output by spray gun 312. Air cap 1012 is mounted to the gun body by cap retainer 1014. Cap retainer 1014 mounts to the gun body and holds air cap 1012 on the gun body. Cap retainer 1014 interfaces with the gun body to hold air cap 1012 on spray gun and align air cap 1012 on spray axis SA. Cap retainer 1014 can mount to the spray gun such that assembly axis AA and spray axis SA are disposed coaxially. Cap retainer 1014 extends over air cap 1012 and interfaces with the gun body to secure air cap 1012 to the gun body.

Air cap 1012 is configured to emit both atomizing air and shaping air. Cap body 1058 defines various flowpaths for compressed air to flow to be emitted from the spray gun. The compressed gas can flow to and be emitted from horn orifices 1070 and cap orifice 1064. Retaining flange 1060 extends radially outward relative to other portions of cap body 1058. Retaining flange 1060 is configured to interface with cap retainer 1014 to prevent air cap 1012 from moving in second axial direction AD2 relative to cap retainer 1014. In the example shown, shoulder 1034 projects to axially overlap with retaining flange 1060 and is configured to interface with retaining flange 1060 to prevent air cap 1012 from moving out of receiving chamber 1082 in axial direction AD2. Cap retainer 1014 can brace against retaining flange 1060 to mount air cap 1012 to the gun body. In the example shown, retaining flange 1060 extends fully annularly about assembly axis AA of cap assembly 1010.

Horns 1062 project in axial direction AD2. Horn passages 1072 are formed in horns 1062 and define flowpaths for compressed air to flow to horn outlets 1070 to be emitted from air cap 1012. Cap orifice 1064 is aligned on spray axis SA so spray fluid can be emitted through cap orifice 1064. In some examples, portions of a spray control assembly (e.g., one or more of spray control assemblies 138, 138′, 138″, 328) can extend into cap orifice 1064.

Flow separator 1066 projects form an axially inner side of air cap 1012. Flow separator 1066 extends axially towards the gun body. Flow separator 1066 extends in axial direction AD1. Flow separator 1066 can be cylindrical, among other possible configurations. In the example shown, flow separator 1066 extends to separator face 1068 that interfaces with a ring, such as a ring of the spray control assembly (e.g., ring 226, 426), to fluidly separate an inner air passage (e.g., inner air passage 214, 414) and an outer air passage (e.g., outer air passage 216, 416). Separator face 1068 is a sloped face in the example shown. Separator face 1068 interfaces with the sloped face of the ring (e.g., ring 226, 426) to fluidly separate the inner and outer air passages.

Retainer body 1016 extends axially between body ends 1028a, 1028b. Body ends 1028a, 1028b can also be referred to as axial ends of retainer body 1016. Receiving chamber 1082 is formed within retainer body 1016. Receiving chamber 1082 is configured such that air cap 1012 is at least partially disposed in receiving chamber 1082 with cap assembly 1010 mounted to the spray gun. Receiving chamber 1082 is configured such that the gun body is at least partially disposed in receiving chamber 1082 with cap assembly 1010 mounted to the spray gun.

Cap opening 1040 is formed through body end 1028a. Air cap 1012 extends through cap opening 1040. Air cap 1012 is mounted to retainer body 1016 such that air cap 1012 is partially disposed outside of cap retainer 1014 and partially disposed within receiving chamber 1082. Body opening 1042 is formed through body end 1028b. The gun body extends through body opening 1042. Cap assembly 1010 is mounted to the spray gun such that the gun body is partially disposed within receiving chamber 1082 and extends out of receiving chamber 1082 through body opening 1042. Body opening 1042 is configured to receive a portion of the gun body into cap assembly 1010. The the gun body extends through body opening 1042 and into receiving chamber 1082. In the example shown, body opening 1042 has a larger diameter than cap opening 1040. Such a configuration facilitates assembly of air cap 1012 to cap retainer 1014, such as by passing air cap 1012 axially along assembly axis AA in second axial direction AD2 through body opening 1042 and receiving chamber 1082 and then partially through cap opening 1040.

Shoulder 1034 is configured to interface with cap body 1058 to retain air cap 1012 at least partially within receiving chamber 1082. In the example shown, shoulder 1034 interfaces with retaining flange 1060. Shoulder 1034 extends radially inwards towards assembly axis AA. Shoulder 1034 axially overlaps with retaining flange 1060. The axial overlap prevents retaining flange 1060 from passing axially past shoulder 1034. With air cap 1012 inserted through receiving chamber 1082 and out through cap opening 1040, the retaining flange 1060 interfaces with shoulder 1034 to prevent air cap 1012 from passing in axial direction AD2 and out of receiving chamber 1082.

Cap seal groove 1054 is formed in retainer body 1016. Cap seal groove 1054 extends radially into retainer body 1016. In the example shown, cap seal groove 1054 is open radially inwards towards assembly axis AA and extends radially outwards into retainer body 1016. Cap seal groove 1054 is formed in the radial projection that forms shoulder 1034, in the example shown. Cap seal 1056 is disposed in cap seal groove 1054 and interfaces with air cap 1012 and cap retainer 1014. Cap seal 1056 forms a fluid-tight seal between air cap 1012 and retainer body 1016 to prevent compressed gas from leaking therebetween. Cap seal 1056 can be formed as an elastomer o-ring, among other options. Cap seal 1056 can frictionally interface with air cap 1012 such that air cap 1012 is carried with retainer body 1016 by the frictional interface. Air cap 1012 can be held to axially displace with retainer body 1016 during mounting and dismounting of cap assembly 1010 on the spray gun.

Cap lock 1018 is configured to place cap retainer 1014 in the locked state and the unlocked state. Cap lock 1018 is configured to shift relative to retainer body 1016 to place cap retainer 1014 in the locked state and the unlocked state. Cap lock 1018 is configured to slide axially along actuator axis AA to actuate cap retainer 1014 between the locked and unlocked states. In the example shown, cap lock 1018 shifts axially relative to retainer body 1016. Cap lock 1018 can be considered to form a sleeve in the example shown. Cap lock 1018 can be disposed fully annularly about retainer body 1016. In some examples, cap lock 1018 can from a solid ring extending about retainer body 1016.

Lock body 1044 extends axially. Grips 1048a, 1048b project outward and are configured to be interfaced with by a user to displace cap lock 1018. Grip 1048a is disposed at one axial end of lock body 1044. Grip 1048a projects radially outward from other portions of lock body 1044. Grip 1048a is formed as an annular projection in the example shown. Grip 1048b is disposed at an opposite axial end of lock body 1044 from grip 1048a. Grip 1048b projects radially outward from other portions of lock body 1044. Grip 1048b is formed as an annular projection in the example shown. Grips 1048a, 1048b provide protrusions that a user can push or pull on to displace cap lock 1018 axially.

Cap lock 1018 is configured to interface with detents 1024 to place cap retainer 1014 in the locked state. Blocker 1046 is disposed on a radially inner side of lock body 1044. In the example shown, blocker 1046 is monolithically formed with other portions of lock body 1044, though it is understood that not all examples are so limited. Blocker 1046 projects radially inwards towards actuator axis AA. In the example shown, the cap lock 1018 includes an inner ring surface oriented towards the axis AA and the blocker 1046 projects radially inwards from that inner ring surface. A portion of the inner ring surface can radially overlap with detents 1024 with cap retainer 1014 in the unlocked state.

Blocker 1046 extends at least partially around actuator axis AA. Blocker 1046 is formed as an annular ring in the example shown. In the example shown, blocker 1046 extends fully annularly about the actuator axis AA. Blocker 1046 is positioned relative to detents 1024 to place cap retainer 1014 in the locked state and the unlocked state. In the example shown, blocker 1046 is radially overlapped with detents 1024 to place cap retainer 1014 in the locked state and blocker 1046 is spaced axially from detents 1024 to place cap retainer 1014 in the unlocked state. Blocker 1046 radially overlapping with detents 1024 biases detents 1024 radially inward and maintains detents 1024 in engagement with gun body to secure cap assembly 1010 to gun body. Blocker 1046 is configured to prevent detents 1024 from shifting radially outward and out of engagement with the gun body while in the locked state.

Inner face 1052 is oriented radially inward. Inner face 1052 is a portion of cap retainer 1014 that is oriented inwards towards assembly axis AA. In the example shown, inner face 1052 forms a portion of blocker 1046 radially overlapped with detents 1024 with cap retainer 1014 in the locked state. Inner face 1052 is spaced axially from detents 1024 and does not radially overlap with detents 1024 in the unlocked state of the example shown.

End faces 1050a, 1050b are disposed at axially opposite ends of blocker 1046. In the example shown, end face 1050a is disposed at an axial end of blocker 1046 oriented in first axial direction AD1 and end face 1050b is disposed at an axial end of blocker 1046 oriented in second axial direction AD2. End faces 1050a, 1050b are formed as sloped faces in the example shown. A base of the projection forming blocker 1046 is axially wider than inner face 1052 of blocker 1046 due to the sloped configuration of end faces 1050a, 1050b. End faces 1050a, 1050b are configured to engage with other components of cap assembly 1010 to retain cap lock 1018 on retainer body 1016. In the example shown, end face 1050a is configured to engage with stop block 1020 to limit movement of cap lock 1018 in axial direction AD1 relative to retainer body 1016. The interface between end face 1050a and stop block 1020 maintains cap lock 1018 mounted on retainer body 1016. In the example shown, end face 1050b is configured to engage with position lock 1022 to maintain cap lock 1018 in the lock position associated with the locked state and end face 1050b is configured to engage body stop 1038 to limit movement of cap lock 1018 in second axial direction AD2 relative to retainer body 1016. The interface between end face 1050b and body stop 1038 maintains cap lock 1018 mounted on retainer body 1016. In the example shown, body stop 1038 is formed as a sloped face of retainer body 1016.

Stop block 1020 is mounted to retainer body 1016. Stop block 1020 is configured to interface with cap lock 1018 to limit displacement of cap lock 1018 in first axial direction AD1 relative to retainer body 1016. Stop block 1020 retains cap lock 1018 on retainer body 1016. Stop block 1020 can extend at least partially around assembly axis AA. Stop block 1020 can be formed as a partial ring. In some examples, stop block 1020 can be formed as a full ring or as an overlapping ring with ends that extend greater than 360-degrees about axis AA. Stop block 1020 is mounted to retainer body 1016. In the example shown, stop block 1020 is mounted within block retainer 1030 formed in retainer body 1016 in the example shown. Stop block 1020 is at least partially disposed in block retainer 1030. Stop block 1020 can project radially outward beyond the lips of block retainer 1030. In the example shown, stop block 1020 is disposed between the blocker 1046 and body end 1028b to limit displacement of the cap lock 1018 towards the body end 1028b.

Block retainer 1030 is open radially outward from actuator axis AA. Block retainer 1030 can be formed as a retaining groove that extends at least partially about actuator axis AA. Block retainer 1030 can extend fully annularly about actuator axis AA. In the example shown, stop block 1020 is at least partially disposed radially outside of block retainer 1030 such that stop block 1020 axially overlaps with blocker 1046.

Position lock 1022 is mounted to retainer body 1016. Position lock 1022 is configured to interface with cap lock 1018 to maintain cap lock 1018 in a position associated with a desired state. In the example shown, position lock 1022 is configured to interface with blocker 1046 (e.g., end face 1050b) to maintain cap lock 1018 in the lock position (FIG. 20C) associated with the locked state. In the example shown, position lock 1022 projects radially outward to axially overlap with the projection forming blocker 1046 to retain cap lock 1018 in the lock position. Position lock 1022 is further configured to interface with blocker 1046 to maintain cap lock 1018 in the unlock position (FIG. 20D) associated with the unlocked state. In the example shown, position lock 1022 projects radially outward to interface with inner face 1052 of blocker 1046 to maintain cap lock 1018 in the unlock position. Position lock 1022 is configured such that position lock 1022 frictionally retains cap lock 1018 in the unlock position. In the example shown, position lock 1022 is formed from a compliant material such that position lock 1022 can inhibit axial movement of cap lock 1018 while also allowing for cap lock 1018 to be pulled over position lock 1022 to compress position lock 1022 while shifting to the unlock position. The compliant material forming position lock 1022 can bias position lock 1022 radially outward into engagement with inner face 1052 to frictionally interface position lock 1022 and cap lock 1018. Position lock 1022 can be formed as a compliant ring. For example, position lock 1022 can be formed as an elastomer o-ring, among other options.

Lock retainer 1032 is open radially outward from actuator axis AA. Lock retainer 1032 can be formed as a retaining groove that extends at least partially about actuator axis AA. Lock retainer 1032 can extend fully annularly about actuator axis AA. In the example shown, position lock 1022 is at least partially disposed radially outside of lock retainer 1032 such that position lock 1022 axially overlaps with blocker 1046 with cap lock 1018 in the lock position and such that position lock 1022 radially engages blocker 1046 with cap lock 1018 in the unlock position.

In the example shown, both position lock 1022 and stop block 1020 project radially outward to axially overlap with blocker 1046 with cap retainer 1014 in the locked state. The position lock 1022 projects radially outward beyond a portion of the outer radial side of the retainer body 1016 forming a lip of the lock retainer 1032. In the example shown, position lock 1022 projects radially beyond both lips of the lock retainer 1032. The stop block 1020 projects radially outward beyond a portion of the outer radial side of the retainer body 1016 forming a lip of the block retainer 1030. In the example shown, stop block 1020 projects radially beyond both lips of the block retainer 1030. In the example shown, position lock 1022 is compliant such that position lock 1022 can be compressed by blocker 1046 engaging and passing over position lock 1022 such that inner face 1052 radially overlaps with position lock 1022. Stop block 1020 is formed as a resilient ring such that blocker 1046 is prevented from compressing or passing over stop block 1020. For example, stop block 1020 can be formed from a plastic, metal, composite, etc.

Detents 1024 are configured to engage with the gun body to connect cap assembly 1010 to the gun body. Detents 1024 form a detent array 1026 that extends at least partially about assembly axis AA. Detent array 1026 extends fully circumferentially about assembly axis AA in the example shown. The detents 1024 are evenly spaced about assembly axis AA as shown, though it is understood that detents 1024 can be unevenly spaced in some examples. In the example shown, body seal 1078 is disposed in body groove 1074 to interface with cap assembly 1010 and gun body and form a seal therebetween to prevent leakage of compressed gas therebetween. Detents 1024 are configured to extend into detent receiver 1076 in the example shown to mount cap assembly 1010 to the gun body.

Detents 1024 are disposed within detent bores 1036 formed in retainer body 1016. In the example shown, detent bores 1036 extend fully through retainer body 1016 such that detent bores 1036 are open through a radially inner surface of retainer body 1016 and through a radially outer surface of retainer body 1016. An array of the detent bores 1036 extends annularly about assembly axis AA.

Detent bores 1036 are open through the radially inner surface of retainer body 1016 to allow detents 1024 to project into receiving chamber 1082. Detents 1024 project into receiving chamber 1082 to engage with the gun body to mount cap assembly 1010 to the gun body. In the example shown, detent bores 1036 are open through the radially outer surface of retainer body 1016 such that detents 1024 can pass at least partially out of detent bore 1036 through the outer radial surface, such as to allow the gun body to pass under detents 1024 and push detents 1024 radially outward during mounting and dismounting of cap assembly 1010.

Detent array 1026 is disposed axially between position lock 1022 and stop block 1020. Detent array 1026 is disposed axially between lock retainer 1032 and block retainer 1030. Position lock 1022 is disposed between body end 1028a and detent array 1026. Stop block 1020 is disposed between body end 1028b and detent array 1026. In the example shown, cap lock 1018 radially overlaps with detents 1024 with cap retainer 1014 in both the locked and unlocked states. With cap retainer 1014 in the locked state, the blocker 1046 radially overlaps with detents 1024. With cap retainer 1014 in the unlocked state, blocker 1046 is spaced axially from detent array 1026 such that detents 1024 can move radially outward to allow the gun body to pass under detent array 1026. The body 1044 of cap lock 1018 remains radially overlapped with detents 1024 to maintain detents 1024 at least partially within detent bores 1036 with cap retainer 1014 in the unlocked state. The cap lock 1018 thereby maintains detents 1024 mounted to retainer body 1016 while in the unlocked state while also allowing detents 1024 to move radially outward to facilitate passing of gun body axially through detent array 1026.

Detent array 1026 is disposed axially closer to body opening 1042 than to cap opening 1040. Such a position facilitates engaging with the gun body at a location inset from the axial edge of the gun body while the gun body and air cap 1012 both extend into retainer body 1016 to be linked by a single mechanical support. The gun body can pass axially through the detent array 1026 during mounting and dismounting of cap assembly 1010 on the gun body.

Detent receiver 1076 is formed on the gun body. Detent receiver 1076 is configured to interface with detents 1024 to mount cap assembly 1010 to the gun body. The detent receiver 1076 extends radially into an outer radial side of the gun body. Detent receiver 1076 can extend fully or partially about the spray axis SA. The detent receiver 1076 can be formed as a series of individual receivers or a single receiver. Detent receiver 1076 can be configured as a receiving groove that extends up to fully annularly about the spray axis SA. In the example shown, detents 1024 extend into detent receiver 1076 to axially overlap with the axial walls of detent receiver 1076 with cap assembly 1010 mounted on and locked to the gun body.

In the example shown, detents 1024 are formed as balls 1080. Balls 1080 are biased radially inward and into detent receiver 1076 with cap retainer 1014 in the locked state. In the example shown, the detent array 1026 is formed as a plurality of balls 1080 disposed in a plurality of detent bores 1036, each detent bore 1036 of the plurality of detent bores 1036 spaced circumferentially about the axis AA from an adjacent detent bore 1036 of the plurality of detent bores 1036. The multiple balls 1080 can extend into a single groove forming detent receiver 1076. Cap assembly 1010 is mountable at any desired orientation about the axis AA as any one of balls 1080 is mountable within any portion of the detent receiver 1076.

Detents 1024 being formed as balls 1080 can facilitate reorienting air cap 1012 and cap assembly 1010 without having to dismount cap assembly 1010 from gun body. With cap assembly 1010 mounted to the gun body, a user can grasp retainer body 1016 and/or cap lock 1018 and twist that component about the assembly axis AA. For example, the user can exert a radially inward force on grip 1048a and twist about the axis AA. Such a twisting motion can cause air cap 1012 to rotate on the axis AA. Such a reorientation of air cap 1012 reorients the spray pattern (e.g., fan) emitted from the sprayer. Balls 1080 can roll on gun body within detent receiver 1076, facilitating reorientation without dismounting of cap assembly 1010. In some examples, air cap 1012 can be directly grasped (e.g., at horns 1062) and rotated on axis AA to reorient the spray pattern.

In the example shown, cap lock 1018 can be rotated about the assembly axis AA without affecting the engagement of detents 1024 with gun body. Cap lock 1018 can be rotated about assembly axis AA while in the locked state (FIG. 20C) and will remain in the locked state until cap lock 1018 is displaced axially relative to detents 1024 and to the unlocked state. Cap lock 1018 can be rotated about assembly axis AA while in the unlocked state (FIG. 20D) and will remain in the unlocked state until cap lock 1018 is displaced axially relative to detents 1024 and to the locked state.

Cap assembly 1010 provides significant advantages. Cap assembly 1010 facilitates quick and toolless mounting and dismounting of air cap 1012 from the gun body. Cap lock 1018 can be slid linearly along assembly axis AA to place cap assembly 1010 in the unlocked state (FIG. 20D). Position lock 1022 retains cap lock 1018 in that position as cap assembly 1010 is mounted over the gun body. The gun body enters into receiving chamber 1082 through body opening 1042. With cap assembly 1010 positioned over the gun body, the cap lock 1018 is slid in axial direction AD1 such that blocker 1046 passes over detent array 1026 and cap retainer 1014 is placed in the locked state (FIGS. 20C and 21). The blocker 1046 biases detents 1024 radially inwards and into detent receiver 1076. Cap assembly 1010 is thus mounted on the gun body.

Cap lock 1018 is slid in second axial direction AD2 such that blocker 1046 passes out of radial overlap with detents 1024 and returns cap retainer 1014 to the unlocked state. Cap assembly 1010 can then be pulled in axial direction AD2 such that the gun body is withdrawn from receiving chamber 1082 through body opening 1042. Cap assembly 1010 is thereby dismounted from the gun body.

Cap assembly 1010 can be mounted and/or dismounted by a single action in some examples. In the example shown, cap assembly 1010 can be grasped with cap lock 1018 disposed axially forward (FIG. 20D) such that cap retainer 1014 is in the unlocked state. The cap assembly 1010 is axially displaced such that portions of the spray gun (e.g., the gun body, the spray control assembly) pass into receiving chamber 1082. The cap assembly 1010 is displaced until axially stopped, such as by air cap 1012 encountering ring 226, 426. Air cap 1012 being axially stopped will stop retainer body 1016 due to the axial overlap between retaining flange 1060 and shoulder 1034. Cap lock 1018 can continue to displace in axial direction AD1 relative to retainer body 1016 to bias detents 1024 into engagement with the gun body and until end face 1050a encounters stop block 1020. Cap assembly 1010 is thus mounted by a single axial movement.

Cap assembly 1010 can be dismounted by a single axial movement opposite the single axial movement for mounting of cap assembly 1010. Cap lock 1018 is grasped and pulled in axial direction AD2. Blocker 1046 passes over the compliant position lock 1022 and cap lock 1018 continues to displace until end face 1050b encounters body stop 1038. Body stop 1038 prevents cap lock 1018 from displacing further in axial direction AD2 relative to body stop 1038. Cap lock 1018 exerts an axial force on retainer body 1016 to displacer retainer body 1016 in axial direction AD2. Blocker 1046 is axially spaced from detents 1024 such that detents 1024 can bump radially outward to pass over the gun body to allow the gun body to pass out of receiving chamber 1082. Air cap 1012 can be connected to retainer body 1016 to dismount with retainer body 1016. For example, cap seal 1056 can mount air cap 1012 to retainer body 1016. Cap seal 1056 can exert sufficient frictional engagement with cap body 1058 to cause air cap 1012 to displace axially with retainer body 1016. Cap assembly 1010 is thereby dismountable by a single axial movement.

Cap assembly 1010 facilitates quick and efficient mounting and dismounting of an air cap 1012 from a sprayer. Cap assembly 1010 can be mounted and dismounted by a single motion, providing for simple, ergonomic mounting by a user. The cap assembly 1010 does not require twisting to mount or dismount from the gun body. Position lock 1022 holds cap lock 1018 in either the locked or unlocked states, providing confidence to the user and a robust configuration that does not fall between states. Detent array 1026 distributes the forces exerted on the gun body about the gun body. The detent array 1026 provides for a robust holding configuration that retains cap assembly 1010 on the gun body. The cap assembly 1010 is a quick-connect air cap assembly that allows for quick and easy mounting and/or replacement of an air cap on a spray gun, minimizing downtime and providing for more efficient spray operations.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A spray control assembly for a fluid spray gun, the spray control assembly comprising:
a cartridge body elongate along a cartridge axis;
a nozzle formed at a first end of the cartridge body;
a spray valve disposed within the cartridge body;
a needle partially disposed within the cartridge body and extending out of the cartridge body through a second end of the cartridge body opposite the first end of the cartridge body, the needle including a needle tip configured to engage with the seat to place a spray valve in a closed state and including a needle head at an opposite end of the needle from the needle tip;
a cartridge mount disposed on an exterior of the cartridge body, the cartridge mount configured to interface with a gun body of the spray gun to mount the spray control assembly to the spray gun; and
at least one fluid port extending through the cartridge body between the exterior of the cartridge body and a flow chamber formed within an interior of the cartridge body;
wherein the spray control assembly is formed as a single module configured to be mounted to and dismounted from the fluid spray gun as the single module.

2. The spray control assembly of claim 1, wherein no springs are disposed in the flow chamber.

3. The spray control assembly of claim 1, wherein the single module does not include any springs.

4. The spray control assembly of claim 1, further comprising:
a first baffle extending radially outward from the cartridge body.

5. The spray control assembly of claim 4, wherein the first baffle is formed as a flange.

6. The spray control assembly of claim 4, further comprising:
a second baffle extending radially outward from the cartridge body.

7. (canceled)

8. The spray control assembly of claim 6, wherein the second baffle has a larger diameter than the first baffle.

9. The spray control assembly of claim 6, wherein at least one air passage extends through the cartridge body, the at least one air passage disposed radially outward of the flow chamber.

10. The spray control assembly of claim 9, wherein the at least one air passage is disposed radially inward of the second baffle.

11. The spray control assembly of claim wherein the at least one air passage axially overlaps with the first baffle.

12. The spray control assembly of claim 1, wherein the cartridge body includes a housing through which the at least one fluid port and the nozzle are formed, and the cartridge body includes a seal holder mounted to the housing.

13. The spray control assembly of claim 12, further comprising:
a needle seal disposed within the cartridge body, the needle seal engaging the needle, wherein the needle is slidable relative to the needle seal.

14. The spray control assembly of claim 12, wherein the housing comprises:
an inlet housing through which the at least one fluid port is formed; and
an outlet housing through which the nozzle is formed, the outlet housing connected to the inlet housing.

15. (canceled)

16. The spray control assembly of claim 14, further comprising:
a first seal groove formed on the exterior of the cartridge body, the first seal groove defined by the outlet housing and the inlet housing;
a second seal groove formed on the exterior of the cartridge body, the second seal groove formed on the inlet housing.

17-19. (canceled)

20. The spray control assembly of claim lone wherein the cartridge body includes:
a radially extending collar disposed axially between the at least one fluid port and the nozzle; and
at least one air passage extending through the collar, the at least one air passage disposed radially outward of the flow chamber.

21. The spray control assembly of claim 20, wherein the cartridge body includes:
a ring extending axially from the collar, the at least one air passage is disposed radially between the ring and the flow chamber.

22. (canceled)

23. (canceled)

24. A spray gun configured to emit a spray of spray fluid, the spray gun comprising:
a gun body having a gun bore formed within the gun body, the gun bore extending along a spray axis;
an air cap supported by the gun body, the air cap configured to output compressed air; and
a spray control assembly mountable to the gun body, the spray control assembly including:
a cartridge body elongate along a cartridge axis, the cartridge body configured to mount to the gun body within the gun bore;
a nozzle formed at a first end of the cartridge body;
a spray valve disposed within the cartridge body;
a needle partially disposed within the cartridge body and extending out of the cartridge body through a second end of the cartridge body opposite the first end of the cartridge body, the needle including a needle tip configured to engage with the seat to place a spray valve in a closed state and including a needle head at an opposite end of the needle from the needle tip;
a cartridge mount disposed on an exterior of the cartridge body, the cartridge mount configured to mount the spray control assembly to the spray gun; and
at least one fluid port extending through the cartridge body between the exterior of the cartridge body and a flow chamber formed within an interior of the cartridge body;
wherein the spray control assembly is formed as a single module configured to be mounted to and dismounted from the gun body.

25. The spray gun of claim 24, further comprising:
a valve lock selectively engageable with the needle, wherein the valve lock is drivingly engaged with the needle with the spray gun in a spray state and is drivingly disengaged from the needle with the spray gun in a non-spray state.

26-49. (canceled)

50. A spray gun comprising:
a gun body having a main body and a handle projecting from the main body;
an air cap mounted to the gun body, the air cap configured to emit compressed air;
a trigger supported by the gun body;
a spray control assembly mountable to and dismountable from the gun body as a single spray module, the spray control assembly including a nozzle and a spray valve actuatable between an open spray state, in which spray fluid can flow through the nozzle, and a closed spray state, in which the spray fluid is prevented from flowing through the nozzle; and
a flow control assembly mountable to and dismountable from the gun body as a single flow module, the flow control assembly biasing the spray valve towards the closed spray state and the flow control assembly biasing an air valve configured to control flow of compressed air to the air cap towards a closed air state, the air valve actuatable between an open air state, in which the compressed air can flow through the air valve, and the closed air state, in which the compressed air is prevented from flowing through the air valve.

51-66. (canceled)

67. The flow control assembly of claim 58, wherein the flow control assembly further comprises:
a positioner disposed at least partially within the limiter housing and extending out of the limiter housing, the positioner including positioner shaft;
a stop mounted to the positioner shaft by interfaced threading between the stop and the positioner shaft;
a knob mounted on the positioner at a location outside of the limiter housing;
wherein rotation of the knob rotates the positioner and axially displaces the stop along the axis by the threaded interface; and
wherein the stop is disposed on the axis and is positioned to limit displacement of the return block in a second axial direction along the assembly axis.

68-258. (canceled)
